(19) United States
(12) Patent Application Publication
(10) Pub. No.: US 2025/0288841 A1
(43) Pub. Date: Sep. 18, 2025

(54) FIRE RETARDANT COMPOSITIONS AND PRODUCTS AND METHODS FOR PREPARING THE SAME

(71) Applicant: Black Finch Group, LLC, Austin, TX (US)

(72) Inventors: Steve MOSELEY, Paris, TN (US); Jennifer STANLEY, Austin, TX (US); Robert HAMILTON, Austin, TX (US); Peter WOLF, Winter Park, FL (US)

(21) Appl. No.: 19/079,325

(22) Filed: Mar. 13, 2025

Related U.S. Application Data
(60) Provisional application No. 63/565,184, filed on Mar. 14, 2024.
(60) Provisional application No. 63/689,091, filed on Aug. 30, 2024.

(51) Int. Cl. A62D 1/00

(52) U.S. Cl. CPC A62D 1/0042; A62D 1/0007

(57) ABSTRACT

Embodiments of the present disclosure generally relate to fire retardant compositions, fire retardant products, and methods for preparing such fire retardant compositions and products. A variety of fire retardant products may contain the fire retardant composition. The fire retardant product may be or include a dry fire retardant product, a wet, foam, or gel fire retardant product, and/or may include one or more base products (e.g., wood, paper, textile, fiber, hemp, cannabis, combinations thereof, or other products). In one or more embodiments, a fire retardant composition is provided and contains a product composition prepared from a mixture containing about 90 wt % to about 99.9 wt % of a polysaccharide-base composition and about 0.1 wt % to about 10 wt % of a bio-stimulant composition, or contains a reaction product of a weight ratio of the polysaccharide-base composition and the bio-stimulant composition in a range from about 50:1 to about 200:1.

### CROSS-REFERENCE TO RELATED APPLICATIONS

This application claims benefit to U.S. Prov. Appl. No. 63/565,184, filed on Mar. 14, 2024, and claims benefit to U.S. Prov. Appl. No. 63/689,091, filed on Aug. 30, 2024, which are both herein incorporated by reference in their entirety.

### BACKGROUND

### Field

Embodiments of the present disclosure generally relate to fire retardant technology, and more specifically, fire retardant compositions and products and methods for preparing such fire retardant compositions and products.

### Description of the Related Art

Fire retardants contain compositions used to reduce, inhibit, and/or stop the spread of a fire or reduce the intensity of the fire. Fire retardants, in general, reduce the flammability of materials by either blocking the fire physically or by initiating a chemical reaction that reduces or stops the fire. Fire retardants may be used to control or extinguish a variety of fires which include forest fires, grass fires, or other outdoor or wilderness fires, as well as man-made structure fires (e.g., houses, buildings, vessels, etc.).

Conventional fire retardants generally have formulations which are not environmentally friendly and/or may be complicated to formulate. For example, conventional fire retardants may contain one or more bromine or bromide compounds, one or more organophosphate compounds, one or more chromate compounds, one or more fluoro-polymers or compounds, formaldehyde (e.g., in free form), or any combination thereof. As such, conventional fire retardants may produce fumes which are toxic, poisonous, corrosive, or the like to humans, animals, and the general environment.

Therefore, there is need for improved fire retardant compositions, fire retardant products, and methods for preparing such fire retardant compositions and products.

### SUMMARY

Embodiments of the present disclosure generally relate to fire retardant technology, and more specifically, fire retardant compositions, fire retardant products, and methods for preparing such fire retardant compositions and products. Many different types of fire retardant products may be contain and/or be prepared or otherwise produced with the fire retardant composition as described and discussed herein. In one or more examples, a dry fire retardant product may be or include the fire retardant composition. In other examples, a wet, gel, or foam fire retardant product may include the fire retardant composition. In further examples, a fire retardant product may be or include one or more base products (e.g., wood, paper, textile, or other products) and the fire retardant composition. The fire retardant compositions described and discussed herein may be used for fire protection, flame retardancy, as well as a coating for base products including active firefighting products.

In one or more embodiments, a fire retardant composition is provided and contains a product composition prepared from a mixture containing about 90 weight percent (wt %) to about 99.9 wt % of a polysaccharide-base composition and about 0.1 wt % to about 10 wt % of a bio-stimulant composition, based on dry weight. In some embodiments, a fire retardant composition is provided and contains a product composition prepared from a mixture containing about 98 wt % to about 99.2 wt % of the polysaccharide-base composition and about 0.8 wt % to about 2 wt % of the bio-stimulant composition, based on dry weight.

In other embodiments, a fire retardant composition is provided and contains a reaction product of a weight ratio of a polysaccharide-base composition and a bio-stimulant composition, the weight ratio in a range from about 50:1 to about 200:1, based on dry weight. In some embodiments, a fire retardant composition is provided and contains a reaction product of a weight ratio of a polysaccharide-base composition and a bio-stimulant composition, the weight ratio in a range from about 85:1 to about 95:1, based on dry weight.

In one or more embodiments, a fire retardant composition is provided and contains a product composition prepared from a mixture containing about 95 wt % to about 99.4 wt % of a polysaccharide-base composition and about 0.6 wt % to about 5 wt % of a bio-stimulant composition, based on dry weight; and/or the fire retardant composition is provided and contains a reaction product of a weight ratio of the polysaccharide-base composition and the bio-stimulant composition, the weight ratio in a range from about 70:1 to about 150:1, based on dry weight. The polysaccharide-base composition contains about 0.005 wt % to about 0.5 wt % of a polysaccharide composition, about 12 wt % to about 30 wt % of an organic base composition, and about 65 wt % to about 88 wt % of an ammonium phosphate composition, based on dry weight. The polysaccharide composition contains one or more carrageenans, salts thereof, complexes thereof, or any combination thereof. The organic base composition contains urea, salts thereof, complexes thereof, or any combination thereof. The ammonium phosphate composition contains monobasic ammonium phosphate, dibasic ammonium phosphate, salts thereof, complexes thereof, or any combination thereof. The bio-stimulant composition contains about 8 wt % to about 15 wt % of the oil composition, about 42 wt % to about 52 wt % of the organic acid composition, and about 10 wt % to about 25 wt % of the surfactant composition.

In one or more embodiments, a fire retardant composition is provided and contains a product composition prepared from a mixture containing about 80 wt % to about 98 wt % of a polysaccharide-base composition and about 2 wt % to about 20 wt % of a bio-stimulant composition, based on dry weight. In some embodiments, a fire retardant composition is provided and contains a product composition prepared from a mixture containing about 88 wt % to about 98 wt % of a polysaccharide-base composition and about 2 wt % to about 12 wt % of a bio-stimulant composition, based on dry weight.

In other embodiments, a fire retardant composition is provided and contains a reaction product of a weight ratio of a polysaccharide-base composition and a bio-stimulant composition, the weight ratio in a range from about 5:1 to about 15:1, based on dry weight. In some embodiments, a fire retardant composition is provided and contains a reaction product of a weight ratio of a polysaccharide-base composition and a bio-stimulant composition, the weight ratio in a range from about 8:1 to about 20:1, based on dry weight.

In one or more embodiments, a fire retardant composition is provided and contains a product composition prepared from a mixture containing about 80 wt % to about 98 wt % of a polysaccharide-base composition and about 2 wt % to about 20 wt % of a bio-stimulant composition, based on dry weight; and/or the fire retardant composition is provided and contains a reaction product of a weight ratio of the polysaccharide-base composition and the bio-stimulant composition, the weight ratio in a range from about 5:1 to about 15:1, based on dry weight. The polysaccharide-base composition contains about 0.5 wt % to about 10 wt % of a polysaccharide composition, about 10 wt % to about 35 wt % of an organic base composition, and about 60 wt % to about 88 wt % of an ammonium phosphate composition, based on dry weight. The polysaccharide composition contains guar gum, one or more carrageenans, salts thereof, complexes thereof, or any combination thereof. The organic base composition contains urea, salts thereof, complexes thereof, or any combination thereof. The ammonium phosphate composition contains monobasic ammonium phosphate, dibasic ammonium phosphate, salts thereof, complexes thereof, or any combination thereof. The bio-stimulant composition contains about 8 wt % to about 15 wt % of the oil composition, about 42 wt % to about 52 wt % of the organic acid composition, and about 10 wt % to about 25 wt % of the surfactant composition.

In further embodiments, a fire retardant composition is provided and contains a product composition prepared from a mixture containing about 88 wt % to about 98 wt % of a polysaccharide-base composition and about 2 wt % to about 12 wt % of a bio-stimulant composition, based on dry weight; and/or the fire retardant composition is provided and contains a reaction product of a weight ratio of the polysaccharide-base composition and the bio-stimulant composition, the weight ratio in a range from about 8:1 to about 20:1, based on dry weight. The polysaccharide-base composition contains about 4 wt % to about 12 wt % of a polysaccharide composition, about 35 wt % to about 52 wt % of an organic base composition, and about 35 wt % to about 52 wt % of an ammonium phosphate composition, based on dry weight. The polysaccharide composition contains chitosan, guar gum, one or more carrageenans, salts thereof, complexes thereof, or any combination thereof. The organic base composition contains melamine, urea, salts thereof, complexes thereof, or any combination thereof. The ammonium phosphate composition contains monobasic ammonium phosphate, dibasic ammonium phosphate, salts thereof, complexes thereof, or any combination thereof. The bio-stimulant composition contains about 8 wt % to about 15 wt % of the oil composition, about 42 wt % to about 52 wt % of the organic acid composition, and about 10 wt % to about 25 wt % of the surfactant composition.

In some embodiments, a method for preparing the fire retardant composition is provided and includes combining the polysaccharide-base composition and the bio-stimulant composition to prepare the product composition and/or the reaction product as described and discussed herein.

In other embodiments, a method for preparing the fire retardant composition is provided and includes combining a polysaccharide composition with water to prepare a first mixture, combining at least an organic base composition and an ammonium phosphate composition with the first mixture to prepare a polysaccharide-base composition, and combining a bio-stimulant composition and the polysaccharide-base composition to prepare a product composition or a reaction product.

In one or more embodiments, a fire retardant product is provided and contains a base product and the fire retardant composition as described and discussed herein. In some examples, the base product contains a wood product, a paper product, a textile product, a plant fiber product, a hemp and/or cannabis fiber product, a cellulose product, a resin product, an adhesive product, a plastic product, a polymeric product, or any combination thereof.

### DETAILED DESCRIPTION

According to the embodiments described and disclosed herein, fire retardant compositions, fire retardant products, methods for preparing fire retardant compositions, and methods for preparing fire retardant products are described and discussed herein. The fire retardant composition may be used as and/or contain in a variety of different types of fire retardant products. Exemplary fire retardant products containing the fire retardant composition may be or include dry fire retardant products, wet, gel, and/or foam fire retardant products, as well as coatings and/or films containing the fire retardant composition disposed on or over one or more base products (e.g., wood, paper, textile, hemp and/or cannabis fiber, or other products).

It has been surprisingly and unexpectedly discovered that fire retardant compositions containing one or more polysaccharide-base compositions and one or more bio-stimulant compositions provide longer fire protection and flame retardancy than known fire retardant compositions. For example, the fire retardant compositions containing a polysaccharide-base composition and a bio-stimulant composition, surprisingly and unexpectedly perform better than other fire retardants which lack the bio-stimulant composition and/or do not have the same components and/or the ratios of such components as utilized in the polysaccharide-base compositions and/or the bio-stimulant compositions described and discussed here. Without wishing to be bound by theory, it is believed that the mixture of the polysaccharide-base composition and the bio-stimulant composition provides enhanced integrity and/or protection of the underlying materials (e.g., vegetation in a forest or grass fire, a burnable base product, etc.) such that the underlying material takes longer to ignite or burn and/or requires a hotter fire before igniting or burning when compared to other fire retardants.

In one or more embodiments, a fire retardant composition is provided and contains a product composition prepared from a mixture containing at least a polysaccharide-base composition and a bio-stimulant composition and/or one or more reaction products produced from a reaction between the polysaccharide-base composition and the bio-stimulant composition.

The reaction product and/or the mixture which is or produces the fire retardant composition may contain the polysaccharide-base composition at a concentration or an amount in a range from about 70 weight percent (wt %), about 75 wt %, about 78 wt %, about 80 wt %, about 82 wt %, about 84 wt %, about 86 wt %, about 88 wt %, about 90 wt %, about 90.5 wt %, about 91 wt %, about 91.5 wt %, or about 92 wt % to about 92.5 wt %, about 93 wt %, about 93.5 wt %, about 94 wt %, about 94.5 wt %, about 95 wt %, about 95.5 wt %, about 96 wt %, about 96.5 wt %, about 97 wt %, about 97.2 wt %, about 97.5 wt %, about 97.8 wt %, about 98 wt %, about 98.2 wt %, about 98.5 wt %, about 98.8 wt %, about 99 wt %, about 99.1 wt %, about 99.2 wt %, about 99.3 wt %, about 99.4 wt %, about 99.5 wt %, about 99.6 wt %, about 99.7 wt %, about 99.8 wt %, or about 99.9 wt %, based on dry weight.

For example, the reaction product and/or the mixture may contain the polysaccharide-base composition at a concentration or an amount from about 70 wt % to about 99 wt %, about 80 wt % to about 99 wt %, about 85 wt % to about 99 wt %, about 88 wt % to about 99 wt %, about 90 wt % to about 99 wt %, about 91 wt % to about 99 wt %, about 92 wt % to about 99 wt %, about 92.5 wt % to about 99 wt %, about 93 wt % to about 99 wt %, about 94 wt % to about 99 wt %, about 95 wt % to about 99 wt %, about 70 wt % to about 99 wt %, about 80 wt % to about 99 wt %, about 85 wt % to about 99 wt %, about 88 wt % to about 99 wt %, about 90 wt % to about 99 wt %, about 91 wt % to about 99 wt %, about 92 wt % to about 99 wt %, about 92.5 wt % to about 99 wt %, about 93 wt % to about 99 wt %, about 94 wt % to about 99 wt %, about 95 wt % to about 99 wt %, about 70 wt % to about 98 wt %, about 80 wt % to about 98 wt %, about 85 wt % to about 98 wt %, about 88 wt % to about 98 wt %, about 90 wt % to about 98 wt %, about 91 wt % to about 98 wt %, about 92 wt % to about 98 wt %, about 92.5 wt % to about 98 wt %, about 93 wt % to about 98 wt %, about 94 wt % to about 98 wt %, about 95 wt % to about 98 wt %, about 70 wt % to about 96 wt %, about 80 wt % to about 96 wt %, about 85 wt % to about 96 wt %, about 88 wt % to about 96 wt %, about 90 wt % to about 96 wt %, about 91 wt % to about 96 wt %, about 92 wt % to about 96 wt %, about 92.5 wt % to about 96 wt %, about 93 wt % to about 96 wt %, about 94 wt % to about 96 wt %, about 95 wt % to about 96 wt %, about 70 wt % to about 94 wt %, about 80 wt % to about 94 wt %, about 85 wt % to about 94 wt %, about 88 wt % to about 94 wt %, about 90 wt % to about 94 wt %, about 91 wt % to about 94 wt %, about 92 wt % to about 94 wt %, about 92.5 wt % to about 94 wt %, about 93 wt % to about 94 wt %, about 70 wt % to about 93.5 wt %, about 80 wt % to about 93.5 wt %, about 85 wt % to about 93.5 wt %, about 88 wt % to about 93.5 wt %, about 90 wt % to about 93.5 wt %, about 91 wt % to about 93.5 wt %, about 92 wt % to about 93.5 wt %, about 92.5 wt % to about 93.5 wt %, about 93 wt % to about 93.5 wt %, about 80 wt % to about 98 wt %, about 85 wt % to about 95 wt %, or about 88 wt % to about 92 wt %, based on dry weight.

In other examples, the reaction product and/or the mixture may contain the polysaccharide-base composition at a concentration or an amount from about 90 wt % to about 99.9 wt %, about 90 wt % to about 99.8 wt %, about 90 wt % to about 99.6 wt %, about 90 wt % to about 99.5 wt %, about 90 wt % to about 99.4 wt %, about 90 wt % to about 99.2 wt %, about 90 wt % to about 99 wt %, about 90 wt % to about 98.5 wt %, about 90 wt % to about 98 wt %, about 90 wt % to about 97.5 wt %, about 90 wt % to about 97 wt %, about 90 wt % to about 96.5 wt %, about 90 wt % to about 96 wt %, about 90 wt % to about 95.5 wt %, about 90 wt % to about 95 wt %, about 90 wt % to about 94.5 wt %, about 90 wt % to about 94 wt %, about 90 wt % to about 93 wt %, about 90 wt % to about 92 wt %, about 95 wt % to about 99.9 wt %, about 95 wt % to about 99.8 wt %, about 95 wt % to about 99.6 wt %, about 95 wt % to about 99.5 wt %, about 95 wt % to about 99.4 wt %, about 95 wt % to about 99.2 wt %, about 95 wt % to about 99 wt %, about 95 wt % to about 98.5 wt %, about 95 wt % to about 98 wt %, about 95 wt % to about 97.5 wt %, about 95 wt % to about 97 wt %, about 95 wt % to about 96.5 wt %, about 95 wt % to about 96 wt %, about 95 wt % to about 95.5 wt %, about 98 wt % to about 99.9 wt %, about 98 wt % to about 99.8 wt %, about 98 wt % to about 99.6 wt %, about 98 wt % to about 99.5 wt %, about 98 wt % to about 99.4 wt %, about 98 wt % to about 99.2 wt %, about 98 wt % to about 99 wt %, or about 98 wt % to about 98.5 wt %, based on dry weight.

The reaction product and/or the mixture which is or produces the fire retardant composition may contain the bio-stimulant composition at a concentration or an amount in a range from about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.2 wt %, about 1.4 wt %, or about 1.5 wt % to about 1.6 wt %, about 1.8 wt %, about 2 wt %, about 2.5 wt %, about 3 wt %, about 3.5 wt %, about 4 wt %, about 4.5 wt %, about 5 wt %, about 5.5 wt %, about 6 wt %, or about 6.5 wt % to about 7 wt %, about 7.5 wt %, about 8 wt %, about 8.5 wt %, about 9 wt %, about 10 wt %, about 11 wt %, about 12 wt %, about 13 wt %, about 14 wt %, about 15 wt %, about 18 wt %, about 20 wt %, about 25 wt %, or about 30 wt %, based on dry weight.

For example, the reaction product and/or the mixture may contain the bio-stimulant composition at a concentration or an amount in a range from about 0.5 wt % to about 30 wt %, about 0.5 wt % to about 25 wt %, about 0.5 wt % to about 20 wt %, about 0.5 wt % to about 18 wt %, about 0.5 wt % to about 15 wt %, about 0.5 wt % to about 12 wt %, about 0.5 wt % to about 10 wt %, about 0.5 wt % to about 8 wt %, about 0.5 wt % to about 7 wt %, about 0.5 wt % to about 6 wt %, about 0.5 wt % to about 5 wt %, about 0.5 wt % to about 4 wt %, about 0.5 wt % to about 3 wt %, about 0.5 wt % to about 2 wt %, about 0.5 wt % to about 1 wt %, about 1 wt % to about 30 wt %, about 1 wt % to about 25 wt %, about 1 wt % to about 20 wt %, about 1 wt % to about 18 wt %, about 1 wt % to about 15 wt %, about 1 wt % to about 12 wt %, about 1 wt % to about 10 wt %, about 1 wt % to about 8 wt %, about 1 wt % to about 7 wt %, about 1 wt % to about 6 wt %, about 1 wt % to about 5 wt %, about 1 wt % to about 4 wt %, about 1 wt % to about 3 wt %, about 1 wt % to about 2 wt %, about 2 wt % to about 30 wt %, about 2 wt % to about 25 wt %, about 2 wt % to about 20 wt %, about 2 wt % to about 18 wt %, about 2 wt % to about 15 wt %, about 2 wt % to about 12 wt %, about 2 wt % to about 10 wt %, about 2 wt % to about 8 wt %, about 2 wt % to about 7 wt %, about 2 wt % to about 6 wt %, about 2 wt % to about 5 wt %, about 2 wt % to about 4 wt %, about 2 wt % to about 3 wt %, about 4 wt % to about 30 wt %, about 4 wt % to about 25 wt %, about 4 wt % to about 20 wt %, about 4 wt % to about 18 wt %, about 4 wt % to about 15 wt %, about 4 wt % to about 12 wt %, about 4 wt % to about 10 wt %, about 4 wt % to about 8 wt %, about 4 wt % to about 7 wt %, about 4 wt % to about 6 wt %, about 4 wt % to about 5 wt %, about 5 wt % to about 30 wt %, about 5 wt % to about 25 wt %, about 5 wt % to about 20 wt %, about 5 wt % to about 18 wt %, about 5 wt % to about 15 wt %, about 5 wt % to about 12 wt %, about 5 wt % to about 10 wt %, about 5 wt % to about 8 wt %, about 5 wt % to about 7 wt %, about 5 wt % to about 6 wt %, about 6 wt % to about 30 wt %, about 6 wt % to about 25 wt %, about 6 wt % to about 20 wt %, about 6 wt % to about 18 wt %, about 6 wt % to about 15 wt %, about 6 wt % to about 12 wt %, about 6 wt % to about 10 wt %, about 6 wt % to about 8 wt %, about 6 wt % to about 7 wt %, or about 8 wt % to about 12 wt %, based on dry weight.

In other examples, the reaction product and/or the mixture which is or produces the fire retardant composition may contain the bio-stimulant composition at a concentration or an amount in a range from about 0.1 wt % to about 20 wt %, about 0.1 wt % to about 18 wt %, about 0.1 wt % to about 15 wt %, about 0.1 wt % to about 12 wt %, about 0.1 wt % to about 10 wt %, about 0.1 wt % to about 9 wt %, about 0.1 wt % to about 8 wt %, about 0.1 wt % to about 7 wt %, about 0.1 wt % to about 6 wt %, about 0.1 wt % to about 5 wt %, about 0.1 wt % to about 4 wt %, about 0.1 wt % to about 3 wt %, about 0.1 wt % to about 2.5 wt %, about 0.1 wt % to about 2.2 wt %, about 0.1 wt % to about 2 wt %, about 0.1 wt % to about 1.5 wt %, about 0.1 wt % to about 1.2 wt %, about 0.1 wt % to about 1 wt %, about 0.1 wt % to about 0.8 wt %, about 0.1 wt % to about 0.5 wt %, about 0.1 wt % to about 0.3 wt %, about 0.6 wt % to about 20 wt %, about 0.6 wt % to about 18 wt %, about 0.6 wt % to about 15 wt %, about 0.6 wt % to about 12 wt %, about 0.6 wt % to about 10 wt %, about 0.6 wt % to about 9 wt %, about 0.6 wt % to about 8 wt %, about 0.6 wt % to about 7 wt %, about 0.6 wt % to about 6 wt %, about 0.6 wt % to about 5 wt %, about 0.6 wt % to about 4 wt %, about 0.6 wt % to about 3 wt %, about 0.6 wt % to about 2.5 wt %, about 0.6 wt % to about 2.2 wt %, about 0.6 wt % to about 2 wt %, about 0.6 wt % to about 1.5 wt %, about 0.6 wt % to about 1.2 wt %, about 0.6 wt % to about 1 wt %, about 0.6 wt % to about 0.8 wt %, about 0.8 wt % to about 20 wt %, about 0.8 wt % to about 18 wt %, about 0.8 wt % to about 15 wt %, about 0.8 wt % to about 12 wt %, about 0.8 wt % to about 10 wt %, about 0.8 wt % to about 9 wt %, about 0.8 wt % to about 8 wt %, about 0.8 wt % to about 7 wt %, about 0.8 wt % to about 6 wt %, about 0.8 wt % to about 5 wt %, about 0.8 wt % to about 4 wt %, about 0.8 wt % to about 3 wt %, about 0.8 wt % to about 2.5 wt %, about 0.8 wt % to about 2.2 wt %, about 0.8 wt % to about 2 wt %, about 0.8 wt % to about 1.5 wt %, about 0.8 wt % to about 1.2 wt %, or about 0.8 wt % to about 1 wt %, based on dry weight.

In one or more examples, the reaction product and/or the mixture which is or produces the fire retardant composition may contain about 80 wt % to about 98 wt % of a polysaccharide-base composition and about 2 wt % to about 20 wt % of a bio-stimulant composition, based on dry weight. In some examples, the reaction product and/or the mixture which is or produces the fire retardant composition may contain about 85 wt % to about 95 wt % of a polysaccharide-base composition and about 5 wt % to about 15 wt % of a bio-stimulant composition, based on dry weight. In other examples, the reaction product and/or the mixture which is or produces the fire retardant composition may contain about 88 wt % to about 92 wt % of a polysaccharide-base composition and about 8 wt % to about 12 wt % of a bio-stimulant composition, based on dry weight. In some examples, the reaction product and/or the mixture which is or produces the fire retardant composition may contain about 89 wt % to about 91 wt % of a polysaccharide-base composition and about 9 wt % to about 11 wt % of a bio-stimulant composition, based on dry weight.

In one or more examples, the reaction product and/or the mixture which is or produces the fire retardant composition may contain about 88 wt % to about 98 wt % of a polysaccharide-base composition and about 2 wt % to about 12 wt % of a bio-stimulant composition, based on dry weight. In some examples, the reaction product and/or the mixture which is or produces the fire retardant composition may contain about 90 wt % to about 96 wt % of a polysaccharide-base composition and about 4 wt % to about 10 wt % of a bio-stimulant composition, based on dry weight. In other examples, the reaction product and/or the mixture which is or produces the fire retardant composition may contain about 92 wt % to about 94 wt % of a polysaccharide-base composition and about 6 wt % to about 8 wt % of a bio-stimulant composition, based on dry weight. In some examples, the reaction product and/or the mixture which is or produces the fire retardant composition may contain about 92.5 wt % to about 93.5 wt % of a polysaccharide-base composition and about 6.5 wt % to about 7.5 wt % of a bio-stimulant composition, based on dry weight.

In one or more examples, the reaction product and/or the mixture which is or produces the fire retardant composition may contain about 90 wt % to about 99.9 wt % of a polysaccharide-base composition and about 0.1 wt % to about 10 wt % of a bio-stimulant composition, based on dry weight. In some examples, the reaction product and/or the mixture which is or produces the fire retardant composition may contain about 95 wt % to about 99.4 wt % of a polysaccharide-base composition and about 0.6 wt % to about 5 wt % of a bio-stimulant composition, based on dry weight. In other examples, the reaction product and/or the mixture which is or produces the fire retardant composition may contain about 98 wt % to about 99.2 wt % of a polysaccharide-base composition and about 0.8 wt % to about 2 wt % of a bio-stimulant composition, based on dry weight. In some examples, the reaction product and/or the mixture which is or produces the fire retardant composition may contain about 98.5 wt % to about 99 wt % of a polysaccharide-base composition and about 1 wt % to about 1.5 wt % of a bio-stimulant composition, based on dry weight.

In some embodiments, the fire retardant composition is provided and contains a reaction product of a weight ratio of the polysaccharide-base composition and the bio-stimulant composition, based on dry weight. In other embodiments, the fire retardant composition is provided and contains a mixture of a weight ratio of the polysaccharide-base composition and the bio-stimulant composition, based on dry weight. For example, the weight ratio of the polysaccharide-base composition and the bio-stimulant composition may be in a range from about 4:1, about 5:1, about 6:1, about 7:1, about 8:1, or about 9:1 to about 10:1, about 11:1, about 12:1, about 13:1 to about 14:1, about 15:1, about 16:1, about 17:1, about 18:1, about 19:1, about 20:1, about 21:1, about 22:1, about 25:1, about 30:1, about 35:1, or about 40:1, to about 50:1, about 60:1, about 70:1, about 80:1, about 85:1, or about 90:1 to about 95:1, about 100:1, about 110:1, about 120:1, about 135:1, about 150:1, about 165:1, about 180:1, about 190:1, about 200:1, about 220:1, about 240:1, about 250:1, about 275:1, about 300:1, or greater, based on dry weight. In one or more examples, the weight ratio of the polysaccharide-base composition and the bio-stimulant composition may be from about 5:1 to about 15:1, based on dry weight. In some examples, the weight ratio may be from about 6:1 to about 12:1, based on dry weight. In other examples, the weight ratio of the polysaccharide-base composition and the bio-stimulant composition may be from about 8:1 to about 10:1, based on dry weight. In some examples, the weight ratio may be from about 8.5:1 to about 9.5:1, based on dry weight.

In one or more embodiments, the weight ratio of the polysaccharide-base composition and the bio-stimulant composition may be in a range from about 50:1 to about 300:1, about 50:1 to about 280:1, about 50:1 to about 250:1, about 50:1 to about 220:1, about 50:1 to about 200:1, about 50:1 to about 180:1, about 50:1 to about 150:1, about 50:1 to about 120:1, about 50:1 to about 100:1, about 50:1 to about 95:1, about 50:1 to about 85:1, about 50:1 to about 75:1, about 50:1 to about 60:1, about 70:1 to about 300:1, about 70:1 to about 280:1, about 70:1 to about 250:1, about 70:1 to about 220:1, about 70:1 to about 200:1, about 70:1 to about 180:1, about 70:1 to about 150:1, about 70:1 to about 120:1, about 70:1 to about 100:1, about 70:1 to about 95:1, about 70:1 to about 85:1, about 70:1 to about 75:1, about 85:1 to about 300:1, about 85:1 to about 280:1, about 85:1 to about 250:1, about 85:1 to about 220:1, about 85:1 to about 200:1, about 85:1 to about 180:1, about 85:1 to about 150:1, about 85:1 to about 120:1, about 85:1 to about 100:1, or about 85:1 to about 95:1, based on dry weight.

In one or more embodiments, the weight ratio of the polysaccharide-base composition and the bio-stimulant composition may be in a range from about 4:1, about 5:1, about 6:1, about 7:1, about 8:1, about 9:1, about 10:1, about 11:1, about 12:1, or about 13:1 to about 14:1, about 15:1, about 16:1, about 17:1, about 18:1, about 19:1, about 20:1, about 21:1, about 22:1, about 25:1, about 30:1, about 35:1, about 40:1, based on dry weight. In one or more examples, the weight ratio of the polysaccharide-base composition and the bio-stimulant composition may be from about 8:1 to about 20:1. In some examples, the weight ratio may be from about 10:1 to about 18:1, based on dry weight. In other examples, the weight ratio of the polysaccharide-base composition and the bio-stimulant composition may be from about 12:1 to about 15:1, based on dry weight. In some examples, the weight ratio of the polysaccharide-base composition and the bio-stimulant composition may be from about 13:1 to about 14:1, such as about 13.1:1, about 13.2:1, about 13.3:1, about 13.4:1, about 13.5:1, about 13.6:1, about 13.7:1, about 13.8:1, or about 13.9:1, based on dry weight.

In one or more embodiments, the polysaccharide-base composition may contain at least a polysaccharide composition, an organic base composition, and an ammonium phosphate composition, and optionally, an oxide material composition. In some examples, the polysaccharide-base composition contains water.

In one or more embodiments, the polysaccharide-base composition contains the polysaccharide composition in a range from about 0.0005 wt %, about 0.001 wt %, about 0.002 wt %, about 0.004 wt %, about 0.005 wt %, about 0.008 wt %, about 0.01 wt %, about 0.012 wt %, about 0.015 wt %, about 0.02 wt %, about 0.025 wt %, about 0.03 wt %, about 0.035 wt %, about 0.04 wt %, about 0.045 wt %, or about 0.05 wt % to about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt % to about 1.1 wt %, about 1.2 wt %, about 1.3 wt %, about 1.4 wt %, about 1.5 wt %, about 1.8 wt %, about 2 wt %, or greater, based on dry weight. For example, the polysaccharide-base composition may contain from about 0.001 wt % to about 2 wt %, about 0.001 wt % to about 1.8 wt %, about 0.001 wt % to about 1.5 wt %, about 0.001 wt % to about 1.2 wt %, about 0.001 wt % to about 1 wt %, about 0.001 wt % to about 0.8 wt %, about 0.001 wt % to about 0.5 wt %, about 0.001 wt % to about 0.2 wt %, about 0.001 wt % to about 0.1 wt %, about 0.001 wt % to about 0.08 wt %, about 0.001 wt % to about 0.05 wt %, about 0.001 wt % to about 0.01 wt %, about 0.001 wt % to about 0.005 wt %, about 0.005 wt % to about 2 wt %, about 0.005 wt % to about 1.8 wt %, about 0.005 wt % to about 1.5 wt %, about 0.005 wt % to about 1.2 wt %, about 0.005 wt % to about 1 wt %, about 0.005 wt % to about 0.8 wt %, about 0.005 wt % to about 0.5 wt %, about 0.005 wt % to about 0.2 wt %, about 0.005 wt % to about 0.1 wt %, about 0.005 wt % to about 0.08 wt %, about 0.005 wt % to about 0.05 wt %, about 0.005 wt % to about 0.01 wt %, about 0.01 wt % to about 2 wt %, about 0.01 wt % to about 1.8 wt %, about 0.01 wt % to about 1.5 wt %, about 0.01 wt % to about 1.2 wt %, about 0.01 wt % to about 1 wt %, about 0.01 wt % to about 0.8 wt %, about 0.01 wt % to about 0.5 wt %, about 0.01 wt % to about 0.2 wt %, about 0.01 wt % to about 0.1 wt %, about 0.01 wt % to about 0.08 wt %, about 0.01 wt % to about 0.05 wt % of the polysaccharide composition, based on dry weight.

In one or more embodiments, the polysaccharide-base composition contains the polysaccharide composition in a range from about 0.1 wt %, about 0.5 wt %, about 0.8 wt %, about 1 wt %, about 1.2 wt %, about 1.5 wt %, about 1.8 wt %, about 2 wt %, about 2.5 wt %, or about 2.8 wt % to about 3 wt %, about 3.5 wt %, about 4 wt %, about 5 wt %, about 6 wt %, about 8 wt %, about 10 wt %, about 12 wt %, about 15 wt %, or about 20 wt %, based on dry weight. For example, the polysaccharide-base composition may contain from about 0.5 wt % to about 25 wt %, about 0.5 wt % to about 20 wt %, about 0.5 wt % to about 15 wt %, about 0.5 wt % to about 10 wt %, about 0.5 wt % to about 8 wt %, about 0.5 wt % to about 6 wt %, about 0.5 wt % to about 5 wt %, about 0.5 wt % to about 4 wt %, about 0.5 wt % to about 3 wt %, about 0.5 wt % to about 2.5 wt %, about 0.5 wt % to about 2 wt %, about 0.5 wt % to about 1.8 wt %, about 0.5 wt % to about 1.5 wt %, about 0.5 wt % to about 1.2 wt %, about 0.5 wt % to about 1 wt %, about 0.5 wt % to about 0.8 wt %, about 0.8 wt % to about 10 wt %, about 0.8 wt % to about 8 wt %, about 0.8 wt % to about 6 wt %, about 0.8 wt % to about 5 wt %, about 0.8 wt % to about 4 wt %, about 0.8 wt % to about 3 wt %, about 0.8 wt % to about 2.5 wt %, about 0.8 wt % to about 2 wt %, about 0.8 wt % to about 1.8 wt %, about 0.8 wt % to about 1.5 wt %, about 0.8 wt % to about 1.2 wt %, about 0.8 wt % to about 1 wt %, about 1 wt % to about 10 wt %, about 1 wt % to about 8 wt %, about 1 wt % to about 6 wt %, about 1 wt % to about 5 wt %, about 1 wt % to about 4 wt %, about 1 wt % to about 3 wt %, about 1 wt % to about 2.5 wt %, about 1 wt % to about 2 wt %, about 1 wt % to about 1.8 wt %, about 1 wt % to about 1.5 wt %, or about 1 wt % to about 1.2 wt % of the polysaccharide composition, based on dry weight.

In some embodiments, the polysaccharide-base composition contains the polysaccharide composition in a range from about 2 wt %, about 3 wt %, about 4 wt %, about 5 wt %, about 6 wt %, about 7 wt %, or about 8 wt % to about 9 wt %, about 10 wt %, about 11 wt %, about 12 wt %, about 13 wt %, about 14 wt %, about 15 wt %, about 16 wt %, about 18 wt %, about 20 wt %, or about 25 wt %, based on dry weight. For example, the polysaccharide-base composition may contain from about 2 wt % to about 25 wt %, about 4 wt % to about 25 wt %, about 5 wt % to about 25 wt %, about 6 wt % to about 25 wt %, about 8 wt % to about 25 wt %, about 10 wt % to about 25 wt %, about 12 wt % to about 25 wt %, about 15 wt % to about 25 wt %, about 18 wt % to about 25 wt %, about 20 wt % to about 25 wt %, about 22 wt % to about 25 wt %, about 2 wt % to about 20 wt %, about 4 wt % to about 20 wt %, about 5 wt % to about 20 wt %, about 6 wt % to about 20 wt %, about 8 wt % to about 20 wt %, about 10 wt % to about 20 wt %, about 12 wt % to about 20 wt %, about 15 wt % to about 20 wt %, about 18 wt % to about 20 wt %, about 2 wt % to about 12 wt %, about 4 wt % to about 12 wt %, about 5 wt % to about 12 wt %, about 6 wt % to about 12 wt %, about 8 wt % to about 12 wt %, about 10 wt % to about 12 wt %, about 2 wt % to about 10 wt %, about 4 wt % to about 10 wt %, about 5 wt % to about 10 wt %, about 6 wt % to about 10 wt %, about 8 wt % to about 10 wt %, about 2 wt % to about 8 wt %, about 4 wt % to about 8 wt %, about 5 wt % to about 8 wt %, about 6 wt % to about 8 wt %, about 6 wt % to about 9 wt %, or about 8 wt % to about 9 wt % of the polysaccharide composition, based on dry weight.

In one or more embodiments, the polysaccharide-base composition contains the organic base composition in a range from about 2 wt %, about 5 wt %, about 8 wt %, about 10 wt %, about 12 wt %, about 15 wt %, about 16 wt %, about 18 wt %, or about 20 wt % to about 22 wt %, about 25 wt %, about 28 wt %, about 30 wt %, about 32 wt %, about 35 wt %, about 38 wt %, about 40 wt %, about 45 wt %. about 50 wt %, or about 60 wt %, based on dry weight. For example, the polysaccharide-base composition may contain from about 5 wt % to about 60 wt %, about 5 wt % to about 50 wt %, about 5 wt % to about 45 wt %, about 5 wt % to about 40 wt %, about 5 wt % to about 35 wt %, about 5 wt % to about 30 wt %, about 5 wt % to about 28 wt %, about 5 wt % to about 25 wt %, about 5 wt % to about 22 wt %, about 5 wt % to about 20 wt %, about 5 wt % to about 18 wt %, about 5 wt % to about 15 wt %, about 5 wt % to about 12 wt %, about 5 wt % to about 10 wt %, about 5 wt % to about 8 wt %, about 5 wt % to about 6 wt %, about 10 wt % to about 60 wt %, about 10 wt % to about 50 wt %, about 10 wt % to about 45 wt %, about 10 wt % to about 40 wt %, about 10 wt % to about 35 wt %, about 10 wt % to about 30 wt %, about 10 wt % to about 28 wt %, about 10 wt % to about 25 wt %, about 10 wt % to about 22 wt %, about 10 wt % to about 20 wt %, about 10 wt % to about 18 wt %, about 10 wt % to about 15 wt %, about 10 wt % to about 12 wt %, about 12 wt % to about 60 wt %, about 12 wt % to about 50 wt %, about 12 wt % to about 45 wt %, about 12 wt % to about 40 wt %, about 12 wt % to about 35 wt %, about 12 wt % to about 30 wt %, about 12 wt % to about 28 wt %, about 12 wt % to about 25 wt %, about 12 wt % to about 22 wt %, about 12 wt % to about 20 wt %, about 12 wt % to about 18 wt %, about 12 wt % to about 15 wt %, about 12 wt % to about 13 wt %, about 16 wt % to about 60 wt %, about 16 wt % to about 50 wt %, about 16 wt % to about 45 wt %, about 16 wt % to about 40 wt %, about 16 wt % to about 35 wt %, about 16 wt % to about 30 wt %, about 16 wt % to about 28 wt %, about 16 wt % to about 25 wt %, about 16 wt % to about 22 wt %, about 16 wt % to about 20 wt %, or about 16 wt % to about 18 wt % of the organic base composition, based on dry weight.

In some embodiments, the polysaccharide-base composition contains the organic base composition in a range from about 25 wt %, about 30 wt %, about 32 wt %, about 35 wt %, about 38 wt %, about 40 wt %, or about 42 wt % to about 44 wt %, about 45 wt %, about 46 wt %, about 48 wt %, about 50 wt %, about 52 wt %, about 55 wt %, or about 60 wt %, based on dry weight. For example, the polysaccharide-base composition may contain from about 25 wt % to about 60 wt %, about 25 wt % to about 55 wt %, about 25 wt % to about 52 wt %, about 25 wt % to about 50 wt %, about 25 wt % to about 49 wt %, about 25 wt % to about 48 wt %, about 25 wt % to about 46 wt %, about 25 wt % to about 44 wt %, about 25 wt % to about 40 wt %, about 35 wt % to about 60 wt %, about 35 wt % to about 55 wt %, about 35 wt % to about 52 wt %, about 35 wt % to about 50 wt %, about 35 wt % to about 49 wt %, about 35 wt % to about 48 wt %, about 35 wt % to about 46 wt %, about 35 wt % to about 44 wt %, about 35 wt % to about 40 wt %, about 40 wt % to about 60 wt %, about 40 wt % to about 55 wt %, about 40 wt % to about 52 wt %, about 40 wt % to about 50 wt %, about 40 wt % to about 49 wt %, about 40 wt % to about 48 wt %, about 40 wt % to about 46 wt %, about 40 wt % to about 44 wt %, about 40 wt % to about 42 wt %, about 42 wt % to about 60 wt %, about 42 wt % to about 55 wt %, about 42 wt % to about 52 wt %, about 42 wt % to about 50 wt %, about 42 wt % to about 49 wt %, about 42 wt % to about 48 wt %, about 42 wt % to about 46 wt %, about 46 wt % to about 60 wt %, about 46 wt % to about 55 wt %, about 46 wt % to about 52 wt %, about 46 wt % to about 50 wt %, about 46 wt % to about 49 wt %, or about 46 wt % to about 48 wt % of the organic base composition, based on dry weight.

In one or more embodiments, the polysaccharide-base composition contains the ammonium phosphate composition in a range from about 40 wt %, about 50 wt %, about 55 wt %, about 58 wt %, about 60 wt %, about 62 wt %, about 65 wt %, about 68 wt %, about 70 wt %, or about 72 wt % to about 75 wt %, about 78 wt %, about 80 wt %, about 82 wt %, about 84 wt %, about 85 wt %, about 86 wt %, about 88 wt %, about 90 wt %, about 92 wt %, about 94 wt %, about 95 wt %, about 96 wt %, about 97 wt %, or greater, based on dry weight. For example, the polysaccharide-base composition may contain from about 40 wt % to about 90 wt %, about 50 wt % to about 95 wt %, about 50 wt % to about 90 wt %, about 50 wt % to about 88 wt %, about 50 wt % to about 85 wt %, about 50 wt % to about 82 wt %, about 50 wt % to about 80 wt %, about 50 wt % to about 78 wt %, about 50 wt % to about 75 wt %, about 50 wt % to about 72 wt %, about 50 wt % to about 70 wt %, about 50 wt % to about 68 wt %, about 50 wt % to about 65 wt %, about 50 wt % to about 60 wt %, about 60 wt % to about 96 wt %, about 60 wt % to about 95 wt %, about 60 wt % to about 94 wt %, about 60 wt % to about 92 wt %, about 60 wt % to about 90 wt %, about 60 wt % to about 88 wt %, about 60 wt % to about 85 wt %, about 60 wt % to about 82 wt %, about 60 wt % to about 80 wt %, about 60 wt % to about 78 wt %, about 60 wt % to about 75 wt %, about 60 wt % to about 72 wt %, about 60 wt % to about 70 wt %, about 60 wt % to about 68 wt %, about 60 wt % to about 65 wt %, about 60 wt % to about 62 wt %, about 65 wt % to about 95 wt %, about 65 wt % to about 90 wt %, about 65 wt % to about 88 wt %, about 65 wt % to about 85 wt %, about 65 wt % to about 82 wt %, about 65 wt % to about 80 wt %, about 65 wt % to about 78 wt %, about 65 wt % to about 75 wt %, about 65 wt % to about 72 wt %, about 65 wt % to about 70 wt %, about 65 wt % to about 68 wt %, about 70 wt % to about 95 wt %, about 70 wt % to about 90 wt %, about 70 wt % to about 88 wt %, about 70 wt % to about 85 wt %, about 70 wt % to about 82 wt %, about 70 wt % to about 80 wt %, about 70 wt % to about 78 wt %, about 70 wt % to about 75 wt %, about 70 wt % to about 72 wt %, about 72 wt % to about 95 wt %, about 72 wt % to about 90 wt %, about 72 wt % to about 88 wt %, about 72 wt % to about 85 wt %, about 72 wt % to about 84 wt %, about 72 wt % to about 82 wt %, about 72 wt % to about 80 wt %, about 72 wt % to about 78 wt %, about 72 wt % to about 75 wt %, about 72 wt % to about 74 wt % of the ammonium phosphate composition, based on dry weight.

In some embodiments, the polysaccharide-base composition contains the ammonium phosphate composition in a range from about 25 wt %, about 30 wt %, about 32 wt %, about 35 wt %, about 38 wt %, about 40 wt %, or about 42 wt % to about 44 wt %, about 45 wt %, about 46 wt %, about 48 wt %, about 50 wt %, about 52 wt %, about 55 wt %, or about 60 wt %, based on dry weight. For example, the polysaccharide-base composition may contain from about 25 wt % to about 60 wt %, about 25 wt % to about 55 wt %, about 25 wt % to about 52 wt %, about 25 wt % to about 50 wt %, about 25 wt % to about 49 wt %, about 25 wt % to about 48 wt %, about 25 wt % to about 46 wt %, about 25 wt % to about 44 wt %, about 25 wt % to about 40 wt %, about 35 wt % to about 60 wt %, about 35 wt % to about 55 wt %, about 35 wt % to about 52 wt %, about 35 wt % to about 50 wt %, about 35 wt % to about 49 wt %, about 35 wt % to about 48 wt %, about 35 wt % to about 46 wt %, about 35 wt % to about 44 wt %, about 35 wt % to about 40 wt %, about 40 wt % to about 60 wt %, about 40 wt % to about 55 wt %, about 40 wt % to about 52 wt %, about 40 wt % to about 50 wt %, about 40 wt % to about 49 wt %, about 40 wt % to about 48 wt %, about 40 wt % to about 46 wt %, about 40 wt % to about 44 wt %, about 40 wt % to about 42 wt %, about 42 wt % to about 60 wt %, about 42 wt % to about 55 wt %, about 42 wt % to about 52 wt %, about 42 wt % to about 50 wt %, about 42 wt % to about 49 wt %, about 42 wt % to about 48 wt %, about 42 wt % to about 46 wt %, about 46 wt % to about 60 wt %, about 46 wt % to about 55 wt %, about 46 wt % to about 52 wt %, about 46 wt % to about 50 wt %, about 46 wt % to about 49 wt %, or about 46 wt % to about 48 wt % of the ammonium phosphate composition, based on dry weight.

In one or more examples, the polysaccharide-base composition may contain about 0.001 wt % to about 1 wt % of a polysaccharide composition, about 10 wt % to about 40 wt % of an organic base composition, and about 60 wt % to about 94 wt % of an ammonium phosphate composition, based on dry weight. In some examples, the polysaccharide-base composition may contain about 0.005 wt % to about 0.5 wt % of a polysaccharide composition, about 12 wt % to about 30 wt % of an organic base composition, and about 65 wt % to about 88 wt % of an ammonium phosphate composition, based on dry weight. In other examples, the polysaccharide-base composition may contain about 0.01 wt % to about 0.1 wt % of a polysaccharide composition, about 16 wt % to about 25 wt % of an organic base composition, and about 72 wt % to about 84 wt % of an ammonium phosphate composition, based on dry weight. In some examples, the polysaccharide-base composition may contain about 0.02 wt % to about 0.07 wt % of a polysaccharide composition, about 18 wt % to about 23 wt % of an organic base composition, and about 75 wt % to about 81 wt % of an ammonium phosphate composition, based on dry weight.

In one or more examples, the polysaccharide-base composition may contain about 0.5 wt % to about 10 wt % of a polysaccharide composition, about 10 wt % to about 35 wt % of an organic base composition, and about 60 wt % to about 88 wt % of an ammonium phosphate composition, based on dry weight. In some examples, the polysaccharide-base composition may contain about 0.8 wt % to about 5 wt % of a polysaccharide composition, about 12 wt % to about 30 wt % of an organic base composition, and about 65 wt % to about 85 wt % of an ammonium phosphate composition, based on dry weight. In other examples, the polysaccharide-base composition may contain about 1 wt % to about 3 wt % of a polysaccharide composition, about 16 wt % to about 25 wt % of an organic base composition, and about 70 wt % to about 80 wt % of an ammonium phosphate composition, based on dry weight.

In one or more examples, the polysaccharide-base composition may contain about 4 wt % to about 12 wt % of a polysaccharide composition, about 35 wt % to about 52 wt % of an organic base composition, and about 35 wt % to about 52 wt % of an ammonium phosphate composition, based on dry weight. In some examples, the polysaccharide-base composition may contain about 5 wt % to about 10 wt % of a polysaccharide composition, about 40 wt % to about 48 wt % of an organic base composition, and about 40 wt % to about 50 wt % of an ammonium phosphate composition, based on dry weight. In other examples, the polysaccharide-base composition may contain about 6 wt % to about 9 wt % of a polysaccharide composition, about 42 wt % to about 46 wt % of an organic base composition, and about 46 wt % to about 49 wt % of an ammonium phosphate composition, based on dry weight.

In one or more embodiments, the polysaccharide composition contains one or more polysaccharides, which may be non-sulfated and/or sulfated polysaccharides. In some examples, the polysaccharide composition contains one or more non-sulfated polysaccharides and one or more sulfated polysaccharides. In other examples, the polysaccharide composition contains one or more non-sulfated polysaccharides, or the polysaccharide composition contains one or more sulfated polysaccharides. The polysaccharide composition may be or contain chitosan, guar gum, one or more carrageenans, salts thereof, complexes thereof, or any combination thereof. In some examples, the polysaccharide composition contains one or more carrageenans which may include lambda carrageenan, kappa carrageenan, or any combination thereof. In other examples, the polysaccharide composition contains one, two or more carrageenans and is completely free of or substantially free of guar gum.

In one or more examples, the polysaccharide composition contains about 60 wt % to about 90 wt % of lambda carrageenan and about 10 wt % to about 40 wt % of kappa carrageenan, based on dry weight. In some examples, the polysaccharide composition contains about 65 wt % to about 85 wt % of lambda carrageenan and about 15 wt % to about 35 wt % of kappa carrageenan, based on dry weight. In other examples, the polysaccharide composition contains about 70 wt % to about 80 wt % of lambda carrageenan and about 20 wt % to about 30 wt % of kappa carrageenan, based on dry weight. In other examples, the polysaccharide composition contains about 40 wt % to about 60 wt % of lambda carrageenan and about 40 wt % to about 60 wt % of kappa carrageenan, based on dry weight.

In one or more examples, the polysaccharide composition contains about 8 wt % to about 40 wt % of guar gum, about 30 wt % to about 55 wt % of lambda carrageenan, and about 30 wt % to about 55 wt % of kappa carrageenan, based on dry weight. In some examples, the polysaccharide composition contains about 14 wt % to about 22 wt % of guar gum, about 35 wt % to about 48 wt % of lambda carrageenan, and about 35 wt % to about 48 wt % of kappa carrageenan, based on dry weight. In other examples, the polysaccharide composition contains about 16 wt % to about 19 wt % of guar gum, about 40 wt % to about 44 wt % of lambda carrageenan, and about 40 wt % to about 44 wt % of kappa carrageenan, based on dry weight.

In one or more examples, the polysaccharide composition contains about 20 wt % to about 60 wt % of chitosan, about 20 wt % to about 60 wt % of guar gum, about 3 wt % to about 20 wt % of lambda carrageenan, and about 3 wt % to about 20 wt % of kappa carrageenan, based on dry weight. In other examples, the polysaccharide composition contains about 35 wt % to about 45 wt % of chitosan, about 35 wt % to about 45 wt % of guar gum, about 5 wt % to about 15 wt % of lambda carrageenan, and about 5 wt % to about 15 wt % of kappa carrageenan, based on dry weight.

In one or more embodiments, the organic base composition contains urea, salts thereof, complexes thereof, or any combination thereof. In one or more examples, the organic base composition contains about or greater than 10 wt %, about or greater than 20 wt %, about or greater than 30 wt %, about or greater than 40 wt %, about or greater than 50 wt %, about or greater than 60 wt %, about or greater than 70 wt %, about or greater than 80 wt %, about or greater than 90 wt %, about or greater than 95 wt %, about or greater than 97 wt %, about or greater than 98 wt %, about or greater than 99 wt %, or about 100 wt % of urea, based on dry weight. In some examples, the organic base composition is completely free of or substantially free of melamine.

In some embodiments, the organic base composition contains melamine, urea, salts thereof, complexes thereof, or any combination thereof. In one or more examples, the organic base composition contains about 40 wt % to about 85 wt % of melamine and about 15 wt % to about 60 wt % of urea, based on dry weight. In other examples, the organic base composition contains about 55 wt % to about 80 wt % of melamine and about 20 wt % to about 45 wt % of urea, based on dry weight. In some examples, the organic base composition contains about 60 wt % to about 75 wt % of melamine and about 25 wt % to about 40 wt % of urea, based on dry weight. In one or more examples, the organic base composition contains about 65 wt % to about 70 wt % of melamine and about 30 wt % to about 35 wt % of urea, based on dry weight.

The ammonium phosphate composition contains one or more ammonium phosphate compounds or complexes. In some embodiments, the ammonium phosphate composition contains monobasic ammonium phosphate, dibasic ammonium phosphate, salts thereof, complexes thereof, or any combination thereof. In one or more examples, the ammonium phosphate composition contains about 20 wt % to about 80 wt % of monobasic ammonium phosphate and about 20 wt % to about 80 wt % of dibasic ammonium phosphate, based on dry weight. In other examples, the ammonium phosphate composition contains about 40 wt % to about 60 wt % of monobasic ammonium phosphate and about 40 wt % to about 60 wt % of dibasic ammonium phosphate, based on dry weight.

In one or more embodiments the polysaccharide-base composition further contains one or more oxide materials. The oxide material may be or contain silica, quartz, silicon oxide, alumina, titania, hafnia, or any combination thereof. In some embodiments, the polysaccharide-base composition may contain about 0.1 wt %, about 0.2 wt %, about 0.4 wt %, about 0.5 wt %, about 0.6 wt %, about 0.8 wt %, about 1 wt %, about 1.2 wt %, about 1.5 wt %, about 1.8 wt %, about 2 wt %, about 2.2 wt %, about 2.5 wt %, about 2.8 wt %, about 3 wt %, about 3.5 wt %, about 4 wt %, about 5 wt %, or greater of the oxide material, based on dry weight. For example, the polysaccharide-base composition may contain the oxide material at a concentration in a range from about 0.1 wt % to about 5 wt %, about 0.1 wt % to about 4 wt %, about 0.1 wt % to about 3 wt %, about 0.1 wt % to about 2.5 wt %, about 0.1 wt % to about 2 wt %, about 0.1 wt % to about 1.8 wt %, about 0.1 wt % to about 1.5 wt %, about 0.1 wt % to about 1.2 wt %, about 0.1 wt % to about 1 wt %, about 0.1 wt % to about 0.8 wt %, about 0.1 wt % to about 0.5 wt %, about 0.1 wt % to about 0.3 wt %, about 0.5 wt % to about 5 wt %, about 0.5 wt % to about 4 wt %, about 0.5 wt % to about 3 wt %, about 0.5 wt % to about 2.5 wt %, about 0.5 wt % to about 2 wt %, about 0.5 wt % to about 1.8 wt %, about 0.5 wt % to about 1.5 wt %, about 0.5 wt % to about 1.2 wt %, about 0.5 wt % to about 1 wt %, about 0.5 wt % to about 0.8 wt %, about 0.8 wt % to about 5 wt %, about 0.8 wt % to about 4 wt %, about 0.8 wt % to about 3 wt %, about 0.8 wt % to about 2.5 wt %, about 0.8 wt % to about 2 wt %, about 0.8 wt % to about 1.8 wt %, about 0.8 wt % to about 1.5 wt %, about 0.8 wt % to about 1.2 wt %, about 0.8 wt % to about 1 wt %, about 1 wt % to about 5 wt %, about 1 wt % to about 4 wt %, about 1 wt % to about 3 wt %, about 1 wt % to about 2.5 wt %, about 1 wt % to about 2 wt %, about 1 wt % to about 1.8 wt %, about 1 wt % to about 1.5 wt %, about 1 wt % to about 1.2 wt %, or about 1 wt % to about 1.1 wt %, based on dry weight.

In one or more examples, the polysaccharide-base composition contains about 0.1 wt % to about 2.5 wt % of the oxide material, based on dry weight. In some examples, the polysaccharide-base composition contains about 0.5 wt % to about 1.5 wt % of the oxide material, based on dry weight. In other examples, the polysaccharide-base composition contains about 0.8 wt % to about 1.5 wt % of the oxide material, based on dry weight. In some examples, the polysaccharide-base composition contains about 1 wt % to about 1.3 wt % of the oxide material, based on dry weight. In one or more examples, the polysaccharide-base composition contains about 0.1 wt % to about 2 wt % of the oxide material, based on dry weight. In some examples, the polysaccharide-base composition contains about 0.5 wt % to about 1.2 wt % of the oxide material, based on dry weight. In some examples, the polysaccharide-base composition contains about 0.55 wt % to about 1 wt % of the oxide material, based on dry weight. In other examples, the polysaccharide-base composition contains about 0.6 wt % to about 0.9 wt % of the oxide material, based on dry weight. In some examples, the polysaccharide-base composition contains about 0.7 wt % to about 0.8 wt % of the oxide material, based on dry weight.

In one or more examples, the bio-stimulant composition may include sugar cane alcohol (e.g., ethanol), oleic acid, sunflower lecithin surfactant, water, gluconic acid, sea salt (e.g., Dead Sea salt), fulvic acid, lecithin, soy oil, canola oil, alfalfa powder, and molasses. In some examples, the bio-stimulant composition may contain organic components, as defined by the United States Department of Agriculture (USDA), which may be or include sugar cane alcohol (e.g., ethanol), organic oleic acid, sunflower lecithin surfactant, water, organic gluconic acid, pre-dissolved sea salt, organic fulvic acid, pre-dissolved organic lecithin, organic soy oil, organic canola oil, organic alfalfa powder (pre-dissolved in water), and organic molasses.

The bio-stimulant composition contains an oil composition. In one or more embodiments, the oil composition may be or contain one or more seed oils, one or more vegetable oils, one or more essential fatty acids, one or more animal fats, or any combination thereof. In one or more examples, the bio-stimulant composition contains about 6 wt % to about 20 wt % of the oil composition. In some examples, the bio-stimulant composition contains about 8 wt % to about 15 wt % of the oil composition. In other examples, the bio-stimulant composition contains about 10 wt % to about 12 wt % of the oil composition. In one or more examples, the oil composition may be or contain canola oil, soy oil, or any combination thereof. In some examples, the bio-stimulant composition contains about 3 wt % to about 12 wt % of canola oil and about 2 wt % to about 8 wt % of soy oil.

The bio-stimulant composition contains an organic acid composition. In one or more examples, the bio-stimulant composition contains about 35 wt % to about 60 wt % of an organic acid composition. In some examples, the bio-stimulant composition contains about 42 wt % to about 52 wt % of the organic acid composition. In other examples, the bio-stimulant composition contains about 44 wt % to about 50 wt % of the organic acid composition. In some examples, the bio-stimulant composition contains about 45 wt % to about 48 wt % or about 46 wt % to about 47 wt % of the organic acid composition.

The organic acid composition may be or contain one or more organic acids. In some examples, the organic acid composition may be or contain fulvic acid, gluconic acid, oleic acid, esters thereof, salts thereof, complexes thereof, or any combination thereof. In one or more examples, the bio-stimulant composition contains about 0.4 wt % to about 2 wt % of fulvic acid, about 10 wt % to about 25 wt % of gluconic acid, and about 20 wt % to about 40 wt % of oleic acid. In some examples, the bio-stimulant composition contains about 0.6 wt % to about 1 wt % of fulvic acid, about 15 wt % to about 20 wt % of gluconic acid, and about 25 wt % to about 32 wt % of oleic acid.

The bio-stimulant composition may further contain one or more salts. Exemplary salts may be or include sodium chloride, potassium chloride, magnesium chloride, calcium chloride, potassium iodine, potassium permanganate, sodium bisulfate, magnesium sulfate, sodium acetate, potassium acetate, calcium acetate, copper sulfate, Dead Sea salt, complexes thereof, hydrates thereof, or any combination thereof.

In one or more some examples, the bio-stimulant composition contains about 0.5 wt % to about 5 wt % of the salt. In other examples, the bio-stimulant composition contains about 0.8 wt % to about 4 wt % of the salt. In some examples, the bio-stimulant composition contains about 1 wt % to about 3 wt % of the salt. In other examples, the bio-stimulant composition contains about 1.2 wt % to about 2 wt % of the salt. In other examples, the bio-stimulant composition contains about 1.5 wt % to about 1.8 wt % of the salt. In other examples, the bio-stimulant composition contains about 1.6 wt % to about 1.75 wt % of the salt.

In one or more examples, the salt contains about 40 wt % to about 60 wt % of magnesium chloride, about 32 wt % to about 42 wt % of potassium chloride, and about 4 wt % to about 15 wt % of sodium chloride, based on dry weight. In other examples, the salt contains about 50 wt % to about 55 wt % of magnesium chloride, about 35 wt % to about 39 wt % of potassium chloride, and about 6 wt % to about 10 wt % of sodium chloride, based on dry weight. In one or more examples, the salt may be or include Dead Sea salt and contain about 53 wt % of magnesium chloride, about 37 wt % of potassium chloride, and about 8 wt % of sodium chloride, based on dry weight.

The bio-stimulant composition contains an alfalfa composition. In some examples, the alfalfa composition contains ground leaves of Medicago sativa. In one or more examples, the bio-stimulant composition contains about 0.05 wt % to about 0.50 wt % of the alfalfa composition. In other examples, the bio-stimulant composition contains about 0.08 wt % to about 0.25 wt %. In some examples, the bio-stimulant composition contains about 0.12 wt % to about 0.22 wt %. In some examples, the bio-stimulant composition contains about 0.15 wt % to about 0.20 wt %.

The bio-stimulant composition contains molasses. In one or more examples, the bio-stimulant composition contains about 3 wt % to about 12 wt % of the molasses. In some examples, the bio-stimulant composition contains about 4 wt % to about 8 wt % of the molasses. In other examples, the bio-stimulant composition contains about 6 wt % to about 7.4 wt % of the molasses.

The bio-stimulant composition contains the alcohol composition which contains one or more alcohols. Optionally, the alcohol composition contains one or more solvents, such as water and/or an organic solvent. The alcohol composition may be or contain ethanol, sugar cane alcohol, methanol, propanol, butanol, glycol ethers, or combinations thereof. In one or more examples, the bio-stimulant composition contains about 10 wt % to about 25 wt % of the alcohol composition. In some examples, the bio-stimulant composition contains about 12 wt % to about 20 wt % of the alcohol composition. In other examples, the bio-stimulant composition contains about 15 wt % to about 17.5 wt % of the alcohol composition.

The bio-stimulant composition contains a surfactant composition containing one or more surfactants. The surfactant composition may be or contain one or more seed oils, one or more essential fatty acids, esters thereof, salts thereof, or any combination thereof. In some examples, the surfactant composition may be or contain linoleic acid, oleic acid, sunflower seed oil, esters thereof, salts thereof, or any combination thereof. In one or more examples, the bio-stimulant composition contains about 10 wt % to about 25 wt % of the surfactant composition. In some examples, the bio-stimulant composition contains about 14 wt % to about 20 wt % of the surfactant composition. In other examples, the bio-stimulant composition contains about 16 wt % to about 18.5 wt % of the surfactant composition.

In one or more examples, the bio-stimulant composition contains about 0.5 wt % to about 5 wt % of a salt, about 35 wt % to about 60 wt % of an organic acid composition, about 6 wt % to about 20 wt % of an oil composition, about 0.05 wt % to about 0.50 wt % of an alfalfa composition, about 3 wt % to about 12 wt % of molasses, about 10 wt % to about 25 wt % of an alcohol composition, and about 10 wt % to about 25 wt % of a surfactant composition.

In other examples, the bio-stimulant composition contains about 1 wt % to about 3 wt % of a salt, about 42 wt % to about 52 wt % of an organic acid composition, about 8 wt % to about 15 wt % of an oil composition, about 0.08 wt % to about 0.25 wt % of an alfalfa composition, about 4 wt % to about 8 wt % of a molasses, about 12 wt % to about 20 wt % of an alcohol composition, and about 14 wt % to about 20 wt % of a surfactant composition.

In some examples, the bio-stimulant composition contains about 1.5 wt % to about 2.5 wt % of a salt, about 45 wt % to about 49 wt % of an organic acid composition, about 10 wt % to about 13 wt % of an oil composition, about 0.12 wt % to about 0.2 wt % of an alfalfa composition, about 5 wt % to about 7 wt % of a molasses, about 15 wt % to about 18 wt % of an alcohol composition, and about 16 wt % to about 18 wt % of a surfactant composition.

In one or more embodiments, a fire retardant composition is provided and contains a product composition prepared from a mixture containing about 80 wt % to about 98 wt % of a polysaccharide-base composition and about 2 wt % to about 20 wt % of a bio-stimulant composition; or a reaction product of a weight ratio of the polysaccharide-base composition and the bio-stimulant composition, the weight ratio in a range from about 5:1 to about 15:1. The polysaccharide-base composition contains about 0.5 wt % to about 10 wt % of a polysaccharide composition, about 10 wt % to about 35 wt % of an organic base composition, and about 60 wt % to about 88 wt % of an ammonium phosphate composition. The polysaccharide composition contains guar gum, one or more carrageenans, salts thereof, complexes thereof, or any combination thereof. The organic base composition contains urea, salts thereof, complexes thereof, or any combination thereof. The ammonium phosphate composition contains monobasic ammonium phosphate, dibasic ammonium phosphate, salts thereof, complexes thereof, or any combination thereof. The bio-stimulant composition contains about 8 wt % to about 15 wt % of the oil composition, about 42 wt % to about 52 wt % of the organic acid composition, and about 10 wt % to about 25 wt % of the surfactant composition.

In one or more embodiments, a fire retardant composition is provided and contains a product composition prepared from a mixture containing about 88 wt % to about 98 wt % of a polysaccharide-base composition and about 2 wt % to about 12 wt % of a bio-stimulant composition; or a reaction product of a weight ratio of the polysaccharide-base composition and the bio-stimulant composition, the weight ratio in a range from about 8:1 to about 20:1. The polysaccharide-base composition contains about 4 wt % to about 12 wt % of a polysaccharide composition, about 35 wt % to about 52 wt % of an organic base composition, and about 35 wt % to about 52 wt % of an ammonium phosphate composition. The polysaccharide composition contains chitosan, guar gum, one or more carrageenans, salts thereof, complexes thereof, or any combination thereof. The organic base composition contains melamine, urea, salts thereof, complexes thereof, or any combination thereof. The ammonium phosphate composition contains monobasic ammonium phosphate, dibasic ammonium phosphate, salts thereof, complexes thereof, or any combination thereof. The bio-stimulant composition contains about 8 wt % to about 15 wt % of the oil composition, about 42 wt % to about 52 wt % of the organic acid composition, and about 10 wt % to about 25 wt % of the surfactant composition.

In one or more embodiments, the fire retardant composition may have a solid state and/or a powder state which is completely free of or substantially free of water. In other embodiments, the fire retardant composition may be a liquid state or form, such as a suspension, a dissolved solution, or a combination thereof where some components are dissolved and other components are suspended in the solution. In some embodiments, the fire retardant composition may contain water. For examples, the fire retardant composition may further contain water combined with the product composition or the reaction product, as described and discussed herein.

In one or more examples, the fire retardant composition contains water at a concentration in a range from about 10 wt %, about 15 wt %, about 20 wt %, about 25 wt %, about 30 wt %, about 35 wt %, about 40 wt %, about 42 wt %, about 45 wt %, about 48 wt %, about 50 wt %, about 52 wt %, about 55 wt %, or about 58 wt % to about 60 wt %, about 65 wt %, about 70 wt %, about 75 wt %, about 80 wt %, about 85 wt %, or about 90 wt %. For example, the fire retardant composition contains water at a concentration in a range from about 10 wt % to about 90 wt %, about 10 wt % to about 80 wt %, about 10 wt % to about 75 wt %, about 10 wt % to about 70 wt %, about 10 wt % to about 60 wt %, about 10 wt % to about 50 wt %, about 10 wt % to about 40 wt %, about 10 wt % to about 35 wt %, about 10 wt % to about 30 wt %, about 10 wt % to about 25 wt %, about 10 wt % to about 20 wt %, about 10 wt % to about 15 wt %, about 25 wt % to about 90 wt %, about 25 wt % to about 80 wt %, about 25 wt % to about 75 wt %, about 25 wt % to about 70 wt %, about 25 wt % to about 60 wt %, about 25 wt % to about 50 wt %, about 25 wt % to about 40 wt %, about 25 wt % to about 35 wt %, about 25 wt % to about 30 wt %, about 40 wt % to about 90 wt %, about 40 wt % to about 80 wt %, about 40 wt % to about 75 wt %, about 40 wt % to about 70 wt %, about 40 wt % to about 60 wt %, about 40 wt % to about 50 wt %, or about 40 wt % to about 45 wt %.

In some examples, the fire retardant composition contains the product composition or the reaction product at a concentration in a range from about 10 wt %, about 15 wt %, about 20 wt %, about 25 wt %, about 30 wt %, about 35 wt %, about 40 wt % or about 42 wt % to about 45 wt %, about 48 wt %, about 50 wt %, about 52 wt %, about 55 wt %, about 58 wt %, about 60 wt %, about 65 wt %, about 70 wt %, about 75 wt %, about 80 wt %, about 85 wt %, or about 90 wt %. For example, the fire retardant composition contains the product composition or the reaction product at a concentration in a range from about 10 wt % to about 90 wt %, about 10 wt % to about 80 wt %, about 10 wt % to about 75 wt %, about 10 wt % to about 70 wt %, about 10 wt % to about 60 wt %, about 10 wt % to about 50 wt %, about 10 wt % to about 40 wt %, about 10 wt % to about 35 wt %, about 10 wt % to about 30 wt %, about 10 wt % to about 25 wt %, about 10 wt % to about 20 wt %, about 10 wt % to about 15 wt %, about 25 wt % to about 90 wt %, about 25 wt % to about 80 wt %, about 25 wt % to about 75 wt %, about 25 wt % to about 70 wt %, about 25 wt % to about 60 wt %, about 25 wt % to about 50 wt %, about 25 wt % to about 40 wt %, about 25 wt % to about 35 wt %, about 25 wt % to about 30 wt %, about 40 wt % to about 90 wt %, about 40 wt % to about 80 wt %, about 40 wt % to about 75 wt %, about 40 wt % to about 70 wt %, about 40 wt % to about 60 wt %, about 40 wt % to about 50 wt %, or about 40 wt % to about 45 wt %.

In one or more examples, the fire retardant composition contains about 25 wt % to about 60 wt % of the product composition or the reaction product and about 40 wt % to about 75 wt % of the water. In other examples, the fire retardant composition contains about 35 wt % to about 55 wt % of the product composition or the reaction product and about 45 wt % to about 65 wt % of the water. In some examples, the fire retardant composition contains about 40 wt % to about 45 wt % of the product composition or the reaction product and about 55 wt % to about 60 wt % of the water. In other examples, the fire retardant composition contains about 40 wt % to about 60 wt % or about 50 wt % of the product composition or the reaction product and about 40 wt % to about 60 wt % or about 50 wt % of the water. In some examples, the fire retardant composition contains about 15 wt % to about 30 wt % of the product composition or the reaction product and about 70 wt % to about 85 wt % of the water.

### Methods

In one or more embodiments, a method for preparing the fire retardant composition is provided and includes combining the polysaccharide-base composition and the bio-stimulant composition to prepare the product composition and/or the reaction product. The polysaccharide-base composition contains combining a polysaccharide composition, an organic base composition, and an ammonium phosphate composition.

In one or more embodiments, a method for preparing the fire retardant composition is provided and includes combining a polysaccharide composition with water to prepare a first mixture, combining at least an organic base composition and an ammonium phosphate composition with the first mixture to prepare a polysaccharide-base composition, and combining a bio-stimulant composition and the polysaccharide-base composition to prepare a product composition or a reaction product.

More specifically, the method includes preparing the polysaccharide composition by combining the water together with one or more non-sulfated polysaccharides, one or more sulfated polysaccharides, or both one or more non-sulfated polysaccharides and one or more sulfated polysaccharides. In one or more examples, the polysaccharide composition contains chitosan, guar gum, one or more carrageenans, salts thereof, complexes thereof, or any combination thereof. In some examples, the polysaccharide composition contains the one or more carrageenans which includes lambda carrageenan, kappa carrageenan, or any combination thereof. In one or more examples, the polysaccharide composition and water are combined to prepare the first mixture at a first temperature in a range from about 23° C. to about 100° C., about 70° C. to about 100° C., about 75° C. to about 95° C., or about 80° C. to about 90° C. The mixture may be heated to the first temperature. Alternately, the water may be heated to the first temperature and then the polysaccharide composition and the water may be combined to prepare the first mixture.

In one or more examples, the water is heated to about 75° C. to about 85° C., such as about 80° C., and then kappa carrageenan is added to and dissolved in the heated water. Thereafter, the mixture containing water and kappa carrageenan is cooled to room temperature (e.g., about 23° C.) and lambda carrageenan is added to and dissolved in the mixture to produce a mixture containing water, kappa carrageenan, and lambda carrageenan. The mixture containing water, kappa carrageenan, and lambda carrageenan may stand for a period from about 8 hours to about 24 hours, such as about 10 hours to about 15 hours, or about 12 hours before adding other components.

In some embodiments, the method also includes combining the first mixture and at least melamine, urea, salts thereof, complexes thereof, or any combination thereof. In some examples, the method includes combining the first mixture and at least the ammonium phosphate composition. In other examples, the method includes combining the first mixture and at least the ammonium phosphate composition and the organic base composition. The ammonium phosphate composition may be or contain monobasic ammonium phosphate, dibasic ammonium phosphate, salts thereof, complexes thereof, or any combination thereof. In some examples, the organic base composition, the ammonium phosphate composition, and the first mixture are combined to prepare the polysaccharide-base composition at a second temperature in a range from about 23° C. to about 100° C., about 70° C. to about 100° C., about 75° C. to about 95° C., or about 80° C. to about 90° C.

The bio-stimulant composition and the polysaccharide-base composition are combined to prepare the product composition or the reaction product at a third temperature in a range from about 23° C. to about 100° C., about 40° C. to about 80° C., about 50° C. to about 70° C., or about 55° C. to about 65° C.

In one or more examples, the first temperature is in a range from about 80° C. to about 90° C., the second temperature is in a range from about 23° C. to about 100° C., and the third temperature is in a range from about 23° C. to about 100° C. In some examples, the first temperature is in a range from about 80° C. to about 90° C., the second temperature is in a range from about 80° C. to about 90° C., and the third temperature is in a range from about 50° C. to about 70° C.

In some examples, the method includes combining water and the product composition and/or combining water and the reaction product. The fire retardant composition may be or include a wet fire retardant product and may contain about 15 wt % to about 30 wt % of the product composition or the reaction product and about 70 wt % to about 85 wt % of the water.

### Fire Retardant Products

Many different types of fire retardant products may be contain and/or be prepared or otherwise produced with the fire retardant composition as described and discussed herein. In one or more embodiments, a fire retardant product may be or include one or more base products and the fire retardant composition as described and discussed herein. The fire retardant composition may be sprayed, wiped, poured, soaked, or otherwise coated onto one or more of the outer surfaces of the base product and/or soaked into any porous or hollow surfaces within the base product. Thereafter, the fire retardant composition may be dried onto any of the outer surfaces and/or inner surfaces of the base product and/or the fire retardant product. The fire retardant products may be of include a fireboard, a flame-retardant material (e.g., a flame-retardant board, lumber, wood, or wall, a flame-retardant insulation, fabric or linen, and/or other flame-retardant products). In some examples, a flame-retardant insulation product may be or include flame-retardant home insulation, flame-retardant building or structure insulation, flame-retardant automotive insulation, or flame-retardant wire insulation.

In some examples, the base product may be or include one or more wood products, one or more paper products, one or more textile products, one or more plant fiber products, one or more cellulose products, one or more resin products, one or more adhesive products, one or more plastic products, one or more natural and/or synthetic polymeric products, or any combination thereof. In some specific examples, the base product may be or include wood, lumber, a board, a particle board, a composite board, a dry wall, a cement board, or any combination thereof. The base product may be coated with or soaked in the fire retardant composition in order to produce the fire retardant product. The base product may be or include one or more wood composition elements, such as wood chips, wood fibers, cellulose fibers, wood flakes, lumber, wood particles, sawdust, wood strands, wood veneer, wood flour, hemp and/or cannabis fibers, hemp and/or cannabis flakes, hemp and/or cannabis particles, hemp and/or cannabis dust, hemp and/or cannabis strands, hemp and/or cannabis rope, hemp and/or cannabis fabric, hemp and/or cannabis cloth, hemp and/or cannabis flour, hemp and/or cannabis seeds, or any combination thereof.

In some embodiments, one or more adhesives, one or more adhesive binders, one or more bonding agents, one or more softening agents or softeners, one or more biocides, or any combination thereof may be used for bonding the wood composition elements together to make a wood composite or otherwise the base product. Exemplary adhesives, adhesive binders and/or bonding agents may be or include urea formaldehyde, melamine formaldehyde, melamine urea formaldehyde, phenol formaldehyde, crosslinking polyvinyl acetate, emulsion polymer isocyanate, resorcinol formaldehyde, resorcinol phenol formaldehyde, polyurethane, polymeric diphenylmethane diisocyanate, soy protein-based glues, or any combination thereof. Exemplary softening agents or softeners may be or include glycerin (e.g., vegetable glycerin), one or more oils and/or fats, or any combination thereof. Exemplary biocide may be or include borates (e.g., disodium octaborate tetrahydrate (DOT)), copper azoles, linseed oil, boric acid, benzalkonium chloride, a mixture containing boric acid and benzalkonium chloride (commercially available as ACS Boracol 5RH), creosote, pentachlorophenol, derivatives thereof, or any combination thereof.

In one or more embodiments, the fire retardant product contains the fire retardant composition dried onto and/or into any of the outer surfaces and/or inner surfaces of the base product. In some examples, the fire retardant product may contain the fire retardant composition at a concentration in a range from about or less than 0.5 wt %, about or less than 1 wt %, about or less than 2 wt %, about or less than 3 wt %, about or less than 4 wt %, about or less than 5 wt %, or about or less than 6 wt % to about or less than 7 wt %, about or less than 8 wt %, about or less than 9 wt %, about or less than 10 wt %, about or less than 11 wt %, about or less than 12 wt %, about or less than 13 wt %, about or less than 14 wt %, about or less than 15 wt %, about or less than 16 wt %, about or less than 18 wt %, about or less than 20 wt %, about or less than 22 wt %, about or less than 25 wt %, or greater than 25 wt %, based on the dry weight of the fire retardant composition over the weight of the fire retardant product. For example, the fire retardant product may contain the fire retardant composition at a concentration in a range from about 0.5 wt % to about or less than 25 wt %, about 0.5 wt % to about or less than 20 wt %, about 0.5 wt % to about or less than 15 wt %, about 0.5 wt % to about or less than 12 wt %, about 0.5 wt % to about or less than 11 wt %, about 0.5 wt % to about or less than 10 wt %, about 0.5 wt % to about or less than 9 wt %, about 0.5 wt % to about or less than 8 wt %, about 0.5 wt % to about or less than 7 wt %, about 0.5 wt % to about or less than 6 wt %, about 0.5 wt % to about or less than 5 wt %, about 0.5 wt % to about or less than 4 wt %, about 0.5 wt % to about or less than 3 wt %, about 0.5 wt % to about or less than 2 wt %, about 0.5 wt % to about or less than 1 wt %, about 2 wt % to about or less than 25 wt %, about 2 wt % to about or less than 20 wt %, about 2 wt % to about or less than 15 wt %, about 2 wt % to about or less than 12 wt %, about 2 wt % to about or less than 11 wt %, about 2 wt % to about or less than 10 wt %, about 2 wt % to about or less than 9 wt %, about 2 wt % to about or less than 8 wt %, about 2 wt % to about or less than 7 wt %, about 2 wt % to about or less than 6 wt %, about 2 wt % to about or less than 5 wt %, about 2 wt % to about or less than 4 wt %, about 2 wt % to about or less than 3 wt %, about 5 wt % to about or less than 25 wt %, about 5 wt % to about or less than 20 wt %, about 5 wt % to about or less than 15 wt %, about 5 wt % to about or less than 12 wt %, about 5 wt % to about or less than 11 wt %, about 5 wt % to about or less than 10 wt %, about 5 wt % to about or less than 9 wt %, about 5 wt % to about or less than 8 wt %, about 5 wt % to about or less than 7 wt %, about 5 wt % to about or less than 6 wt %, about 8 wt % to about or less than 25 wt %, about 8 wt % to about or less than 20 wt %, about 8 wt % to about or less than 15 wt %, about 8 wt % to about or less than 12 wt %, about 8 wt % to about or less than 11 wt %, about 8 wt % to about or less than 10 wt %, or about 8 wt % to about or less than 9 wt %, based on the dry weight of the fire retardant composition over the weight of the fire retardant product. In other examples, the fire retardant product may contain the fire retardant composition at a concentration of less than 25 wt %, less than 22 wt %, less than 20 wt %, less than 18 wt %, less than 15 wt %, less than 12 wt %, less than 11 wt %, less than 10 wt %, less than 9 wt %, less than 8 wt %, less than 7 wt %, less than 6 wt %, less than 5 wt %, less than 4 wt %, less than 3 wt %, less than 2 wt %, or less than 1 wt %, such as, about 0.5%, based on the dry weight of the fire retardant composition over the weight of the fire retardant product.

In one or more embodiments, the fire retardant product may be or include a hemp and/or cannabis-containing board (e.g., a hemp and/or cannabis-containing fire board or a hemp and/or cannabis-containing insulation fire board), a hemp and/or cannabis-containing insulation material or product (e.g., a flame-retardant home insulation, a flame-retardant building or structure insulation, a flame-retardant automotive insulation, or a flame-retardant wire insulation). In one or more examples, a hemp and/or cannabis-containing board may have less than 15 wt % of the fire retardant composition, such as about 0.5 wt % to about 12 wt %, about 0.5 wt % to about 10 wt %, about 0.5 wt % to about 8 wt %, about 0.5 wt % to about 6 wt %, about 0.5 wt % to about 5 wt %, about 0.5 wt % to about 4 wt %, about 0.5 wt % to about 3 wt %, about 0.5 wt % to about 2 wt %, about 0.5 wt % to about 1 wt %, about 2 wt % to about 12 wt %, about 2 wt % to about 10 wt %, about 2 wt % to about 8 wt %, about 2 wt % to about 6 wt %, about 2 wt % to about 5 wt %, about 2 wt % to about 4 wt %, about 2 wt % to about 3 wt %, about 5 wt % to about 12 wt %, about 5 wt % to about 10 wt %, about 5 wt % to about 8 wt %, or about 5 wt % to about 6 wt % of the fire retardant composition, based on the dry weight of the fire retardant composition over the weight of the fire retardant product. In some examples, the hemp and/or cannabis-containing board may contain one or more softening agents or softeners.

In other examples, a hemp and/or cannabis-containing insulation material or product may have less than 15 wt % of the fire retardant composition, such as about 0.5 wt % to about 12 wt %, about 0.5 wt % to about 10 wt %, about 0.5 wt % to about 8 wt %, about 0.5 wt % to about 6 wt %, about 0.5 wt % to about 5 wt %, about 0.5 wt % to about 4 wt %, about 0.5 wt % to about 3 wt %, about 0.5 wt % to about 2 wt %, about 0.5 wt % to about 1 wt %, about 2 wt % to about 12 wt %, about 2 wt % to about 10 wt %, about 2 wt % to about 8 wt %, about 2 wt % to about 6 wt %, about 2 wt % to about 5 wt %, about 2 wt % to about 4 wt %, about 2 wt % to about 3 wt %, about 5 wt % to about 12 wt %, about 5 wt % to about 10 wt %, about 5 wt % to about 8 wt %, or about 5 wt % to about 6 wt % of the fire retardant composition, based on the dry weight of the fire retardant composition over the weight of the fire retardant product.

In other embodiments, the fire retardant composition may be used as a dry fire retardant product which may be applied to fires by dropping or otherwise displacing the dry fire retardant product from aircraft (e.g., aerial firefighting from fixed-wing aircraft and/or helicopter), applying by a firefighting ground crew, or administrating the dry fire retardant product from extinguishers and/or fixed spray systems. In some embodiments, the fire retardant composition may be used as a wet, gel, or foam fire retardant product. For example, the base product contains water and/or one or more aqueous gels and/or one or more aqueous foams and the fire retardant composition may be suspended, mixed, or otherwise combined therein. In one example, the fire retardant composition is suspended, mixed, or otherwise combined in water or an aqueous solution to produce a wet fire retardant product. In other examples, the fire retardant composition is suspended, mixed, or otherwise combined in one or more aqueous foams to produce a foam fire retardant product. In some examples, the fire retardant composition is suspended, mixed, or otherwise combined in one or more aqueous gels to produce a gel fire retardant product. The foam or gel fire retardant product may also contain one or more surfactants and/or other additives.

### EXPERIMENTAL SECTION

Example 1: Bio-Stimulant Composition—In a blender/mixer, 60 gallons of organic sugar cane alcohol (e.g., ethanol) and 120 gallons of oleic acid were mixed with constant stirring for about 3 hours. Then, 55 gallons of organic sunflower lecithin surfactant was mixed with 55 gallons of water with constant stirring for about 2 hours. Then, 60 gallons of gluconic acid was added and mixed for about 1 hour. Then, 50 pounds of Dead Sea salt (dissolved for 24 hours) was mixed with 20 gallons of water and 3 pounds of fulvic acid for about 1 hour. Then, 10 pounds of lecithin (dissolved for 24 hours) was added with 20 gallons of water and was mixed for about 1 hour. Then, 10 gallons of soy oil and 27.5 gallons of canola oil were mixed for about 1 hour. Then, 3 pounds of alfalfa (dissolved for 24 hours) and 15 gallons of water were added to the mixture. Then, 15 gallons of molasses was slow mixed with 156 gallons of water for about 8 hours at ambient temperature (about 23° C.).

Example 2: Bio-Stimulant Composition—In a blender/mixer, 490 pounds of organic sugar cane alcohol (e.g., ethanol) and 850 pounds of oleic acid were mixed with constant stirring for about 3 hours. Then, 525 pounds of organic sunflower lecithin surfactant was mixed into the mixture with constant stirring for about 2 hours. Then, 510 pounds of gluconic acid was added into the mixture and mixed for about 1 hour. Then, 50 pounds of Dead Sea salt and 25 pounds of fulvic acid was mixed into the mixture for about 1 hour. Then, 120 pounds of soy oil and 200 pounds of canola oil were added into the mixture and mixed for about 1 hour. Then, 5 pounds of alfalfa was added into the mixture an stirred for 1 hour. Then, 200 pounds of molasses was slow mixed into the mixture and stirred for about 8 hours at ambient temperature (about 23° C.).

Example 3: Polysaccharide-Base Composition—In a high speed blender/mixer, the following was added to 800 ml of water (85° C.), already blending at high speed: 2 g of chitosan (CAS 9012-76-4) and 2 g of guar gum (CAS 9000-30-0). This was blended at high speed until dissolved. Once dissolved, the following was added into the mixture: 0.5 g of lambda carrageenan and 0.5 g of kappa carrageenan. The mixture was blended until dissolved. The mixture, at this point was transferred to a temperature controlled, lower speed mixing device. At 85° C., as the mixture was blended, the following was added: 20 g of melamine (CAS 108-78-1), 16 g of monobasic ammonium phosphate (NH₄)H₂PO₄ (CAS 7722-76-1), 16 g of dibasic ammonium phosphate (NH₄)₂HPO₄ (CAS 7783-28-0), 0.5 g of silica (CAS 708-78-1), and 10 g of urea (CAS 57-13-6). Once dissolved, the temperature was lowered to 60° C., while continuing to spin.

Example 4: Fire Retardant Composition—The full mixture prepared in Example 3 was maintained at 60° C., then 5 g of the bio-stimulant composition of Example 1 was added to the mixture.

The temperature was maintained until the solvent (e.g., water) was evaporated to one-half of the original volume. The temperature was then decreased to 40° C., for an additional reduction, and then temperature was turned off. In one example, the final volume was about one-third of original volume. This product was a wet fire retardant product.

In another example, the mixture was blended and maintained at 40° C. for about 1 hour. The mixture was put on a drying sheet/pan to air dry completely. The resulting solid was then crushed to create the powder form a dry fire retardant product.

Example 5: Fire Retardant Composition—The full mixture prepared in Example 3 was maintained at 60° C., then 5 g of the bio-stimulant composition of Example 2 was added to the mixture.

The temperature was maintained until the solvent (e.g., water) was evaporated to one-half of the original volume. The temperature was then decreased to 40° C., for an additional reduction, and then temperature was turned off. In one example, the final volume was about one-third of original volume. This product was a wet fire retardant product.

In another example, the mixture was blended and maintained at 40° C. for about 1 hour. The mixture was put on a drying sheet/pan to air dry completely. The resulting solid was then crushed to create the powder form a dry fire retardant product.

Example 6: Polysaccharide-Base Composition—In a high speed blender/mixer, 1.3 g of guar gum and 3 g of lambda carrageenan were added to 4 L of water at about 23° C. and blended at high speed until dissolved. Under constant stirring, the temperature was raised to about 85° C. Then, 3 g of kappa carrageenan was added to the mixture. Once components were combined, 30 g of melamine was added to and combined in the mixture. Then, 140 g of diammonium phosphate, 140 g of ammonium phosphate (monobasic), and 75 g of urea were added to the mixture. Then, 3.75 g of silica was added to the mixture. The mixture was blended and maintained at about 85° C. until components were combined.

Example 7: Fire Retardant Composition—The full mixture prepared in Example 6 was maintained at 85° C., then 40 g of the bio-stimulant composition of Example 1 was added to the mixture.

The temperature was maintained until the solvent (e.g., water) was evaporated to about 60% of the original volume (after about 6-8 hours). Heating was stopped and the mixture was stirred until the temperature reached room temperature (about 23° C.).

In one example, this mixture had a final concentration of about 12 wt % solids. This product was a wet fire retardant product.

In another example, this mixture was filtered such that the liquid was separated from the solid. The solid was put on a drying sheet/pan to air dry completely. The resulting solid was then crushed to create the powder form a dry fire retardant product.

Example 8: Fire Retardant Composition—The full mixture prepared in Example 6 was maintained at 85° C., then 40 g of the bio-stimulant composition of Example 2 was added to the mixture.

The temperature was maintained until the solvent (e.g., water) was evaporated to about 60% of the original volume (after about 6-8 hours). Heating was stopped and the mixture was stirred until the temperature reached room temperature (about 23° C.).

In one example, this mixture had a final concentration of about 12 wt % solids. This product was a wet fire retardant product.

In another example, this mixture was filtered such that the liquid was separated from the solid. The solid was put on a drying sheet/pan to air dry completely. The resulting solid was then crushed to create the powder form a dry fire retardant product.

Example 9: Polysaccharide-Base Composition—In a high speed blender/mixer, 3.2 g of guar gum and 7.5 g of lambda carrageenan were added to 4 L of water at about 23° C. and blended at high speed until combined. Under constant stirring, the temperature was raised to about 85° C. Then, 7.5 g of kappa carrageenan was added to the mixture. Once components were combined, 344 g of diammonium phosphate, 344 g of ammonium phosphate (monobasic), and 185 g of urea were added to the mixture. Then, 9.7 g of silica were added to the mixture. The mixture was blended and maintained at about 85° C. until components were combined.

Example 10: Fire Retardant Composition—The full mixture prepared in Example 9 was maintained at 85° C., then 40 g of the bio-stimulant composition of Example 1 was added to the mixture.

The temperature was maintained until the solvent (e.g., water) was evaporated to about 60% of the original volume (after about 6-8 hours). Heating was stopped and the mixture was stirred until the temperature reached room temperature (about 23° C.).

In one example, this mixture had a final concentration of about 12 wt % solids. This product was a wet fire retardant product.

In another example, this mixture was filtered such that the liquid was separated from the solid. The solid was put on a drying sheet/pan to air dry completely. The resulting solid was then crushed to create the powder form a dry fire retardant product.

Example 11: Fire Retardant Composition—The full mixture prepared in Example 9 was maintained at 85° C., then 40 g of the bio-stimulant composition of Example 2 was added to the mixture.

The temperature was maintained until the solvent (e.g., water) was evaporated to about 60% of the original volume (after about 6-8 hours). Heating was stopped and the mixture was stirred until the temperature reached room temperature (about 23° C.).

In one example, this mixture had a final concentration of about 12 wt % solids. This product was a wet fire retardant product.

In another example, this mixture was filtered such that the liquid was separated from the solid. The solid was put on a drying sheet/pan to air dry completely. The resulting solid was then crushed to create the powder form a dry fire retardant product.

Example 12: Polysaccharide-Base Composition—In a high speed blender/mixer, 0.32 g of kappa carrageenan was added to 4 L of water at about 80° C. and blended at high speed until dissolved. Under constant stirring, the mixture was allowed to cool to a temperature of about 23° C. Then, 0.96 g of lambda carrageenan is added to the mixture and blended at high speed until dissolved. Then, the mixture was allowed to stand for about 12 hours. Thereafter, the mixture was heated to about 85° C., and 1.12 kg of diammonium phosphate, 1.12 kg of ammonium phosphate (monobasic), and 600 g of urea were added to the mixture. Then, 30 g of silica was added to the mixture. The mixture is blended and maintained at about 85° C. until components are combined.

Example 13: Fire Retardant Composition—The full mixture prepared in Example 12 was maintained at 85° C., then 32 g of the bio-stimulant composition of Example 1 was added to the mixture.

The temperature was maintained until the solvent (e.g., water) was evaporated to about 60% of the original volume (after about 6-8 hours). Heating was stopped and the mixture was stirred until the temperature reached room temperature (about 23° C.).

In one example, this mixture had a final concentration of about 41 wt % solids. This product was a wet fire retardant product.

In another example, this mixture was filtered such that the liquid was separated from the solid. The solid was put on a drying sheet/pan to air dry completely. The resulting solid was then crushed to create the powder form a dry fire retardant product.

Example 14: Fire Retardant Composition—The full mixture prepared in Example 12 was maintained at 85° C., then 32 g of the bio-stimulant composition of Example 2 was added to the mixture.

The temperature was maintained until the solvent (e.g., water) was evaporated to about 60% of the original volume (after about 6-8 hours). Heating was stopped and the mixture was stirred until the temperature reached room temperature (about 23° C.).

In one example, this mixture had a final concentration of about 65 wt % solids. This product was a wet fire retardant product.

In another example, this mixture was filtered such that the liquid was separated from the solid. The solid was put on a drying sheet/pan to air dry completely. The resulting solid was then crushed to create the powder form a dry fire retardant product.

Example 15: Polysaccharide-Base Composition—In a high speed blender/mixer, 0.96 g of kappa carrageenan was added to 4 L of water at about 80° C. and blended at high speed until dissolved. Under constant stirring, the mixture was allowed to cool to a temperature of about 23° C. Then, 0.96 g of lambda carrageenan is added to the mixture and blended at high speed until dissolved. Then, the mixture was allowed to stand for about 12 hours. Thereafter, the mixture was heated to about 85° C., and 1.12 kg of diammonium phosphate, 1.12 kg of ammonium phosphate (monobasic), and 600 g of urea were added to the mixture. Then, 30 g of silica was added to the mixture. The mixture is blended and maintained at about 85° C. until components are combined.

Example 16: Fire Retardant Composition—The full mixture prepared in Example 15 was maintained at 85° C., then 32 g of the bio-stimulant composition of Example 1 was added to the mixture.

The temperature was maintained until the solvent (e.g., water) was evaporated to about 60% of the original volume (after about 6-8 hours). Heating was stopped and the mixture was stirred until the temperature reached room temperature (about 23° C.).

In one example, this mixture had a final concentration of about 41 wt % solids. This product was a wet fire retardant product.

In another example, this mixture was filtered such that the liquid was separated from the solid. The solid was put on a drying sheet/pan to air dry completely. The resulting solid was then crushed to create the powder form a dry fire retardant product.

Example 17: Fire Retardant Composition—The full mixture prepared in Example 15 was maintained at 85° C., then 32 g of the bio-stimulant composition of Example 2 was added to the mixture.

The temperature was maintained until the solvent (e.g., water) was evaporated to about 60% of the original volume (after about 6-8 hours). Heating was stopped and the mixture was stirred until the temperature reached room temperature (about 23° C.).

In one example, this mixture had a final concentration of about 65 wt % solids. This product was a wet fire retardant product.

In another example, this mixture was filtered such that the liquid was separated from the solid. The solid was put on a drying sheet/pan to air dry completely. The resulting solid was then crushed to create the powder form a dry fire retardant product.

### EXEMPLARY EMBODIMENTS

The present disclosure provides, among others, the following embodiments, each of which may be considered as optionally including any alternate embodiments per one or more of the following Clauses contained in Clause Groups 1-6. Any one or more Clauses within Clause Group 1, 2, 3, 4, 5, or 6 may be combined with any one or more Clauses within any one or more of Clause Group 1, 2, 3, 4, 5, or 6. The Clause Groups 1-6 are as follows:

### Clause Group 1 Containing the Following Clauses 1-72:

Clause 1. A fire retardant composition, comprising: a product composition prepared from a mixture comprising: about 88 weight percent (wt %) to about 98 wt % of a polysaccharide-base composition; and about 2 wt % to about 12 wt % of a bio-stimulant composition, based on dry weight.

Clause 2. The fire retardant composition according to Clause 1, wherein the mixture comprises: about 90 wt % to about 96 wt % of the polysaccharide-base composition; and about 4 wt % to about 10 wt % of the bio-stimulant composition, based on dry weight.

Clause 3. The fire retardant composition according to Clause 1 or 2, wherein the mixture comprises: about 92 wt % to about 94 wt % of the polysaccharide-base composition; and about 6 wt % to about 8 wt % of the bio-stimulant composition, based on dry weight.

Clause 4. A fire retardant composition, comprising: a reaction product of a weight ratio of a polysaccharide-base composition and a bio-stimulant composition, the weight ratio in a range from about 8:1 to about 20:1, based on dry weight.

Clause 5. The fire retardant composition according to Clause 4, wherein the weight ratio is from about 10:1 to about 18:1, based on dry weight.

Clause 6. The fire retardant composition according to Clause 4 or 5, wherein the weight ratio is from about 12:1 to about 15:1, based on dry weight.

Clause 7. The fire retardant composition according to any one of Clauses 1-6, wherein the polysaccharide-base composition comprises: about 4 wt % to about 12 wt % of a polysaccharide composition; about 35 wt % to about 52 wt % of an organic base composition; and about 35 wt % to about 52 wt % of an ammonium phosphate composition, based on dry weight.

Clause 8. The fire retardant composition according to Clause 7, wherein the polysaccharide-base composition comprises: about 5 wt % to about 10 wt % of the polysaccharide composition; about 40 wt % to about 48 wt % of the organic base composition; and about 40 wt % to about 50 wt % of the ammonium phosphate composition, based on dry weight.

Clause 9. The fire retardant composition according to Clause 8, wherein the polysaccharide-base composition comprises: about 6 wt % to about 9 wt % of the polysaccharide composition; about 42 wt % to about 46 wt % of the organic base composition; and about 46 wt % to about 49 wt % of the ammonium phosphate composition, based on dry weight.

Clause 10. The fire retardant composition according to any one of Clauses 7-9, wherein the polysaccharide composition comprises one or more non-sulfated polysaccharides and one or more sulfated polysaccharides.

Clause 11. The fire retardant composition according to any one of Clauses 7-10, wherein the polysaccharide composition comprises chitosan, guar gum, one or more carrageenans, salts thereof, complexes thereof, or any combination thereof.

Clause 12. The fire retardant composition according to Clause 11, wherein the polysaccharide composition comprises the one or more carrageenans which includes lambda carrageenan, kappa carrageenan, or any combination thereof.

Clause 13. The fire retardant composition according to any one of Clauses 7-12, wherein the polysaccharide composition comprises: about 20 wt % to about 60 wt % of chitosan; about 20 wt % to about 60 wt % of guar gum; about 3 wt % to about 20 wt % of lambda carrageenan; and about 3 wt % to about 20 wt % of kappa carrageenan, based on dry weight.

Clause 14. The fire retardant composition according to any one of Clauses 7-13, wherein the polysaccharide composition comprises: about 35 wt % to about 45 wt % of chitosan; about 35 wt % to about 45 wt % of guar gum; about 5 wt % to about 15 wt % of lambda carrageenan; and about 5 wt % to about 15 wt % of kappa carrageenan, based on dry weight.

Clause 15. The fire retardant composition according to any one of Clauses 7-14, wherein the organic base composition comprises melamine, urea, salts thereof, complexes thereof, or any combination thereof.

Clause 16. The fire retardant composition according to any one of Clauses 7-15, wherein the organic base composition comprises: about 40 wt % to about 85 wt % of melamine; and about 15 wt % to about 60 wt % of urea, based on dry weight.

Clause 17. The fire retardant composition according to Clause 16, wherein the organic base composition comprises: about 55 wt % to about 80 wt % of melamine; and about 20 wt % to about 45 wt % of urea, based on dry weight.

Clause 18. The fire retardant composition according to any one of Clauses 7-phosphate, dibasic ammonium phosphate, salts thereof, complexes thereof, or any combination thereof.

Clause 19. The fire retardant composition according to any one of Clauses 7-18, wherein the ammonium phosphate composition comprises: about 20 wt % to about 80 wt % of monobasic ammonium phosphate; and about 20 wt % to about 80 wt % of dibasic ammonium phosphate, based on dry weight.

Clause 20. The fire retardant composition according to Clause 19, wherein the ammonium phosphate composition comprises: about 40 wt % to about 60 wt % of monobasic ammonium phosphate; and about 40 wt % to about 60 wt % of dibasic ammonium phosphate, based on dry weight.

Clause 21. The fire retardant composition according to any one of Clauses 1-20, wherein the polysaccharide-base composition further comprises an oxide material, based on dry weight.

Clause 22. The fire retardant composition according to Clause 21, wherein the polysaccharide-base composition comprises about 0.1 wt % to about 2 wt % of the oxide material, based on dry weight.

Clause 23. The fire retardant composition according to Clause 22, wherein the polysaccharide-base composition comprises about 0.5 wt % to about 1.2 wt % of the oxide material.

Clause 24. The fire retardant composition according to any one of Clauses 21-23, wherein the oxide material comprises silica, quartz, silicon oxide, alumina, titania, hafnia, or any combination thereof.

Clause 25. The fire retardant composition according to any one of Clauses 1-24, wherein the bio-stimulant composition comprises about 6 wt % to about 20 wt % of an oil composition.

Clause 26. The fire retardant composition according to Clause 25, wherein the bio-stimulant composition comprises about 8 wt % to about 15 wt % of the oil composition.

Clause 27. The fire retardant composition according to Clause 25, wherein the oil composition comprises a seed oil, a vegetable oil, an essential fatty acid, an animal fat, or any combination thereof.

Clause 28. The fire retardant composition according to Clause 25, wherein the oil composition comprises canola oil, soy oil, or any combination thereof.

Clause 29. The fire retardant composition according to any one of Clauses 1-24, wherein the bio-stimulant composition comprises: about 3 wt % to about 12 wt % of canola oil; and about 2 wt % to about 8 wt % of soy oil.

Clause 30. The fire retardant composition according to any one of Clauses 1-24, wherein the bio-stimulant composition comprises about 35 wt % to about 60 wt % of an organic acid composition.

Clause 31. The fire retardant composition according to Clause 30, wherein the bio-stimulant composition comprises about 42 wt % to about 52 wt % of the organic acid composition.

Clause 32. The fire retardant composition according to Clause 30, wherein the organic acid composition comprises fulvic acid, gluconic acid, oleic acid, esters thereof, salts thereof, or any combination thereof.

Clause 33. The fire retardant composition according to Clause 30, wherein the bio-stimulant composition comprises: about 0.4 wt % to about 2 wt % of fulvic acid; about 10 wt % to about 25 wt % of gluconic acid; and about 20 wt % to about 40 wt % of oleic acid.

Clause 34. The fire retardant composition according to Clause 30, wherein the bio-stimulant composition comprises: about 0.6 wt % to about 1 wt % of fulvic acid; about 15 wt % to about 20 wt % of gluconic acid; and about 25 wt % to about 32 wt % of oleic acid.

Clause 35. The fire retardant composition according to any one of Clauses 1-24, wherein the bio-stimulant composition further comprises a salt.

Clause 36. The fire retardant composition according to Clause 35, wherein the bio-stimulant composition comprises about 0.5 wt % to about 5 wt % of the salt.

Clause 37. The fire retardant composition according to Clause 35, wherein the bio-stimulant composition comprises about 1 wt % to about 3 wt % of the salt.

Clause 38. The fire retardant composition according to Clause 35, wherein the salt comprises sodium chloride, potassium chloride, magnesium chloride, potassium iodine, or any combination thereof.

Clause 39. The fire retardant composition according to Clause 35, wherein the salt comprises: about 40 wt % to about 60 wt % of magnesium chloride; about 32 wt % to about 42 wt % of potassium chloride; and about 4 wt % to about 15 wt % of sodium chloride, based on dry weight.

Clause 40. The fire retardant composition according to Clause 35, wherein the salt comprises: about 50 wt % to about 55 wt % of magnesium chloride; about 35 wt % to about 39 wt % of potassium chloride; and about 6 wt % to about 10 wt % of sodium chloride, based on dry weight.

Clause 41. The fire retardant composition according to any one of Clauses 1-24, wherein the bio-stimulant composition comprises an alfalfa composition.

Clause 42. The fire retardant composition according to Clause 41, wherein the bio-stimulant composition comprises about 0.05 wt % to about 0.50 wt % of the alfalfa composition.

Clause 43. The fire retardant composition according to Clause 41, wherein the alfalfa composition comprises ground leaves of Medicago sativa.

Clause 44. The fire retardant composition according to any one of Clauses 1-24, wherein the bio-stimulant composition comprises molasses.

Clause 45. The fire retardant composition according to Clause 44, wherein the bio-stimulant composition comprises about 3 wt % to about 12 wt % of the molasses.

Clause 46. The fire retardant composition according to any one of Clauses 1-24, wherein the bio-stimulant composition comprises an alcohol composition.

Clause 47. The fire retardant composition according to Clause 46, wherein the bio-stimulant composition comprises about 10 wt % to about 25 wt % of the alcohol composition.

Clause 48. The fire retardant composition according to Clause 46, wherein the alcohol composition comprises ethanol, sugar cane alcohol, or combinations thereof.

Clause 49. The fire retardant composition according to any one of Clauses 1-24, wherein the bio-stimulant composition comprises a surfactant composition.

Clause 50. The fire retardant composition according to Clause 49, wherein the bio-stimulant composition comprises about 10 wt % to about 25 wt % of the surfactant composition.

Clause 51. The fire retardant composition according to Clause 49, wherein the surfactant composition comprises linoleic acid, oleic acid, sunflower seed oil, or combinations thereof.

Clause 52. The fire retardant composition according to any one of Clauses 1-51, wherein the bio-stimulant composition comprises: about 0.5 wt % to about 5 wt % of a salt; about 35 wt % to about 60 wt % of an organic acid composition; about 6 wt % to about 20 wt % of an oil composition; about 0.05 wt % to about 0.50 wt % of an alfalfa composition; about 3 wt % to about 12 wt % of molasses; about 10 wt % to about 25 wt % of an alcohol composition; and about 10 wt % to about 25 wt % of a surfactant composition.

Clause 53. The fire retardant composition according to any one of Clauses 1-52, wherein the bio-stimulant composition comprises: about 1 wt % to about 3 wt % of a salt; about 42 wt % to about 52 wt % of an organic acid composition; about 8 wt % to about 15 wt % of an oil composition; about 0.08 wt % to about 0.25 wt % of an alfalfa composition; about 4 wt % to about 8 wt % of a molasses; about 12 wt % to about 20 wt % of an alcohol composition; and about 14 wt % to about 20 wt % of a surfactant composition.

Clause 54. The fire retardant composition according to any one of Clauses 1-53, further comprising water combined with the product composition or the reaction product.

Clause 55. The fire retardant composition according to Clause 54, wherein the fire retardant composition comprises: about 15 wt % to about 30 wt % of the product composition or the reaction product; and about 70 wt % to about 85 wt % of the water.

Clause 56. A method for preparing the fire retardant composition according to any one of Clauses 1-55, comprising: combining the polysaccharide-base composition and the bio-stimulant composition to prepare the product composition or the reaction product.

Clause 57. A fire retardant product, comprising: a base product; and the fire retardant composition according to any one of Clauses 1-56.

Clause 58. The fire retardant product according to Clause 57, wherein the base product comprises a wood product, a paper product, a textile product, a plant fiber product, a hemp and/or cannabis fiber product, a cellulose product, a resin product, an adhesive product, a plastic product, a polymeric product, or any combination thereof.

Clause 59. The fire retardant product according to Clause 57, wherein the base product comprises wood, lumber, a board, a particle board, a dry wall, a cement board, or any combination thereof.

Clause 60. The fire retardant product according to Clause 57, wherein the base product comprises hemp and/or cannabis, hemp and/or cannabis fibers, hemp and/or cannabis flakes, hemp and/or cannabis particles, hemp and/or cannabis dust, hemp and/or cannabis strands, hemp and/or cannabis rope, hemp and/or cannabis fabric, hemp and/or cannabis cloth, hemp and/or cannabis flour, hemp and/or cannabis seeds, or any combination thereof.

Clause 61. The fire retardant product according to any one of Clauses 57-60, wherein the fire retardant product is a hemp and/or cannabis-containing board, a hemp and/or cannabis-containing fire board, or a hemp and/or cannabis-containing insulation fire board.

Clause 62. The fire retardant product according to any one of Clauses 57-61, wherein the fire retardant product is a hemp and/or cannabis-containing insulation material or product, a flame-retardant home insulation, a flame-retardant building or structure insulation, a flame-retardant automotive insulation, or a flame-retardant wire insulation.

Clause 63. The fire retardant product according to any one of Clauses 57-62, wherein the fire retardant product contains less than 15 wt % of the fire retardant composition.

Clause 64. The fire retardant product according to Clause 63, wherein the fire retardant product contains about 0.5 wt % to about 10 wt % of the fire retardant composition.

Clause 65. The fire retardant product according to any one of Clauses 57-64, further comprising a softening agent or a softener.

Clause 66. The fire retardant product according to Clause 65, wherein the softening agent or the softener comprises glycerin.

Clause 67. The fire retardant product according to any one of Clauses 57-66, further comprising a biocide.

Clause 68. The fire retardant product according to Clause 67, wherein the biocide comprises a borate, copper azole, linseed oil, boric acid, benzalkonium chloride, a mixture of boric acid and benzalkonium chloride, creosote, pentachlorophenol, derivatives thereof, or any combination thereof.

Clause 69. The fire retardant product according to Clause 57, wherein the base product comprises an aqueous foam or an aqueous gel.

Clause 70. A fire retardant composition, comprising: a product composition prepared from a mixture comprising: about 88 weight percent (wt %) to about 98 wt % of a polysaccharide-base composition; and about 2 wt % to about 12 wt % of a bio-stimulant composition, based on dry weight; or a reaction product of a weight ratio of the polysaccharide-base composition and the bio-stimulant composition, the weight ratio in a range from about 8:1 to about 20:1, based on dry weight; wherein the polysaccharide-base composition comprises: about 4 wt % to about 12 wt % of a polysaccharide composition; about 35 wt % to about 52 wt % of an organic base composition; and about 35 wt % to about 52 wt % of an ammonium phosphate composition, based on dry weight; wherein the polysaccharide composition comprises chitosan, guar gum, one or more carrageenans, salts thereof, complexes thereof, or any combination thereof; wherein the organic base composition comprises melamine, urea, salts thereof, complexes thereof, or any combination thereof; wherein the ammonium phosphate composition comprises monobasic ammonium phosphate, dibasic ammonium phosphate, salts thereof, complexes thereof, or any combination thereof; and wherein the bio-stimulant composition comprises about 8 wt % to about 15 wt % of the oil composition; about 42 wt % to about 52 wt % of the organic acid composition; and about 10 wt % to about 25 wt % of the surfactant composition, based on dry weight.

Clause 71. A fire retardant composition and/or a fire retardant product according to any one, two, or more of Clauses 1-70 combined and as further described and discussed herein.

Clause 72. A method for preparing a fire retardant composition and/or a fire retardant product according to any one, two, or more of Clauses 1-71 combined and as further described and discussed herein.

### Clause Group 2 Containing the Following Clauses 1-115:

Clause 1. A method for preparing the fire retardant composition, comprising: combining a polysaccharide-base composition and a bio-stimulant composition to prepare a product composition or a reaction product.

Clause 2. The method according to Clause 1, further comprising combining a polysaccharide composition, an organic base composition, and an ammonium phosphate composition to prepare the polysaccharide-base composition.

Clause 3. The method according to Clause 1 or 2, wherein the product composition is prepared from a mixture comprising: about 88 weight percent (wt %) to about 98 wt % of the polysaccharide-base composition; and about 2 wt % to about 12 wt % of the bio-stimulant composition, based on dry weight.

Clause 4. The method according to any one of Clauses 1-3, wherein the mixture comprises: about 90 wt % to about 96 wt % of the polysaccharide-base composition; and about 4 wt % to about 10 wt % of the bio-stimulant composition, based on dry weight.

Clause 5. The method according to any one of Clauses 1-4, wherein the mixture comprises: about 92 wt % to about 94 wt % of the polysaccharide-base composition; and about 6 wt % to about 8 wt % of the bio-stimulant composition, based on dry weight.

Clause 6. The method according to any one of Clauses 1-5, wherein the reaction product is prepared from a weight ratio of the polysaccharide-base composition and the bio-stimulant composition, the weight ratio in a range from about 8:1 to about 20:1, based on dry weight.

Clause 7. The method according to any one of Clauses 1-6, wherein the weight ratio is from about 10:1 to about 18:1, based on dry weight.

Clause 8. The method according to any one of Clauses 1-7, wherein the weight ratio is from about 12:1 to about 15:1, based on dry weight.

Clause 9. The method according to any one of Clauses 1-8, wherein the polysaccharide-base composition comprises: about 4 wt % to about 12 wt % of a polysaccharide composition; about 35 wt % to about 52 wt % of an organic base composition; and about 35 wt % to about 52 wt % of an ammonium phosphate composition, based on dry weight.

Clause 10. The method according to any one of Clauses 1-9, wherein the polysaccharide-base composition comprises: about 5 wt % to about 10 wt % of a polysaccharide composition; about 40 wt % to about 48 wt % of an organic base composition; and about 40 wt % to about 50 wt % of an ammonium phosphate composition, based on dry weight.

Clause 11. The method according to any one of Clauses 1-10, wherein the polysaccharide-base composition comprises: about 6 wt % to about 9 wt % of a polysaccharide composition; about 42 wt % to about 46 wt % of an organic base composition; and about 46 wt % to about 49 wt % of an ammonium phosphate composition, based on dry weight.

Clause 12. The method according to any one of Clauses 9-11, wherein the polysaccharide composition comprises one or more non-sulfated polysaccharides and one or more sulfated polysaccharides.

Clause 13. The method according to any one of Clauses 9-12, wherein the polysaccharide composition comprises chitosan, guar gum, one or more carrageenans, salts thereof, complexes thereof, or any combination thereof.

Clause 14. The method according to Clause 13, wherein the polysaccharide composition comprises the one or more carrageenans which includes lambda carrageenan, kappa carrageenan, or any combination thereof.

Clause 15. The method according to any one of Clauses 9-14, wherein the polysaccharide composition comprises: about 20 wt % to about 60 wt % of chitosan; about 20 wt % to about 60 wt % of guar gum; about 3 wt % to about 20 wt % of lambda carrageenan; and about 3 wt % to about 20 wt % of kappa carrageenan, based on dry weight.

Clause 16. The method according to any one of Clauses 9-15, wherein the polysaccharide composition comprises: about 35 wt % to about 45 wt % of chitosan; about 35 wt % to about 45 wt % of guar gum; about 5 wt % to about 15 wt % of lambda carrageenan; and about 5 wt % to about 15 wt % of kappa carrageenan, based on dry weight.

Clause 17. The method according to any one of Clauses 9-16, wherein the organic base composition comprises melamine, urea, salts thereof, complexes thereof, or any combination thereof.

Clause 18. The method according to any one of Clauses 9-17, wherein the organic base composition comprises: about 40 wt % to about 85 wt % of melamine; and about 15 wt % to about 60 wt % of urea, based on dry weight.

Clause 19. The method according to any one of Clauses 1-18, wherein the organic base composition comprises: about 55 wt % to about 80 wt % of melamine; and about 20 wt % to about 45 wt % of urea, based on dry weight.

Clause 20. The method according to any one of Clauses 9-19, wherein the ammonium phosphate composition comprises monobasic ammonium phosphate, dibasic ammonium phosphate, salts thereof, complexes thereof, or any combination thereof.

Clause 21. The method according to any one of Clauses 9-20, wherein the ammonium phosphate composition comprises: about 20 wt % to about 80 wt % of monobasic ammonium phosphate; and about 20 wt % to about 80 wt % of dibasic ammonium phosphate, based on dry weight.

Clause 22. The method according to Clause 21, wherein the ammonium phosphate composition comprises: about 40 wt % to about 60 wt % of monobasic ammonium phosphate; and about 40 wt % to about 60 wt % of dibasic ammonium phosphate, based on dry weight.

Clause 23. The method according to any one of Clauses 1-22, wherein the polysaccharide-base composition further comprises an oxide material.

Clause 24. The method according to Clause 23, wherein the polysaccharide-base composition comprises about 0.1 wt % to about 2 wt % of the oxide material, based on dry weight.

Clause 25. The method according to Clause 24, wherein the polysaccharide-base composition comprises about 0.5 wt % to about 1.2 wt % of the oxide material, based on dry weight.

Clause 26. The method according to any one of Clauses 23-25, wherein the oxide material comprises silica, quartz, silicon oxide, alumina, titania, hafnia, or any combination thereof.

Clause 27. The method according to any one of Clauses 1-26, wherein the bio-stimulant composition comprises about 6 wt % to about 20 wt % of an oil composition.

Clause 28. The method according to Clause 27, wherein the bio-stimulant composition comprises about 8 wt % to about 15 wt % of the oil composition.

Clause 29. The method according to Clause 27, wherein the oil composition comprises a seed oil, a vegetable oil, an essential fatty acid, an animal fat, or any combination thereof.

Clause 30. The method according to Clause 27, wherein the oil composition comprises canola oil, soy oil, or any combination thereof.

Clause 31. The method according to any one of Clauses 1-26, wherein the bio-stimulant composition comprises: about 3 wt % to about 12 wt % of canola oil; and about 2 wt % to about 8 wt % of soy oil.

Clause 32. The method according to any one of Clauses 1-26, wherein the bio-stimulant composition comprises about 35 wt % to about 60 wt % of an organic acid composition.

Clause 33. The method according to Clause 32, wherein the bio-stimulant composition comprises about 42 wt % to about 52 wt % of the organic acid composition.

Clause 34. The method according to Clause 32, wherein the organic acid composition comprises fulvic acid, gluconic acid, oleic acid, esters thereof, salts thereof, or any combination thereof.

Clause 35. The method according to Clause 32, wherein the bio-stimulant composition comprises: about 0.4 wt % to about 2 wt % of fulvic acid; about 10 wt % to about 25 wt % of gluconic acid; and about 20 wt % to about 40 wt % of oleic acid.

Clause 36. The method according to Clause 32, wherein the bio-stimulant composition comprises: about 0.6 wt % to about 1 wt % of fulvic acid; about 15 wt % to about 20 wt % of gluconic acid; and about 25 wt % to about 32 wt % of oleic acid.

Clause 37. The method according to any one of Clauses 1-26, wherein the bio-stimulant composition comprises a salt.

Clause 38. The method according to Clause 37, wherein the bio-stimulant composition comprises about 0.5 wt % to about 5 wt % of the salt.

Clause 39. The method according to Clause 37, wherein the bio-stimulant composition comprises about 1 wt % to about 3 wt % of the salt.

Clause 40. The method according to Clause 37, wherein the salt comprises sodium chloride, potassium chloride, magnesium chloride, potassium iodine, or any combination thereof.

Clause 41. The method according to Clause 37, wherein the salt comprises: about 40 wt % to about 60 wt % of magnesium chloride; about 32 wt % to about 42 wt % of potassium chloride; and about 4 wt % to about 15 wt % of sodium chloride, based on dry weight.

Clause 42. The method according to Clause 37, wherein the salt comprises: about 50 wt % to about 55 wt % of magnesium chloride; about 35 wt % to about 39 wt % of potassium chloride; and about 6 wt % to about 10 wt % of sodium chloride, based on dry weight.

Clause 43. The method according to any one of Clauses 1-26, wherein the bio-stimulant composition comprises an alfalfa composition.

Clause 44. The method according to Clause 43, wherein the bio-stimulant composition comprises about 0.05 wt % to about 0.50 wt % of the alfalfa composition.

Clause 45. The method according to Clause 43, wherein the alfalfa composition comprises ground leaves of Medicago sativa.

Clause 46. The method according to any one of Clauses 1-45, wherein the bio-stimulant composition comprises molasses.

Clause 47. The method according to Clause 46, wherein the bio-stimulant composition comprises about 3 wt % to about 12 wt % of the molasses.

Clause 48. The method according to any one of Clauses 1-47, wherein the bio-stimulant composition comprises an alcohol composition.

Clause 49. The method according to Clause 48, wherein the bio-stimulant composition comprises about 10 wt % to about 25 wt % of the alcohol composition.

Clause 50. The method according to Clause 48, wherein the alcohol composition comprises ethanol, sugar cane alcohol, or combinations thereof.

Clause 51. The method according to any one of Clauses 1-50, wherein the bio-stimulant composition comprises a surfactant composition.

Clause 52. The method according to Clause 51, wherein the bio-stimulant composition comprises about 10 wt % to about 25 wt % of the surfactant composition.

Clause 53. The method according to Clause 51, wherein the surfactant composition comprises linoleic acid, oleic acid, sunflower seed oil, or combinations thereof.

Clause 54. The method according to any one of Clauses 1-53, wherein the bio-stimulant composition comprises: about 0.5 wt % to about 5 wt % of a salt; about 35 wt % to about 60 wt % of an organic acid composition; about 6 wt % to about 20 wt % of an oil composition; about 0.05 wt % to about 0.50 wt % of an alfalfa composition; about 3 wt % to about 12 wt % of molasses; about 10 wt % to about 25 wt % of an alcohol composition; and about 10 wt % to about 25 wt % of a surfactant composition.

Clause 55. The method according to any one of Clauses 1-54, wherein the bio-stimulant composition comprises: about 1 wt % to about 3 wt % of a salt; about 42 wt % to about 52 wt % of an organic acid composition; about 8 wt % to about 15 wt % of an oil composition; about 0.08 wt % to about 0.25 wt % of an alfalfa composition; about 4 wt % to about 8 wt % of a molasses; about 12 wt % to about 20 wt % of an alcohol composition; and about 14 wt % to about 20 wt % of a surfactant composition.

Clause 56. The method according to any one of Clauses 1-55, further comprising water combined with the product composition or the reaction product.

Clause 57. The method according to Clause 56, wherein the fire retardant composition comprises: about 15 wt % to about 30 wt % of the product composition or the reaction product; and about 70 wt % to about 85 wt % of the water.

Clause 58. A method for preparing the fire retardant composition, comprising: combining a polysaccharide composition with water to prepare a first mixture; combining at least an organic base composition and an ammonium phosphate composition with the first mixture to prepare a polysaccharide-base composition; and combining a bio-stimulant composition and the polysaccharide-base composition to prepare a product composition or a reaction product.

Clause 59. The method according to Clause 58, wherein the polysaccharide composition with the water are combined to prepare the first mixture at a first temperature in a range from about 70° C. to about 100° C.

Clause 60. The method according to Clause 58 or 59, wherein the organic base composition, the ammonium phosphate composition, and the first mixture are combined to prepare the polysaccharide-base composition at a second temperature in a range from about 70° C. to about 100° C.

Clause 61. The method according to Clause 60, wherein the bio-stimulant composition and the polysaccharide-base composition are combined to prepare the product composition or the reaction product at a third temperature in a range from about 40° C. to about 80° C.

Clause 62. The method according to Clause 61, wherein: the first temperature is in a range from about 80° C. to about 90° C.; the second temperature is in a range from about 80° C. to about 90° C.; and the third temperature is in a range from about 50° C. to about 70° C.

Clause 63. The method according to any one of Clauses 58-62, wherein the polysaccharide composition comprises one or more non-sulfated polysaccharides or one or more sulfated polysaccharides.

Clause 64. The method according to any one of Clauses 58-62, wherein the polysaccharide composition comprises one or more non-sulfated polysaccharides and one or more sulfated polysaccharides.

Clause 65. The method according to any one of Clauses 58-64, further comprising preparing the polysaccharide composition by combining the water together with one or more non-sulfated polysaccharides, one or more sulfated polysaccharides, or both one or more non-sulfated polysaccharides and one or more sulfated polysaccharides.

Clause 66. The method according to Clause 65, wherein the polysaccharide composition comprises chitosan, guar gum, one or more carrageenans, salts thereof, complexes thereof, or any combination thereof.

Clause 67. The method according to Clause 66, wherein the polysaccharide composition comprises the one or more carrageenans which includes lambda carrageenan, kappa carrageenan, or any combination thereof.

Clause 68. The method according to any one of Clauses 58-67, wherein the polysaccharide composition comprises: about 20 wt % to about 60 wt % of chitosan; about 20 wt % to about 60 wt % of guar gum; about 3 wt % to about 20 wt % of lambda carrageenan; and about 3 wt % to about 20 wt % of kappa carrageenan, based on dry weight.

Clause 69. The method according to Clause 68, wherein the polysaccharide composition comprises: about 35 wt % to about 45 wt % of chitosan; about 35 wt % to about 45 wt % of guar gum; about 5 wt % to about 15 wt % of lambda carrageenan; and about 5 wt % to about 15 wt % of kappa carrageenan, based on dry weight.

Clause 70. The method according to any one of Clauses 58-69, further comprising combining the first mixture and at least melamine, urea, salts thereof, complexes thereof, or any combination thereof.

Clause 71. The method according to any one of Clauses 58-70, wherein the organic base composition comprises melamine, urea, salts thereof, complexes thereof, or any combination thereof.

Clause 72. The method according to any one of Clauses 58-71, wherein the organic base composition comprises: about 40 wt % to about 85 wt % of melamine; and about 15 wt % to about 60 wt % of urea, based on dry weight.

Clause 73. The method according to Clause 72, wherein the organic base composition comprises: about 55 wt % to about 80 wt % of melamine; and about 20 wt % to about 45 wt % of urea, based on dry weight.

Clause 74. The method according to any one of Clauses 58-73, further comprising combining the first mixture and at least the ammonium phosphate composition.

Clause 75. The method according to any one of Clauses 58-73, further comprising combining the first mixture and at least the ammonium phosphate composition and the organic base composition.

Clause 76. The method according to any one of Clauses 58-75, wherein the ammonium phosphate composition comprises monobasic ammonium phosphate, dibasic ammonium phosphate, salts thereof, complexes thereof, or any combination thereof.

Clause 77. The method according to any one of Clauses 58-76, wherein the ammonium phosphate composition comprises: about 20 wt % to about 80 wt % of monobasic ammonium phosphate; and about 20 wt % to about 80 wt % of dibasic ammonium phosphate, based on dry weight.

Clause 78. The method according to Clause 77, wherein the ammonium phosphate composition comprises: about 40 wt % to about 60 wt % of monobasic ammonium phosphate; and about 40 wt % to about 60 wt % of dibasic ammonium phosphate, based on dry weight.

Clause 79. The method according to any one of Clauses 58-78, wherein the polysaccharide-base composition further comprises an oxide material.

Clause 80. The method according to Clause 79, wherein the polysaccharide-base composition comprises about 0.1 wt % to about 2 wt % of the oxide material, based on dry weight.

Clause 81. The method according to Clause 80, wherein the polysaccharide-base composition comprises about 0.5 wt % to about 1.2 wt % of the oxide material, based on dry weight.

Clause 82. The method according to any one of Clauses 79-81, wherein the oxide material comprises silica, quartz, silicon oxide, alumina, titania, hafnia, or any combination thereof.

Clause 83. The method according to any one of Clauses 58-82, wherein the bio-stimulant composition comprises about 6 wt % to about 20 wt % of an oil composition.

Clause 84. The method according to Clause 83, wherein the bio-stimulant composition comprises about 8 wt % to about 15 wt % of the oil composition.

Clause 85. The method according to Clause 83, wherein the oil composition comprises a seed oil, a vegetable oil, an essential fatty acid, an animal fat, or any combination thereof.

Clause 86. The method according to Clause 83, wherein the oil composition comprises canola oil, soy oil, or any combination thereof.

Clause 87. The method according to any one of Clauses 58-86, wherein the bio-stimulant composition comprises: about 3 wt % to about 12 wt % of canola oil; and about 2 wt % to about 8 wt % of soy oil.

Clause 88. The method according to any one of Clauses 58-87, wherein the bio-stimulant composition comprises about 35 wt % to about 60 wt % of an organic acid composition.

Clause 89. The method according to Clause 88, wherein the bio-stimulant composition comprises about 42 wt % to about 52 wt % of the organic acid composition.

Clause 90. The method according to any one of Clauses 88-89, wherein the organic acid composition comprises fulvic acid, gluconic acid, oleic acid, esters thereof, salts thereof, or any combination thereof.

Clause 91. The method according to any one of Clauses 88-91, wherein the bio-stimulant composition comprises: about 0.4 wt % to about 2 wt % of fulvic acid; about 10 wt % to about 25 wt % of gluconic acid; and about 20 wt % to about 40 wt % of oleic acid.

Clause 92. The method according to any one of Clauses 88-91, wherein the bio-stimulant composition comprises: about 0.6 wt % to about 1 wt % of fulvic acid; about 15 wt % to about 20 wt % of gluconic acid; and about 25 wt % to about 32 wt % of oleic acid.

Clause 93. The method according to any one of Clauses 58-92, wherein the bio-stimulant composition comprises a salt.

Clause 94. The method according to Clause 93, wherein the bio-stimulant composition comprises about 0.5 wt % to about 5 wt % of the salt.

Clause 95. The method according to Clause 94, wherein the bio-stimulant composition comprises about 1 wt % to about 3 wt % of the salt.

Clause 96. The method according to any one of Clauses 93-95, wherein the salt comprises sodium chloride, potassium chloride, magnesium chloride, potassium iodine, or any combination thereof.

Clause 97. The method according to any one of Clauses 93-96, wherein the salt comprises: about 40 wt % to about 60 wt % of magnesium chloride; about 32 wt % to about 42 wt % of potassium chloride; and about 4 wt % to about 15 wt % of sodium chloride, based on dry weight.

Clause 98. The method according to any one of Clauses 93-97, wherein the salt comprises: about 50 wt % to about 55 wt % of magnesium chloride; about 35 wt % to about 39 wt % of potassium chloride; and about 6 wt % to about 10 wt % of sodium chloride, based on dry weight.

Clause 99. The method according to any one of Clauses 58-98, wherein the bio-stimulant composition comprises an alfalfa composition.

Clause 100. The method according to Clause 99, wherein the bio-stimulant composition comprises about 0.05 wt % to about 0.50 wt % of the alfalfa composition.

Clause 101. The method according to Clause 99 or 100, wherein the alfalfa composition comprises ground leaves of Medicago sativa.

Clause 102. The method according to any one of Clauses 58-101, wherein the bio-stimulant composition comprises molasses.

Clause 103. The method according to Clause 102, wherein the bio-stimulant composition comprises about 3 wt % to about 12 wt % of the molasses.

Clause 104. The method according to any one of Clauses 58-103, wherein the bio-stimulant composition comprises an alcohol composition.

Clause 105. The method according to Clause 104, wherein the bio-stimulant composition comprises about 10 wt % to about 25 wt % of the alcohol composition.

Clause 106. The method according to Clause 104, wherein the alcohol composition comprises ethanol, sugar cane alcohol, or combinations thereof.

Clause 107. The method according to any one of Clauses 58-106, wherein the bio-stimulant composition comprises a surfactant composition.

Clause 108. The method according to Clause 107, wherein the bio-stimulant composition comprises about 10 wt % to about 25 wt % of the surfactant composition.

Clause 109. The method according to Clause 107, wherein the surfactant composition comprises linoleic acid, oleic acid, sunflower seed oil, or combinations thereof.

Clause 110. The method according to any one of Clauses 58-109, wherein the bio-stimulant composition comprises: about 0.5 wt % to about 5 wt % of a salt; about 35 wt % to about 60 wt % of an organic acid composition; about 6 wt % to about 20 wt % of an oil composition; about 0.05 wt % to about 0.50 wt % of an alfalfa composition; about 3 wt % to about 12 wt % of molasses; about 10 wt % to about 25 wt % of an alcohol composition; and about 10 wt % to about 25 wt % of a surfactant composition.

Clause 111. The method according to any one of Clauses 58-110, wherein the bio-stimulant composition comprises: about 1 wt % to about 3 wt % of a salt; about 42 wt % to about 52 wt % of an organic acid composition; about 8 wt % to about 15 wt % of an oil composition; about 0.08 wt % to about 0.25 wt % of an alfalfa composition; about 4 wt % to about 8 wt % of a molasses; about 12 wt % to about 20 wt % of an alcohol composition; and about 14 wt % to about 20 wt % of a surfactant composition.

Clause 112. The method according to any one of Clauses 58-111, further comprising combining water and the product composition and/or combining water and the reaction product.

Clause 113. The method according to Clause 112, wherein the fire retardant composition comprises: about 15 wt % to about 30 wt % of the product composition or the reaction product; and about 70 wt % to about 85 wt % of the water.

Clause 114. A method for preparing a fire retardant composition and/or a fire retardant product according to any one, two, or more of Clauses 1-113 combined and as further described and discussed herein.

Clause 115. A fire retardant composition and/or a fire retardant product according to any one, two, or more of Clauses 1-114 combined and as further described and discussed herein.

### Clause Group 3 Containing the Following Clauses 1-72:

Clause 1. A fire retardant composition, comprising: a product composition prepared from a mixture comprising: about 80 weight percent (wt %) to about 98 wt % of a polysaccharide-base composition, based on dry weight; and about 2 wt % to about 20 wt % of a bio-stimulant composition, based on dry weight.

Clause 2. The fire retardant composition according to Clause 1, wherein the mixture comprises: about 85 wt % to about 95 wt % of the polysaccharide-base composition; and about 5 wt % to about 15 wt % of the bio-stimulant composition, based on dry weight.

Clause 3. The fire retardant composition according to Clause 1 or 2, wherein the mixture comprises: about 88 wt % to about 92 wt % of the polysaccharide-base composition; and about 8 wt % to about 12 wt % of the bio-stimulant composition, based on dry weight.

Clause 4. A fire retardant composition, comprising: a reaction product of a weight ratio of a polysaccharide-base composition and a bio-stimulant composition, the weight ratio in a range from about 5:1 to about 15:1, based on dry weight.

Clause 5. The fire retardant composition according to Clause 4, wherein the weight ratio is from about 6:1 to about 12:1, based on dry weight.

Clause 6. The fire retardant composition according to Clause 4 or 5, wherein the weight ratio is from about 8:1 to about 10:1, based on dry weight.

Clause 7. The fire retardant composition according to any one of Clauses 1-6, wherein the polysaccharide-base composition comprises: about 0.5 wt % to about 10 wt % of a polysaccharide composition; about 10 wt % to about 35 wt % of an organic base composition; and about 60 wt % to about 88 wt % of an ammonium phosphate composition, based on dry weight.

Clause 8. The fire retardant composition according to Clause 7, wherein the polysaccharide-base composition comprises: about 0.8 wt % to about 5 wt % of the polysaccharide composition; about 12 wt % to about 30 wt % of the organic base composition; and about 65 wt % to about 85 wt % of the ammonium phosphate composition, based on dry weight.

Clause 9. The fire retardant composition according to Clause 8, wherein the polysaccharide-base composition comprises: about 1 wt % to about 3 wt % of the polysaccharide composition; about 16 wt % to about 25 wt % of the organic base composition; and about 70 wt % to about 80 wt % of the ammonium phosphate composition, based on dry weight.

Clause 10. The fire retardant composition according to any one of Clauses 7-9, wherein the polysaccharide composition comprises one or more non-sulfated polysaccharides and one or more sulfated polysaccharides.

Clause 11. The fire retardant composition according to Clause 8, wherein the polysaccharide composition comprises guar gum, one or more carrageenans, salts thereof, complexes thereof, or any combination thereof.

Clause 12. The fire retardant composition according to Clause 11, wherein the polysaccharide composition comprises the one or more carrageenans which includes lambda carrageenan, kappa carrageenan, or any combination thereof.

Clause 13. The fire retardant composition according to any one of Clauses 7-12, wherein the polysaccharide composition comprises: about 8 wt % to about 40 wt % of guar gum; about 30 wt % to about 55 wt % of lambda carrageenan; and about 30 wt % to about 55 wt % of kappa carrageenan, based on dry weight.

Clause 14. The fire retardant composition according to any one of Clauses 7-13, wherein the polysaccharide composition comprises: about 14 wt % to about 22 wt % of guar gum; about 35 wt % to about 48 wt % of lambda carrageenan; and about 35 wt % to about 48 wt % of kappa carrageenan, based on dry weight.

Clause 15. The fire retardant composition according to any one of Clauses 7-14, wherein the polysaccharide composition comprises: about 16 wt % to about 19 wt % of guar gum; about 40 wt % to about 44 wt % of lambda carrageenan; and about 40 wt % to about 44 wt % of kappa carrageenan, based on dry weight.

Clause 16. The fire retardant composition according to any one of Clauses 7-15, wherein the organic base composition comprises urea, salts thereof, complexes thereof, or any combination thereof.

Clause 17. The fire retardant composition according to any one of Clauses 7-16, wherein the organic base composition comprises about 90 wt % or greater of urea, such as about 95 wt %, about 96 wt %, about 97 wt %, about 98 wt %, about 99 wt %, or about 100 wt % of urea, based on dry weight.

Clause 18. The fire retardant composition according to any one of Clauses 7-17, wherein the ammonium phosphate composition comprises monobasic ammonium phosphate, dibasic ammonium phosphate, salts thereof, complexes thereof, or any combination thereof.

Clause 19. The fire retardant composition according to any one of Clauses 7-18, wherein the ammonium phosphate composition comprises: about 20 wt % to about 80 wt % of monobasic ammonium phosphate; and about 20 wt % to about 80 wt % of dibasic ammonium phosphate, based on dry weight.

Clause 20. The fire retardant composition according to Clause 19, wherein the ammonium phosphate composition comprises: about 40 wt % to about 60 wt % of monobasic ammonium phosphate; and about 40 wt % to about 60 wt % of dibasic ammonium phosphate, based on dry weight.

Clause 21. The fire retardant composition according to any one of Clauses 1-20, wherein the polysaccharide-base composition further comprises an oxide material.

Clause 22. The fire retardant composition according to Clause 21, wherein the polysaccharide-base composition comprises about 0.1 wt % to about 2.5 wt % of the oxide material, based on dry weight.

Clause 23. The fire retardant composition according to Clause 22, wherein the polysaccharide-base composition comprises about 0.8 wt % to about 1.5 wt % of the oxide material, based on dry weight.

Clause 24. The fire retardant composition according to any one of Clauses 21-23, wherein the oxide material comprises silica, quartz, silicon oxide, alumina, titania, hafnia, or any combination thereof.

Clause 25. The fire retardant composition according to any one of Clauses 1-24, wherein the bio-stimulant composition comprises about 6 wt % to about 20 wt % of an oil composition.

Clause 26. The fire retardant composition according to Clause 25, wherein the bio-stimulant composition comprises about 8 wt % to about 15 wt % of the oil composition.

Clause 27. The fire retardant composition according to Clause 25, wherein the oil composition comprises a seed oil, a vegetable oil, an essential fatty acid, an animal fat, or any combination thereof.

Clause 28. The fire retardant composition according to Clause 25, wherein the oil composition comprises canola oil, soy oil, or any combination thereof.

Clause 29. The fire retardant composition according to any one of Clauses 1-24, wherein the bio-stimulant composition comprises: about 3 wt % to about 12 wt % of canola oil; and about 2 wt % to about 8 wt % of soy oil.

Clause 30. The fire retardant composition according to any one of Clauses 1-29, wherein the bio-stimulant composition comprises about 35 wt % to about 60 wt % of an organic acid composition.

Clause 31. The fire retardant composition according to Clause 30, wherein the bio-stimulant composition comprises about 42 wt % to about 52 wt % of the organic acid composition.

Clause 32. The fire retardant composition according to Clause 30, wherein the organic acid composition comprises fulvic acid, gluconic acid, oleic acid, esters thereof, salts thereof, or any combination thereof.

Clause 33. The fire retardant composition according to Clause 30, wherein the bio-stimulant composition comprises: about 0.4 wt % to about 2 wt % of fulvic acid; about 10 wt % to about 25 wt % of gluconic acid; and about 20 wt % to about 40 wt % of oleic acid.

Clause 34. The fire retardant composition according to Clause 30, wherein the bio-stimulant composition comprises: about 0.6 wt % to about 1 wt % of fulvic acid; about 15 wt % to about 20 wt % of gluconic acid; and about 25 wt % to about 32 wt % of oleic acid.

Clause 35. The fire retardant composition according to any one of Clauses 1-34, wherein the bio-stimulant composition further comprises a salt.

Clause 36. The fire retardant composition according to Clause 35, wherein the bio-stimulant composition comprises about 0.5 wt % to about 5 wt % of the salt.

Clause 37. The fire retardant composition according to Clause 35, wherein the bio-stimulant composition comprises about 1 wt % to about 3 wt % of the salt.

Clause 38. The fire retardant composition according to Clause 35, wherein the salt comprises sodium chloride, potassium chloride, magnesium chloride, potassium iodine, or any combination thereof.

Clause 39. The fire retardant composition according to Clause 35, wherein the salt comprises: about 40 wt % to about 60 wt % of magnesium chloride; about 32 wt % to about 42 wt % of potassium chloride; and about 4 wt % to about 15 wt % of sodium chloride, based on dry weight.

Clause 40. The fire retardant composition according to Clause 35, wherein the salt comprises: about 50 wt % to about 55 wt % of magnesium chloride; about 35 wt % to about 39 wt % of potassium chloride; and about 6 wt % to about 10 wt % of sodium chloride, based on dry weight.

Clause 41. The fire retardant composition according to any one of Clauses 1-40, wherein the bio-stimulant composition comprises an alfalfa composition.

Clause 42. The fire retardant composition according to Clause 41, wherein the bio-stimulant composition comprises about 0.05 wt % to about 0.50 wt % of the alfalfa composition.

Clause 43. The fire retardant composition according to Clause 41, wherein the alfalfa composition comprises ground leaves of Medicago sativa.

Clause 44. The fire retardant composition according to any one of Clauses 1-24, wherein the bio-stimulant composition comprises molasses.

Clause 45. The fire retardant composition according to Clause 44, wherein the bio-stimulant composition comprises about 3 wt % to about 12 wt % of the molasses.

Clause 46. The fire retardant composition according to any one of Clauses 1-45, wherein the bio-stimulant composition comprises an alcohol composition.

Clause 47. The fire retardant composition according to Clause 46, wherein the bio-stimulant composition comprises about 10 wt % to about 25 wt % of the alcohol composition.

Clause 48. The fire retardant composition according to Clause 46, wherein the alcohol composition comprises ethanol, sugar cane alcohol, or combinations thereof.

Clause 49. The fire retardant composition according to any one of Clauses 1-48, wherein the bio-stimulant composition comprises a surfactant composition.

Clause 50. The fire retardant composition according to Clause 49, wherein the bio-stimulant composition comprises about 10 wt % to about 25 wt % of the surfactant composition.

Clause 51. The fire retardant composition according to Clause 49, wherein the surfactant composition comprises linoleic acid, oleic acid, sunflower seed oil, or combinations thereof.

Clause 52. The fire retardant composition according to any one of Clauses 1-51, wherein the bio-stimulant composition comprises: about 0.5 wt % to about 5 wt % of a salt; about 35 wt % to about 60 wt % of an organic acid composition; about 6 wt % to about 20 wt % of an oil composition; about 0.05 wt % to about 0.50 wt % of an alfalfa composition; about 3 wt % to about 12 wt % of molasses; about 10 wt % to about 25 wt % of an alcohol composition; and about 10 wt % to about 25 wt % of a surfactant composition.

Clause 53. The fire retardant composition according to any one of Clauses 1-24, wherein the bio-stimulant composition comprises: about 1 wt % to about 3 wt % of a salt; about 42 wt % to about 52 wt % of an organic acid composition; about 8 wt % to about 15 wt % of an oil composition; about 0.08 wt % to about 0.25 wt % of an alfalfa composition; about 4 wt % to about 8 wt % of a molasses; about 12 wt % to about 20 wt % of an alcohol composition; and about 14 wt % to about 20 wt % of a surfactant composition.

Clause 54. The fire retardant composition according to any one of Clauses 1-53, further comprising water combined with the product composition or the reaction product.

Clause 55. The fire retardant composition according to Clause 54, wherein the fire retardant composition comprises: about 15 wt % to about 30 wt % of the product composition or the reaction product; and about 70 wt % to about 85 wt % of the water.

Clause 56. A method for preparing the fire retardant composition according to any one of Clauses 1-55, comprising: combining the polysaccharide-base composition and the bio-stimulant composition to prepare the product composition or the reaction product.

Clause 57. A fire retardant product, comprising: a base product; and the fire retardant composition according to any one of Clauses 1-56.

Clause 58. The fire retardant product according to Clause 57, wherein the base product comprises a wood product, a paper product, a textile product, a plant fiber product, a hemp and/or cannabis fiber product, a cellulose product, a resin product, an adhesive product, a plastic product, a polymeric product, or any combination thereof.

Clause 59. The fire retardant product according to Clause 57, wherein the base product comprises wood, lumber, a board, a particle board, a dry wall, a cement board, or any combination thereof.

Clause 60. The fire retardant product according to Clause 57, wherein the base product comprises hemp and/or cannabis, hemp and/or cannabis fibers, hemp and/or cannabis flakes, hemp and/or cannabis particles, hemp and/or cannabis dust, hemp and/or cannabis strands, hemp and/or cannabis rope, hemp and/or cannabis fabric, hemp and/or cannabis cloth, hemp and/or cannabis flour, hemp and/or cannabis seeds, or any combination thereof.

Clause 61. The fire retardant product according to any one of Clauses 57-60, wherein the fire retardant product is a hemp and/or cannabis-containing board, a hemp and/or cannabis-containing fire board, or a hemp and/or cannabis-containing insulation fire board.

Clause 62. The fire retardant product according to any one of Clauses 57-61, wherein the fire retardant product is a hemp and/or cannabis-containing insulation material or product, a flame-retardant home insulation, a flame-retardant building or structure insulation, a flame-retardant automotive insulation, or a flame-retardant wire insulation.

Clause 63. The fire retardant product according to any one of Clauses 57-62, wherein the fire retardant product contains less than 15 wt % of the fire retardant composition.

Clause 64. The fire retardant product according to Clause 63, wherein the fire retardant product contains about 0.5 wt % to about 10 wt % of the fire retardant composition.

Clause 65. The fire retardant product according to any one of Clauses 57-64, further comprising a softening agent or a softener.

Clause 66. The fire retardant product according to Clause 65, wherein the softening agent or the softener comprises glycerin.

Clause 67. The fire retardant product according to any one of Clauses 57-66, further comprising a biocide.

Clause 68. The fire retardant product according to Clause 67, wherein the biocide comprises a borate, copper azole, linseed oil, boric acid, benzalkonium chloride, a mixture of boric acid and benzalkonium chloride, creosote, pentachlorophenol, derivatives thereof, or any combination thereof.

Clause 69. The fire retardant product according to any one of Clauses 57-68, wherein the base product comprises an aqueous foam or an aqueous gel.

Clause 70. A fire retardant composition, comprising: a product composition prepared from a mixture comprising: about 88 weight percent (wt %) to about 98 wt % of a polysaccharide-base composition; and about 2 wt % to about 12 wt % of a bio-stimulant composition, based on dry weight; or a reaction product of a weight ratio of the polysaccharide-base composition and the bio-stimulant composition, the weight ratio in a range from about 8:1 to about 20:1, based on dry weight; wherein the polysaccharide-base composition comprises: about 4 wt % to about 12 wt % of a polysaccharide composition; about 35 wt % to about 52 wt % of an organic base composition; and about 35 wt % to about 52 wt % of an ammonium phosphate composition, based on dry weight; wherein the polysaccharide composition comprises guar gum, one or more carrageenans, salts thereof, complexes thereof, or any combination thereof; wherein the organic base composition comprises urea, salts thereof, complexes thereof, or any combination thereof; wherein the ammonium phosphate composition comprises monobasic ammonium phosphate, dibasic ammonium phosphate, salts thereof, complexes thereof, or any combination thereof; and wherein the bio-stimulant composition comprises about 8 wt % to about 15 wt % of the oil composition; about 42 wt % to about 52 wt % of the organic acid composition; and about 10 wt % to about 25 wt % of the surfactant composition.

Clause 71. A fire retardant composition and/or a fire retardant product according to any one, two, or more of Clauses 1-70 combined and as further described and discussed herein.

Clause 72. A method for preparing a fire retardant composition and/or a fire retardant product according to any one, two, or more of Clauses 1-71 combined and as further described and discussed herein.

### Clause Group 4 Containing the Following Clauses 1-115:

Clause 1. A method for preparing the fire retardant composition, comprising: combining a polysaccharide-base composition and a bio-stimulant composition to prepare a product composition or a reaction product.

Clause 2. The method according to Clause 1, further comprising combining a polysaccharide composition, an organic base composition, and an ammonium phosphate composition to prepare the polysaccharide-base composition.

Clause 3. The method according to Clause 1 or 2, wherein the product composition is prepared from a mixture comprising: about 80 weight percent (wt %) to about 98 wt % of the polysaccharide-base composition; and about 2 wt % to about 20 wt % of the bio-stimulant composition, based on dry weight.

Clause 4. The method according to any one of Clauses 1-3, wherein the mixture comprises: about 85 wt % to about 95 wt % of the polysaccharide-base composition; and about 5 wt % to about 15 wt % of the bio-stimulant composition, based on dry weight.

Clause 5. The method according to any one of Clauses 1-4, wherein the mixture comprises: about 88 wt % to about 92 wt % of the polysaccharide-base composition; and about 8 wt % to about 12 wt % of the bio-stimulant composition, based on dry weight.

Clause 6. The method according to Clause 1, wherein the reaction product is prepared from a weight ratio of the polysaccharide-base composition and the bio-stimulant composition, the weight ratio in a range from about 5:1 to about 15:1, based on dry weight.

Clause 7. The method according to Clause 6, wherein the weight ratio is from about 6:1 to about 12:1, based on dry weight.

Clause 8. The method according to Clause 7, wherein the weight ratio is from about 8:1 to about 10:1, based on dry weight.

Clause 9. The method according to any one of Clauses 1-8, wherein the polysaccharide-base composition comprises: about 0.5 wt % to about 10 wt % of a polysaccharide composition; about 10 wt % to about 35 wt % of an organic base composition; and about 60 wt % to about 88 wt % of an ammonium phosphate composition, based on dry weight.

Clause 10. The method according to Clause 9, wherein the polysaccharide-base composition comprises: about 0.8 wt % to about 5 wt % of a polysaccharide composition; about 12 wt % to about 30 wt % of an organic base composition; and about 65 wt % to about 85 wt % of an ammonium phosphate composition, based on dry weight.

Clause 11. The method according to Clause 10, wherein the polysaccharide-base composition comprises: about 1 wt % to about 3 wt % of a polysaccharide composition; about 16 wt % to about 25 wt % of an organic base composition; and about 70 wt % to about 80 wt % of an ammonium phosphate composition, based on dry weight.

Clause 12. The method according to Clause 9, wherein the polysaccharide composition comprises one or more non-sulfated polysaccharides and one or more sulfated polysaccharides.

Clause 13. The method according to Clause 9, wherein the polysaccharide composition comprises guar gum, one or more carrageenans, salts thereof, complexes thereof, or any combination thereof.

Clause 14. The method according to Clause 13, wherein the polysaccharide composition comprises the one or more carrageenans which includes lambda carrageenan, kappa carrageenan, or any combination thereof.

Clause 15. The method according to Clause 9, wherein the polysaccharide composition comprises: about 8 wt % to about 40 wt % of guar gum; about 30 wt % to about 55 wt % of lambda carrageenan; and about 30 wt % to about 55 wt % of kappa carrageenan, based on dry weight.

Clause 16. The method according to Clause 9, wherein the polysaccharide composition comprises: about 14 wt % to about 22 wt % of guar gum; about 35 wt % to about 48 wt % of lambda carrageenan; and about 35 wt % to about 48 wt % of kappa carrageenan, based on dry weight.

Clause 17. The method according to Clause 9, wherein the polysaccharide composition comprises: about 16 wt % to about 19 wt % of guar gum; about 40 wt % to about 44 wt % of lambda carrageenan; and about 40 wt % to about 44 wt % of kappa carrageenan, based on dry weight.

Clause 18. The method according to Clause 9, wherein the organic base composition comprises urea, salts thereof, complexes thereof, or any combination thereof.

Clause 19. The method according to Clause 18, wherein the organic base composition comprises about 90 wt % or greater of urea, such as about 95 wt %, about 96 wt %, about 97 wt %, about 98 wt %, about 99 wt %, or about 100 wt % of urea, based on dry weight.

Clause 20. The method according to Clause 9, wherein the ammonium phosphate composition comprises monobasic ammonium phosphate, dibasic ammonium phosphate, salts thereof, complexes thereof, or any combination thereof.

Clause 21. The method according to Clause 9, wherein the ammonium phosphate composition comprises: about 20 wt % to about 80 wt % of monobasic ammonium phosphate; and about 20 wt % to about 80 wt % of dibasic ammonium phosphate, based on dry weight.

Clause 22. The method according to Clause 21, wherein the ammonium phosphate composition comprises: about 40 wt % to about 60 wt % of monobasic ammonium phosphate; and about 40 wt % to about 60 wt % of dibasic ammonium phosphate, based on dry weight.

Clause 23. The method according to any one of Clauses 1-22, wherein the polysaccharide-base composition further comprises an oxide material.

Clause 24. The method according to Clause 23, wherein the polysaccharide-base composition comprises about 0.1 wt % to about 2.5 wt % of the oxide material, based on dry weight.

Clause 25. The method according to Clause 24, wherein the polysaccharide-base composition comprises about 0.8 wt % to about 1.5 wt % of the oxide material, based on dry weight.

Clause 26. The method according to any one of Clauses 23-25, wherein the oxide material comprises silica, quartz, silicon oxide, alumina, titania, hafnia, or any combination thereof.

Clause 27. The method according to any one of Clauses 1-26, wherein the bio-stimulant composition comprises about 6 wt % to about 20 wt % of an oil composition.

Clause 28. The method according to Clause 27, wherein the bio-stimulant composition comprises about 8 wt % to about 15 wt % of the oil composition.

Clause 29. The method according to Clause 27, wherein the oil composition comprises a seed oil, a vegetable oil, an essential fatty acid, an animal fat, or any combination thereof.

Clause 30. The method according to Clause 27, wherein the oil composition comprises canola oil, soy oil, or any combination thereof.

Clause 31. The method according to any one of Clauses 1-30, wherein the bio-stimulant composition comprises: about 3 wt % to about 12 wt % of canola oil; and about 2 wt % to about 8 wt % of soy oil.

Clause 32. The method according to any one of Clauses 1-31, wherein the bio-stimulant composition comprises about 35 wt % to about 60 wt % of an organic acid composition.

Clause 33. The method according to Clause 32, wherein the bio-stimulant composition comprises about 42 wt % to about 52 wt % of the organic acid composition.

Clause 34. The method according to Clause 32, wherein the organic acid composition comprises fulvic acid, gluconic acid, oleic acid, esters thereof, salts thereof, or any combination thereof.

Clause 35. The method according to Clause 32, wherein the bio-stimulant composition comprises: about 0.4 wt % to about 2 wt % of fulvic acid; about 10 wt % to about 25 wt % of gluconic acid; and about 20 wt % to about 40 wt % of oleic acid.

Clause 36. The method according to Clause 32, wherein the bio-stimulant composition comprises: about 0.6 wt % to about 1 wt % of fulvic acid; about 15 wt % to about 20 wt % of gluconic acid; and about 25 wt % to about 32 wt % of oleic acid.

Clause 37. The method according to any one of Clauses 1-36, wherein the bio-stimulant composition comprises a salt.

Clause 38. The method according to Clause 37, wherein the bio-stimulant composition comprises about 0.5 wt % to about 5 wt % of the salt.

Clause 39. The method according to Clause 37, wherein the bio-stimulant composition comprises about 1 wt % to about 3 wt % of the salt.

Clause 40. The method according to Clause 37, wherein the salt comprises sodium chloride, potassium chloride, magnesium chloride, potassium iodine, or any combination thereof.

Clause 41. The method according to Clause 37, wherein the salt comprises: about 40 wt % to about 60 wt % of magnesium chloride; about 32 wt % to about 42 wt % of potassium chloride; and about 4 wt % to about 15 wt % of sodium chloride, based on dry weight.

Clause 42. The method according to Clause 37, wherein the salt comprises: about 50 wt % to about 55 wt % of magnesium chloride; about 35 wt % to about 39 wt % of potassium chloride; and about 6 wt % to about 10 wt % of sodium chloride, based on dry weight.

Clause 43. The method according to any one of Clauses 1-42, wherein the bio-stimulant composition comprises an alfalfa composition.

Clause 44. The method according to Clause 43, wherein the bio-stimulant composition comprises about 0.05 wt % to about 0.50 wt % of the alfalfa composition.

Clause 45. The method according to Clause 43, wherein the alfalfa composition comprises ground leaves of Medicago sativa.

Clause 46. The method according to any one of Clauses 1-45, wherein the bio-stimulant composition comprises molasses.

Clause 47. The method according to Clause 46, wherein the bio-stimulant composition comprises about 3 wt % to about 12 wt % of the molasses.

Clause 48. The method according to any one of Clauses 1-47, wherein the bio-stimulant composition comprises an alcohol composition.

Clause 49. The method according to Clause 48, wherein the bio-stimulant composition comprises about 10 wt % to about 25 wt % of the alcohol composition.

The method according to Clause 48, wherein the alcohol composition comprises ethanol, sugar cane alcohol, or combinations thereof.

Clause 51. The method according to any one of Clauses 1-50, wherein the bio-stimulant composition comprises a surfactant composition.

Clause 52. The method according to Clause 51, wherein the bio-stimulant composition comprises about 10 wt % to about 25 wt % of the surfactant composition.

Clause 53. The method according to Clause 51, wherein the surfactant composition comprises linoleic acid, oleic acid, sunflower seed oil, or combinations thereof.

Clause 54. The method according to any one of Clauses 1-53, wherein the bio-stimulant composition comprises: about 0.5 wt % to about 5 wt % of a salt; about 35 wt % to about 60 wt % of an organic acid composition; about 6 wt % to about 20 wt % of an oil composition; about 0.05 wt % to about 0.50 wt % of an alfalfa composition; about 3 wt % to about 12 wt % of molasses; about 10 wt % to about 25 wt % of an alcohol composition; and about 10 wt % to about 25 wt % of a surfactant composition.

Clause 55. The method according to any one of Clauses 1-54, wherein the bio-stimulant composition comprises: about 1 wt % to about 3 wt % of a salt; about 42 wt % to about 52 wt % of an organic acid composition; about 8 wt % to about 15 wt % of an oil composition; about 0.08 wt % to about 0.25 wt % of an alfalfa composition; about 4 wt % to about 8 wt % of a molasses; about 12 wt % to about 20 wt % of an alcohol composition; and about 14 wt % to about 20 wt % of a surfactant composition.

Clause 56. The method according to any one of Clauses 1-55, further comprising water combined with the product composition or the reaction product.

Clause 57. The method according to Clause 56, wherein the fire retardant composition comprises: about 15 wt % to about 30 wt % of the product composition or the reaction product; and about 70 wt % to about 85 wt % of the water.

Clause 58. A method for preparing the fire retardant composition, comprising: combining a polysaccharide composition with water to prepare a first mixture; combining at least an organic base composition and an ammonium phosphate composition with the first mixture to prepare a polysaccharide-base composition; and combining a bio-stimulant composition and the polysaccharide-base composition to prepare a product composition or a reaction product.

Clause 59. The method according to Clause 58, wherein the polysaccharide composition with the water are combined to prepare the first mixture at a first temperature in a range from about 70° C. to about 100° C.

Clause 60. The method according to Clause 58 or 59, wherein the organic base composition, the ammonium phosphate composition, and the first mixture are combined to prepare the polysaccharide-base composition at a second temperature in a range from about 70° C. to about 100° C.

Clause 61. The method according to Clause 60, wherein the bio-stimulant composition and the polysaccharide-base composition are combined to prepare the product composition or the reaction product at a third temperature in a range from about 40° C. to about 80° C.

Clause 62. The method according to Clause 61, wherein: the first temperature is in a range from about 80° C. to about 90° C.; the second temperature is in a range from about 80° C. to about 90° C.; and the third temperature is in a range from about 50° C. to about 70° C.

Clause 63. The method according to any one of Clauses 58-62, wherein the polysaccharide composition comprises one or more non-sulfated polysaccharides or one or more sulfated polysaccharides.

Clause 64. The method according to any one of Clauses 58-62, wherein the polysaccharide composition comprises one or more non-sulfated polysaccharides and one or more sulfated polysaccharides.

Clause 65. The method according to any one of Clauses 58-64, further comprising preparing the polysaccharide composition by combining the water together with one or more non-sulfated polysaccharides, one or more sulfated polysaccharides, or both one or more non-sulfated polysaccharides and one or more sulfated polysaccharides.

Clause 66. The method according to Clause 65, wherein the polysaccharide composition comprises guar gum, one or more carrageenans, salts thereof, complexes thereof, or any combination thereof.

Clause 67. The method according to Clause 66, wherein the polysaccharide composition comprises the one or more carrageenans which includes lambda carrageenan, kappa carrageenan, or any combination thereof.

Clause 68. The method according to any one of Clauses 58-67, wherein the polysaccharide composition comprises: about 8 wt % to about 40 wt % of guar gum; about 30 wt % to about 55 wt % of lambda carrageenan; and about 30 wt % to about 55 wt % of kappa carrageenan, based on dry weight.

Clause 69. The method according to Clause 68, wherein the polysaccharide composition comprises: about 14 wt % to about 22 wt % of guar gum; about 35 wt % to about 48 wt % of lambda carrageenan; and about 35 wt % to about 48 wt % of kappa carrageenan, based on dry weight.

Clause 70. The method according to Clause 69, wherein the polysaccharide composition comprises: about 16 wt % to about 19 wt % of guar gum; about 40 wt % to about 44 wt % of lambda carrageenan; and about 40 wt % to about 44 wt % of kappa carrageenan, based on dry weight.

Clause 71. The method according to any one of Clauses 58-70, further comprising combining the first mixture and at least urea, salts thereof, complexes thereof, or any combination thereof.

Clause 72. The method according to any one of Clauses 58-71, wherein the organic base composition comprises urea, salts thereof, complexes thereof, or any combination thereof.

Clause 73. The method according to any one of Clauses 58-71, wherein the organic base composition comprises about 90 wt % or greater of urea, such as about 95 wt %, about 96 wt %, about 97 wt %, about 98 wt %, about 99 wt %, or about 100 wt % of urea, based on dry weight.

Clause 74. The method according to any one of Clauses 58-73, further comprising combining the first mixture and at least the ammonium phosphate composition.

Clause 75. The method according to any one of Clauses 58-73, further comprising combining the first mixture and at least the ammonium phosphate composition and the organic base composition.

Clause 76. The method according to any one of Clauses 58-75, wherein the ammonium phosphate composition comprises monobasic ammonium phosphate, dibasic ammonium phosphate, salts thereof, complexes thereof, or any combination thereof.

Clause 77. The method according to any one of Clauses 58-76, wherein the ammonium phosphate composition comprises: about 20 wt % to about 80 wt % of monobasic ammonium phosphate; and about 20 wt % to about 80 wt % of dibasic ammonium phosphate, based on dry weight.

Clause 78. The method according to Clause 77, wherein the ammonium phosphate composition comprises: about 40 wt % to about 60 wt % of monobasic ammonium phosphate; and about 40 wt % to about 60 wt % of dibasic ammonium phosphate, based on dry weight.

Clause 79. The method according to any one of Clauses 58-78, wherein the polysaccharide-base composition further comprises an oxide material.

Clause 80. The method according to Clause 79, wherein the polysaccharide-base composition comprises about 0.1 wt % to about 2 wt % of the oxide material, based on dry weight.

Clause 81. The method according to Clause 80, wherein the polysaccharide-base composition comprises about 0.5 wt % to about 1.2 wt % of the oxide material, based on dry weight.

Clause 82. The method according to any one of Clauses 79-81, wherein the oxide material comprises silica, quartz, silicon oxide, alumina, titania, hafnia, or any combination thereof.

Clause 83. The method according to any one of Clauses 58-82, wherein the bio-stimulant composition comprises about 6 wt % to about 20 wt % of an oil composition.

Clause 84. The method according to Clause 83, wherein the bio-stimulant composition comprises about 8 wt % to about 15 wt % of the oil composition.

Clause 85. The method according to Clause 83, wherein the oil composition comprises a seed oil, a vegetable oil, an essential fatty acid, an animal fat, or any combination thereof.

Clause 86. The method according to Clause 83, wherein the oil composition comprises canola oil, soy oil, or any combination thereof.

Clause 87. The method according to any one of Clauses 58-86, wherein the bio-stimulant composition comprises: about 3 wt % to about 12 wt % of canola oil; and about 2 wt % to about 8 wt % of soy oil.

Clause 88. The method according to any one of Clauses 58-87, wherein the bio-stimulant composition comprises about 35 wt % to about 60 wt % of an organic acid composition.

Clause 89. The method according to Clause 88, wherein the bio-stimulant composition comprises about 42 wt % to about 52 wt % of the organic acid composition.

Clause 90. The method according to Clause 88, wherein the organic acid composition comprises fulvic acid, gluconic acid, oleic acid, esters thereof, salts thereof, or any combination thereof.

Clause 91. The method according to Clause 88, wherein the bio-stimulant composition comprises: about 0.4 wt % to about 2 wt % of fulvic acid; about 10 wt % to about 25 wt % of gluconic acid; and about 20 wt % to about 40 wt % of oleic acid.

Clause 92. The method according to Clause 88, wherein the bio-stimulant composition comprises: about 0.6 wt % to about 1 wt % of fulvic acid; about 15 wt % to about 20 wt % of gluconic acid; and about 25 wt % to about 32 wt % of oleic acid.

Clause 93. The method according to any one of Clauses 58-92, wherein the bio-stimulant composition comprises a salt.

Clause 94. The method according to Clause 93, wherein the bio-stimulant composition comprises about 0.5 wt % to about 5 wt % of the salt.

Clause 95. The method according to Clause 93, wherein the bio-stimulant composition comprises about 1 wt % to about 3 wt % of the salt.

Clause 96. The method according to Clause 93, wherein the salt comprises sodium chloride, potassium chloride, magnesium chloride, potassium iodine, or any combination thereof.

Clause 97. The method according to Clause 93, wherein the salt comprises: about 40 wt % to about 60 wt % of magnesium chloride; about 32 wt % to about 42 wt % of potassium chloride; and about 4 wt % to about 15 wt % of sodium chloride, based on dry weight.

Clause 98. The method according to Clause 93, wherein the salt comprises: about 50 wt % to about 55 wt % of magnesium chloride; about 35 wt % to about 39 wt % of potassium chloride; and about 6 wt % to about 10 wt % of sodium chloride, based on dry weight.

Clause 99. The method according to any one of Clauses 58-98, wherein the bio-stimulant composition comprises an alfalfa composition.

Clause 100. The method according to Clause 99, wherein the bio-stimulant composition comprises about 0.05 wt % to about 0.50 wt % of the alfalfa composition.

Clause 101. The method according to Clause 99, wherein the alfalfa composition comprises ground leaves of Medicago sativa.

Clause 102. The method according to any one of Clauses 58-101, wherein the bio-stimulant composition comprises molasses.

Clause 103. The method according to Clause 102, wherein the bio-stimulant composition comprises about 3 wt % to about 12 wt % of the molasses.

Clause 104. The method according to any one of Clauses 58-103, wherein the bio-stimulant composition comprises an alcohol composition.

Clause 105. The method according to Clause 104, wherein the bio-stimulant composition comprises about 10 wt % to about 25 wt % of the alcohol composition.

Clause 106. The method according to Clause 104, wherein the alcohol composition comprises ethanol, sugar cane alcohol, or combinations thereof.

Clause 107. The method according to any one of Clauses 58-106, wherein the bio-stimulant composition comprises a surfactant composition.

Clause 108. The method according to Clause 107, wherein the bio-stimulant composition comprises about 10 wt % to about 25 wt % of the surfactant composition.

Clause 109. The method according to Clause 107, wherein the surfactant composition comprises linoleic acid, oleic acid, sunflower seed oil, or combinations thereof.

Clause 110. The method according to any one of Clauses 58-109, wherein the bio-stimulant composition comprises: about 0.5 wt % to about 5 wt % of a salt; about 35 wt % to about 60 wt % of an organic acid composition; about 6 wt % to about 20 wt % of an oil composition; about 0.05 wt % to about 0.50 wt % of an alfalfa composition; about 3 wt % to about 12 wt % of molasses; about 10 wt % to about 25 wt % of an alcohol composition; and about 10 wt % to about 25 wt % of a surfactant composition.

Clause 111. The method according to any one of Clauses 58-110, wherein the bio-stimulant composition comprises: about 1 wt % to about 3 wt % of a salt; about 42 wt % to about 52 wt % of an organic acid composition; about 8 wt % to about 15 wt % of an oil composition; about 0.08 wt % to about 0.25 wt % of an alfalfa composition; about 4 wt % to about 8 wt % of a molasses; about 12 wt % to about 20 wt % of an alcohol composition; and about 14 wt % to about 20 wt % of a surfactant composition.

Clause 112. The method according to any one of Clauses 58-111, further comprising combining water and the product composition and/or combining water and the reaction product.

Clause 113. The method according to Clause 112, wherein the fire retardant composition comprises: about 15 wt % to about 30 wt % of the product composition or the reaction product; and about 70 wt % to about 85 wt % of the water.

Clause 114. A method for preparing a fire retardant composition and/or a fire retardant product according to any one, two, or more of Clauses 1-113 combined and as further described and discussed herein.

Clause 115. A fire retardant composition and/or a fire retardant product according to any one, two, or more of Clauses 1-114 combined and as further described and discussed herein.

### Clause Group 5 Containing the Following Clauses 1-72:

Clause 1. A fire retardant composition, comprising: a product composition prepared from a mixture comprising: about 90 weight percent (wt %) to about 99.9 wt % of a polysaccharide-base composition; and about 0.1 wt % to about 10 wt % of a bio-stimulant composition, based on dry weight.

Clause 2. The fire retardant composition according to Clause 1, wherein the mixture comprises: about 95 wt % to about 99.4 wt % of the polysaccharide-base composition; and about 0.6 wt % to about 5 wt % of the bio-stimulant composition, based on dry weight.

Clause 3. The fire retardant composition according to Clause 2, wherein the mixture comprises: about 98 wt % to about 99.2 wt % of the polysaccharide-base composition; and about 0.8 wt % to about 2 wt % of the bio-stimulant composition, based on dry weight.

Clause 4. A fire retardant composition, comprising: a reaction product of a weight ratio of a polysaccharide-base composition and a bio-stimulant composition, the weight ratio in a range from about 50:1 to about 200:1, based on dry weight.

Clause 5. The fire retardant composition according to Clause 4, wherein the weight ratio is in a range from about 70:1 to about 150:1, based on dry weight.

Clause 6. The fire retardant composition according to Clause 5, wherein the weight ratio is in a range from about 85:1 to about 95:1, based on dry weight.

Clause 7. The fire retardant composition according to any one of Clauses 1-6, wherein the polysaccharide-base composition comprises: about 0.001 wt % to about 1 wt % of a polysaccharide composition; about 10 wt % to about 40 wt % of an organic base composition; and about 60 wt % to about 94 wt % of an ammonium phosphate composition, based on dry weight.

Clause 8. The fire retardant composition according to Clause 7, wherein the polysaccharide-base composition comprises: about 0.005 wt % to about 0.5 wt % of the polysaccharide composition; about 12 wt % to about 30 wt % of the organic base composition; and about 65 wt % to about 88 wt % of the ammonium phosphate composition, based on dry weight.

Clause 9. The fire retardant composition according to Clause 8, wherein the polysaccharide-base composition comprises: about 0.01 wt % to about 0.1 wt % of the polysaccharide composition; about 16 wt % to about 25 wt % of the organic base composition; and about 72 wt % to about 84 wt % of the ammonium phosphate composition, based on dry weight.

Clause 10. The fire retardant composition according to any one of Clauses 7-9, wherein the polysaccharide composition comprises one or more non-sulfated polysaccharides and one or more sulfated polysaccharides.

Clause 11. The fire retardant composition according to any one of Clauses 7-10, wherein the polysaccharide composition comprises one or more carrageenans, salts thereof, complexes thereof, or any combination thereof.

Clause 12. The fire retardant composition according to Clause 11, wherein the polysaccharide composition comprises the one or more carrageenans which includes lambda carrageenan, kappa carrageenan, or any combination thereof.

Clause 13. The fire retardant composition according to any one of Clauses 7-12, wherein the polysaccharide composition comprises: about 60 wt % to about 90 wt % of lambda carrageenan; and about 10 wt % to about 40 wt % of kappa carrageenan, based on dry weight.

Clause 14. The fire retardant composition according to any one of Clauses 7-13, wherein the polysaccharide composition comprises: about 65 wt % to about 85 wt % of lambda carrageenan; and about 15 wt % to about 35 wt % of kappa carrageenan, based on dry weight.

Clause 15. The fire retardant composition according to any one of Clauses 7-14, wherein the polysaccharide composition comprises: about 70 wt % to about 80 wt % of lambda carrageenan; and about 20 wt % to about 30 wt % of kappa carrageenan, based on dry weight.

Clause 16. The fire retardant composition according to any one of Clauses 7-15, wherein the organic base composition comprises urea, salts thereof, complexes thereof, or any combination thereof.

Clause 17. The fire retardant composition according to any one of Clauses 7-16, wherein the organic base composition comprises about 90 wt % or greater of urea, such as about 95 wt %, about 96 wt %, about 97 wt %, about 98 wt %, about 99 wt %, or about 100 wt % of urea, based on dry weight.

Clause 18. The fire retardant composition according to any one of Clauses 7-phosphate, dibasic ammonium phosphate, salts thereof, complexes thereof, or any combination thereof.

Clause 19. The fire retardant composition according to any one of Clauses 7-18, wherein the ammonium phosphate composition comprises: about 20 wt % to about 80 wt % of monobasic ammonium phosphate; and about 20 wt % to about 80 wt % of dibasic ammonium phosphate, based on dry weight.

Clause 20. The fire retardant composition according to Clause 19, wherein the ammonium phosphate composition comprises: about 40 wt % to about 60 wt % of monobasic ammonium phosphate; and about 40 wt % to about 60 wt % of dibasic ammonium phosphate, based on dry weight.

Clause 21. The fire retardant composition according to any one of Clauses 1-20, wherein the polysaccharide-base composition further comprises an oxide material.

Clause 22. The fire retardant composition according to Clause 21, wherein the polysaccharide-base composition comprises about 0.1 wt % to about 2.5 wt % of the oxide material, based on dry weight.

Clause 23. The fire retardant composition according to Clause 22, wherein the polysaccharide-base composition comprises about 0.5 wt % to about 1.5 wt % of the oxide material, based on dry weight.

Clause 24. The fire retardant composition according to any one of Clauses 21-23, wherein the oxide material comprises silica, quartz, silicon oxide, alumina, titania, hafnia, or any combination thereof.

Clause 25. The fire retardant composition according to any one of Clauses 1-24, wherein the bio-stimulant composition comprises about 6 wt % to about 20 wt % of an oil composition.

Clause 26. The fire retardant composition according to Clause 25, wherein the bio-stimulant composition comprises about 8 wt % to about 15 wt % of the oil composition.

Clause 27. The fire retardant composition according to Clause 25, wherein the oil composition comprises a seed oil, a vegetable oil, an essential fatty acid, an animal fat, or any combination thereof.

Clause 28. The fire retardant composition according to Clause 25, wherein the oil composition comprises canola oil, soy oil, or any combination thereof.

Clause 29. The fire retardant composition according to any one of Clauses 1-24, wherein the bio-stimulant composition comprises: about 3 wt % to about 12 wt % of canola oil; and about 2 wt % to about 8 wt % of soy oil.

Clause 30. The fire retardant composition according to any one of Clauses 1-29, wherein the bio-stimulant composition comprises about 35 wt % to about 60 wt % of an organic acid composition.

Clause 31. The fire retardant composition according to Clause 30, wherein the bio-stimulant composition comprises about 42 wt % to about 52 wt % of the organic acid composition.

Clause 32. The fire retardant composition according to Clause 30, wherein the organic acid composition comprises fulvic acid, gluconic acid, oleic acid, esters thereof, salts thereof, or any combination thereof.

Clause 33. The fire retardant composition according to Clause 30, wherein the bio-stimulant composition comprises: about 0.4 wt % to about 2 wt % of fulvic acid; about 10 wt % to about 25 wt % of gluconic acid; and about 20 wt % to about 40 wt % of oleic acid.

Clause 34. The fire retardant composition according to Clause 30, wherein the bio-stimulant composition comprises: about 0.6 wt % to about 1 wt % of fulvic acid; about 15 wt % to about 20 wt % of gluconic acid; and about 25 wt % to about 32 wt % of oleic acid.

Clause 35. The fire retardant composition according to any one of Clauses 1-34, wherein the bio-stimulant composition further comprises a salt.

Clause 36. The fire retardant composition according to Clause 35, wherein the bio-stimulant composition comprises about 0.5 wt % to about 5 wt % of the salt.

Clause 37. The fire retardant composition according to Clause 35, wherein the bio-stimulant composition comprises about 1 wt % to about 3 wt % of the salt.

Clause 38. The fire retardant composition according to Clause 35, wherein the salt comprises sodium chloride, potassium chloride, magnesium chloride, potassium iodine, or any combination thereof.

Clause 39. The fire retardant composition according to Clause 35, wherein the salt comprises: about 40 wt % to about 60 wt % of magnesium chloride; about 32 wt % to about 42 wt % of potassium chloride; and about 4 wt % to about 15 wt % of sodium chloride, based on dry weight.

Clause 40. The fire retardant composition according to Clause 35, wherein the salt comprises: about 50 wt % to about 55 wt % of magnesium chloride; about 35 wt % to about 39 wt % of potassium chloride; and about 6 wt % to about 10 wt % of sodium chloride, based on dry weight.

Clause 41. The fire retardant composition according to any one of Clauses 1-40, wherein the bio-stimulant composition comprises an alfalfa composition.

Clause 42. The fire retardant composition according to Clause 41, wherein the bio-stimulant composition comprises about 0.05 wt % to about 0.50 wt % of the alfalfa composition.

Clause 43. The fire retardant composition according to Clause 41, wherein the alfalfa composition comprises ground leaves of Medicago sativa.

Clause 44. The fire retardant composition according to any one of Clauses 1-24, wherein the bio-stimulant composition comprises molasses.

Clause 45. The fire retardant composition according to Clause 44, wherein the bio-stimulant composition comprises about 3 wt % to about 12 wt % of the molasses.

Clause 46. The fire retardant composition according to any one of Clauses 1-45, wherein the bio-stimulant composition comprises an alcohol composition.

Clause 47. The fire retardant composition according to Clause 46, wherein the bio-stimulant composition comprises about 10 wt % to about 25 wt % of the alcohol composition.

Clause 48. The fire retardant composition according to Clause 46, wherein the alcohol composition comprises ethanol, sugar cane alcohol, or combinations thereof.

Clause 49. The fire retardant composition according to any one of Clauses 1-48, wherein the bio-stimulant composition comprises a surfactant composition.

Clause 50. The fire retardant composition according to Clause 49, wherein the bio-stimulant composition comprises about 10 wt % to about 25 wt % of the surfactant composition.

Clause 51. The fire retardant composition according to Clause 49, wherein the surfactant composition comprises linoleic acid, oleic acid, sunflower seed oil, or combinations thereof.

Clause 52. The fire retardant composition according to any one of Clauses 1-51, wherein the bio-stimulant composition comprises: about 0.5 wt % to about 5 wt % of a salt; about 35 wt % to about 60 wt % of an organic acid composition; about 6 wt % to about 20 wt % of an oil composition; about 0.05 wt % to about 0.50 wt % of an alfalfa composition; about 3 wt % to about 12 wt % of molasses; about 10 wt % to about 25 wt % of an alcohol composition; and about 10 wt % to about 25 wt % of a surfactant composition.

Clause 53. The fire retardant composition according to any one of Clauses 1-24, wherein the bio-stimulant composition comprises: about 1 wt % to about 3 wt % of a salt; about 42 wt % to about 52 wt % of an organic acid composition; about 8 wt % to about 15 wt % of an oil composition; about 0.08 wt % to about 0.25 wt % of an alfalfa composition; about 4 wt % to about 8 wt % of a molasses; about 12 wt % to about 20 wt % of an alcohol composition; and about 14 wt % to about 20 wt % of a surfactant composition.

Clause 54. The fire retardant composition according to any one of Clauses 1-53, further comprising water combined with the product composition or the reaction product.

Clause 55. The fire retardant composition according to Clause 54, wherein the fire retardant composition comprises: about 25 wt % to about 60 wt % of the product composition or the reaction product; and about 40 wt % to about 75 wt % of the water.

Clause 56. A method for preparing the fire retardant composition according to any one of Clauses 1-55, comprising: combining the polysaccharide-base composition and the bio-stimulant composition to prepare the product composition or the reaction product.

Clause 57. A fire retardant product, comprising: a base product; and the fire retardant composition according to any one of Clauses 1-56.

Clause 58. The fire retardant product according to Clause 57, wherein the base product comprises a wood product, a paper product, a textile product, a plant fiber product, a hemp and/or cannabis fiber product, a cellulose product, a resin product, an adhesive product, a plastic product, a polymeric product, or any combination thereof.

Clause 59. The fire retardant product according to Clause 57, wherein the base product comprises wood, lumber, a board, a particle board, a dry wall, a cement board, or any combination thereof.

Clause 60. The fire retardant product according to Clause 57, wherein the base product comprises hemp and/or cannabis, hemp and/or cannabis fibers, hemp and/or cannabis flakes, hemp and/or cannabis particles, hemp and/or cannabis dust, hemp and/or cannabis strands, hemp and/or cannabis rope, hemp and/or cannabis fabric, hemp and/or cannabis cloth, hemp and/or cannabis flour, hemp and/or cannabis seeds, or any combination thereof.

Clause 61. The fire retardant product according to any one of Clauses 57-60, wherein the fire retardant product is a hemp and/or cannabis-containing board, a hemp and/or cannabis-containing fire board, or a hemp and/or cannabis-containing insulation fire board.

Clause 62. The fire retardant product according to any one of Clauses 57-61, wherein the fire retardant product is a hemp and/or cannabis-containing insulation material or product, a flame-retardant home insulation, a flame-retardant building or structure insulation, a flame-retardant automotive insulation, or a flame-retardant wire insulation.

Clause 63. The fire retardant product according to any one of Clauses 57-62, wherein the fire retardant product contains less than 15 wt % of the fire retardant composition.

Clause 64. The fire retardant product according to Clause 63, wherein the fire retardant product contains about 0.5 wt % to about 10 wt % of the fire retardant composition.

Clause 65. The fire retardant product according to any one of Clauses 57-64, further comprising a softening agent or a softener.

Clause 66. The fire retardant product according to Clause 65, wherein the softening agent or the softener comprises glycerin.

Clause 67. The fire retardant product according to any one of Clauses 57-66, further comprising a biocide.

Clause 68. The fire retardant product according to Clause 67, wherein the biocide comprises a borate, copper azole, linseed oil, boric acid, benzalkonium chloride, a mixture of boric acid and benzalkonium chloride, creosote, pentachlorophenol, derivatives thereof, or any combination thereof.

Clause 69. The fire retardant product according to any one of Clauses 57-68, wherein the base product comprises an aqueous foam or an aqueous gel.

Clause 70. A fire retardant composition, comprising: a product composition prepared from a mixture comprising: about 95 weight percent (wt %) to about 99.4 wt % of a polysaccharide-base composition; and about 0.6 wt % to about 5 wt % of a bio-stimulant composition, based on dry weight; or a reaction product of a weight ratio of the polysaccharide-base composition and the bio-stimulant composition, the weight ratio in a range from about 70:1 to about 150:1, based on dry weight, based on dry weight; wherein the polysaccharide-base composition comprises: about 0.005 wt % to about 0.5 wt % of a polysaccharide composition; about 12 wt % to about 30 wt % of an organic base composition; and about 65 wt % to about 88 wt % of an ammonium phosphate composition, based on dry weight; wherein the polysaccharide composition comprises one or more carrageenans, salts thereof, complexes thereof, or any combination thereof; wherein the organic base composition comprises urea, salts thereof, complexes thereof, or any combination thereof; wherein the ammonium phosphate composition comprises monobasic ammonium phosphate, dibasic ammonium phosphate, salts thereof, complexes thereof, or any combination thereof; and wherein the bio-stimulant composition comprises about 8 wt % to about 15 wt % of the oil composition; about 42 wt % to about 52 wt % of the organic acid composition; and about 10 wt % to about 25 wt % of the surfactant composition.

Clause 71. A fire retardant composition and/or a fire retardant product according to any one, two, or more of Clauses 1-70 combined and as further described and discussed herein.

Clause 72. A method for preparing a fire retardant composition and/or a fire retardant product according to any one, two, or more of Clauses 1-71 combined and as further described and discussed herein.

### Clause Group 6 Containing the Following Clauses 1-115:

Clause 1. A method for preparing the fire retardant composition, comprising: combining a polysaccharide-base composition and a bio-stimulant composition to prepare a product composition or a reaction product.

Clause 2. The method according to Clause 1, further comprising combining a polysaccharide composition, an organic base composition, and an ammonium phosphate composition to prepare the polysaccharide-base composition.

Clause 3. The method according to Clause 1, wherein the product composition is prepared from a mixture comprising: about 90 weight percent (wt %) to about 99.9 wt % of a polysaccharide-base composition; and about 0.1 wt % to about 10 wt % of a bio-stimulant composition, based on dry weight.

Clause 4. The method according to Clause 3, wherein the mixture comprises: about 95 wt % to about 99.4 wt % of the polysaccharide-base composition; and about 0.6 wt % to about 5 wt % of the bio-stimulant composition, based on dry weight.

Clause 5. The method according to Clause 4, wherein the mixture comprises: about 98 wt % to about 99.2 wt % of the polysaccharide-base composition; and about 0.8 wt % to about 2 wt % of the bio-stimulant composition, based on dry weight.

Clause 6. The method according to Clause 1, wherein the reaction product is prepared from a weight ratio of the polysaccharide-base composition and the bio-stimulant composition, the weight ratio in a range from about 50:1 to about 200:1, based on dry weight.

Clause 7. The method according to Clause 6, wherein the weight ratio is in a range from about 70:1 to about 150:1, based on dry weight.

Clause 8. The method according to Clause 7, wherein the weight ratio is in a range from about 85:1 to about 95:1, based on dry weight.

Clause 9. The method according to any one of Clauses 1-8, wherein the polysaccharide-base composition comprises: about 0.001 wt % to about 1 wt % of a polysaccharide composition; about 10 wt % to about 40 wt % of an organic base composition; and about 60 wt % to about 94 wt % of an ammonium phosphate composition, based on dry weight.

Clause 10. The method according to Clause 9, wherein the polysaccharide-base composition comprises: about 0.005 wt % to about 0.5 wt % of the polysaccharide composition; about 12 wt % to about 30 wt % of the organic base composition; and about 65 wt % to about 88 wt % of the ammonium phosphate composition, based on dry weight.

Clause 11. The method according to Clause 10, wherein the polysaccharide-base composition comprises: about 0.01 wt % to about 0.1 wt % of the polysaccharide composition; about 16 wt % to about 25 wt % of the organic base composition; and about 72 wt % to about 84 wt % of the ammonium phosphate composition, based on dry weight.

Clause 12. The method according to Clause 9, wherein the polysaccharide composition comprises one or more non-sulfated polysaccharides and one or more sulfated polysaccharides.

Clause 13. The method according to Clause 9, wherein the polysaccharide composition comprises one or more carrageenans, salts thereof, complexes thereof, or any combination thereof.

Clause 14. The method according to Clause 13, wherein the polysaccharide composition comprises the one or more carrageenans which includes lambda carrageenan, kappa carrageenan, or any combination thereof.

Clause 15. The method according to Clause 9, wherein the polysaccharide composition comprises: about 60 wt % to about 90 wt % of lambda carrageenan; and about 10 wt % to about 40 wt % of kappa carrageenan, based on dry weight.

Clause 16. The method according to Clause 9, wherein the polysaccharide composition comprises: about 65 wt % to about 85 wt % of lambda carrageenan; and about 15 wt % to about 35 wt % of kappa carrageenan, based on dry weight.

Clause 17. The method according to Clause 9, wherein the polysaccharide composition comprises: about 70 wt % to about 80 wt % of lambda carrageenan; and about 20 wt % to about 30 wt % of kappa carrageenan, based on dry weight.

Clause 18. The method according to Clause 9, wherein the organic base composition comprises urea, salts thereof, complexes thereof, or any combination thereof.

Clause 19. The method according to Clause 18, wherein the organic base composition comprises about 90 wt % or greater of urea, such as about 95 wt %, about 96 wt %, about 97 wt %, about 98 wt %, about 99 wt %, or about 100 wt % of urea, based on dry weight.

Clause 20. The method according to Clause 9, wherein the ammonium phosphate composition comprises monobasic ammonium phosphate, dibasic ammonium phosphate, salts thereof, complexes thereof, or any combination thereof.

Clause 21. The method according to Clause 9, wherein the ammonium phosphate composition comprises: about 20 wt % to about 80 wt % of monobasic ammonium phosphate; and about 20 wt % to about 80 wt % of dibasic ammonium phosphate, based on dry weight.

Clause 22. The method according to Clause 21, wherein the ammonium phosphate composition comprises: about 40 wt % to about 60 wt % of monobasic ammonium phosphate; and about 40 wt % to about 60 wt % of dibasic ammonium phosphate, based on dry weight.

Clause 23. The method according to any one of Clauses 1-22, wherein the polysaccharide-base composition further comprises an oxide material.

Clause 24. The method according to Clause 23, wherein the polysaccharide-base composition comprises about 0.1 wt % to about 2.5 wt % of the oxide material, based on dry weight.

Clause 25. The method according to Clause 24, wherein the polysaccharide-base composition comprises about 0.5 wt % to about 1.5 wt % of the oxide material, based on dry weight.

Clause 26. The method according to any one of Clauses 23-25, wherein the oxide material comprises silica, quartz, silicon oxide, alumina, titania, hafnia, or any combination thereof.

Clause 27. The method according to any one of Clauses 1-26, wherein the bio-stimulant composition comprises about 6 wt % to about 20 wt % of an oil composition.

Clause 28. The method according to Clause 27, wherein the bio-stimulant composition comprises about 8 wt % to about 15 wt % of the oil composition.

Clause 29. The method according to Clause 27, wherein the oil composition comprises a seed oil, a vegetable oil, an essential fatty acid, an animal fat, or any combination thereof.

Clause 30. The method according to Clause 27, wherein the oil composition comprises canola oil, soy oil, or any combination thereof.

Clause 31. The method according to any one of Clauses 1-30, wherein the bio-stimulant composition comprises: about 3 wt % to about 12 wt % of canola oil; and about 2 wt % to about 8 wt % of soy oil.

Clause 32. The method according to any one of Clauses 1-31, wherein the bio-stimulant composition comprises about 35 wt % to about 60 wt % of an organic acid composition.

Clause 33. The method according to Clause 32, wherein the bio-stimulant composition comprises about 42 wt % to about 52 wt % of the organic acid composition.

Clause 34. The method according to Clause 32, wherein the organic acid composition comprises fulvic acid, gluconic acid, oleic acid, esters thereof, salts thereof, or any combination thereof.

Clause 35. The method according to Clause 32, wherein the bio-stimulant composition comprises: about 0.4 wt % to about 2 wt % of fulvic acid; about 10 wt % to about 25 wt % of gluconic acid; and about 20 wt % to about 40 wt % of oleic acid.

Clause 36. The method according to Clause 32, wherein the bio-stimulant composition comprises: about 0.6 wt % to about 1 wt % of fulvic acid; about 15 wt % to about 20 wt % of gluconic acid; and about 25 wt % to about 32 wt % of oleic acid.

Clause 37. The method according to any one of Clauses 1-36, wherein the bio-stimulant composition comprises a salt.

Clause 38. The method according to Clause 37, wherein the bio-stimulant composition comprises about 0.5 wt % to about 5 wt % of the salt.

Clause 39. The method according to Clause 37, wherein the bio-stimulant composition comprises about 1 wt % to about 3 wt % of the salt.

Clause 40. The method according to Clause 37, wherein the salt comprises sodium chloride, potassium chloride, magnesium chloride, potassium iodine, or any combination thereof.

Clause 41. The method according to Clause 37, wherein the salt comprises: about 40 wt % to about 60 wt % of magnesium chloride; about 32 wt % to about 42 wt % of potassium chloride; and about 4 wt % to about 15 wt % of sodium chloride, based on dry weight.

Clause 42. The method according to Clause 37, wherein the salt comprises: about 50 wt % to about 55 wt % of magnesium chloride; about 35 wt % to about 39 wt % of potassium chloride; and about 6 wt % to about 10 wt % of sodium chloride, based on dry weight.

Clause 43. The method according to any one of Clauses 1-42, wherein the bio-stimulant composition comprises an alfalfa composition.

Clause 44. The method according to Clause 43, wherein the bio-stimulant composition comprises about 0.05 wt % to about 0.50 wt % of the alfalfa composition.

Clause 45. The method according to Clause 43, wherein the alfalfa composition comprises ground leaves of Medicago sativa.

Clause 46. The method according to any one of Clauses 1-45, wherein the bio-stimulant composition comprises molasses.

Clause 47. The method according to Clause 46, wherein the bio-stimulant composition comprises about 3 wt % to about 12 wt % of the molasses.

Clause 48. The method according to any one of Clauses 1-47, wherein the bio-stimulant composition comprises an alcohol composition.

Clause 49. The method according to Clause 48, wherein the bio-stimulant composition comprises about 10 wt % to about 25 wt % of the alcohol composition.

Clause 50. The method according to Clause 48, wherein the alcohol composition comprises ethanol, sugar cane alcohol, or combinations thereof.

Clause 51. The method according to any one of Clauses 1-50, wherein the bio-stimulant composition comprises a surfactant composition.

Clause 52. The method according to Clause 51, wherein the bio-stimulant composition comprises about 10 wt % to about 25 wt % of the surfactant composition.

Clause 53. The method according to Clause 51, wherein the surfactant composition comprises linoleic acid, oleic acid, sunflower seed oil, or combinations thereof.

Clause 54. The method according to any one of Clauses 1-53, wherein the bio-stimulant composition comprises: about 0.5 wt % to about 5 wt % of a salt; about 35 wt % to about 60 wt % of an organic acid composition; about 6 wt % to about 20 wt % of an oil composition; about 0.05 wt % to about 0.50 wt % of an alfalfa composition; about 3 wt % to about 12 wt % of molasses; about 10 wt % to about 25 wt % of an alcohol composition; and about 10 wt % to about 25 wt % of a surfactant composition.

Clause 55. The method according to any one of Clauses 1-54, wherein the bio-stimulant composition comprises: about 1 wt % to about 3 wt % of a salt; about 42 wt % to about 52 wt % of an organic acid composition; about 8 wt % to about 15 wt % of an oil composition; about 0.08 wt % to about 0.25 wt % of an alfalfa composition; about 4 wt % to about 8 wt % of a molasses; about 12 wt % to about 20 wt % of an alcohol composition; and about 14 wt % to about 20 wt % of a surfactant composition.

Clause 56. The method according to any one of Clauses 1-55, further comprising water combined with the product composition or the reaction product.

Clause 57. The method according to Clause 56, wherein the fire retardant composition comprises: about 25 wt % to about 60 wt % of the product composition or the reaction product; and about 40 wt % to about 75 wt % of the water.

Clause 58. A method for preparing the fire retardant composition, comprising: combining a polysaccharide composition with water to prepare a first mixture; combining at least an organic base composition and an ammonium phosphate composition with the first mixture to prepare a polysaccharide-base composition; and combining a bio-stimulant composition and the polysaccharide-base composition to prepare a product composition or a reaction product.

Clause 59. The method according to Clause 58, wherein the polysaccharide composition with the water are combined to prepare the first mixture at a first temperature in a range from about 70° C. to about 100° C.

Clause 60. The method according to Clause 59, wherein the organic base composition, the ammonium phosphate composition, and the first mixture are combined to prepare the polysaccharide-base composition at a second temperature in a range from about 70° C. to about 100° C.

Clause 61. The method according to Clause 60, wherein the bio-stimulant composition and the polysaccharide-base composition are combined to prepare the product composition or the reaction product at a third temperature in a range from about 40° C. to about 80° C.

Clause 62. The method according to Clause 61, wherein: the first temperature is in a range from about 80° C. to about 90° C.; the second temperature is in a range from about 80° C. to about 90° C.; and the third temperature is in a range from about 50° C. to about 70° C.

Clause 63. The method according to any one of Clauses 58-62, wherein the polysaccharide composition comprises one or more non-sulfated polysaccharides or one or more sulfated polysaccharides.

Clause 64. The method according to any one of Clauses 58-62, wherein the polysaccharide composition comprises one or more non-sulfated polysaccharides and one or more sulfated polysaccharides.

Clause 65. The method according to any one of Clauses 58-64, further comprising preparing the polysaccharide composition by combining the water together with one or more non-sulfated polysaccharides, one or more sulfated polysaccharides, or both one or more non-sulfated polysaccharides and one or more sulfated polysaccharides.

Clause 66. The method according to Clause 65, wherein the polysaccharide composition comprises one or more carrageenans, salts thereof, complexes thereof, or any combination thereof.

Clause 67. The method according to Clause 66, wherein the polysaccharide composition comprises the one or more carrageenans which includes lambda carrageenan, kappa carrageenan, or any combination thereof.

Clause 68. The method according to any one of Clauses 58-67, wherein the polysaccharide composition comprises: about 60 wt % to about 90 wt % of lambda carrageenan; and about 10 wt % to about 40 wt % of kappa carrageenan, based on dry weight.

Clause 69. The method according to Clause 68, wherein the polysaccharide composition comprises: about 65 wt % to about 85 wt % of lambda carrageenan; and about 15 wt % to about 35 wt % of kappa carrageenan, based on dry weight.

Clause 70. The method according to Clause 69, wherein the polysaccharide composition comprises: about 70 wt % to about 80 wt % of lambda carrageenan; and about 20 wt % to about 30 wt % of kappa carrageenan, based on dry weight.

Clause 71. The method according to any one of Clauses 58-70, further comprising combining the first mixture and at least urea, salts thereof, complexes thereof, or any combination thereof.

Clause 72. The method according to any one of Clauses 58-71, wherein the organic base composition comprises urea, salts thereof, complexes thereof, or any combination thereof.

Clause 73. The method according to any one of Clauses 58-71, wherein the organic base composition comprises about 90 wt % or greater of urea, such as about 95 wt %, about 96 wt %, about 97 wt %, about 98 wt %, about 99 wt %, or about 100 wt % of urea, based on dry weight.

Clause 74. The method according to any one of Clauses 58-73, further comprising combining the first mixture and at least the ammonium phosphate composition.

Clause 75. The method according to any one of Clauses 58-73, further comprising combining the first mixture and at least the ammonium phosphate composition and the organic base composition.

Clause 76. The method according to any one of Clauses 58-75, wherein the ammonium phosphate composition comprises monobasic ammonium phosphate, dibasic ammonium phosphate, salts thereof, complexes thereof, or any combination thereof.

Clause 77. The method according to any one of Clauses 58-76, wherein the ammonium phosphate composition comprises: about 20 wt % to about 80 wt % of monobasic ammonium phosphate; and about 20 wt % to about 80 wt % of dibasic ammonium phosphate, based on dry weight.

Clause 78. The method according to Clause 77, wherein the ammonium phosphate composition comprises: about 40 wt % to about 60 wt % of monobasic ammonium phosphate; and about 40 wt % to about 60 wt % of dibasic ammonium phosphate, based on dry weight.

Clause 79. The method according to any one of Clauses 58-78, wherein the polysaccharide-base composition further comprises an oxide material.

Clause 80. The method according to Clause 79, wherein the polysaccharide-base composition comprises about 0.1 wt % to about 2 wt % of the oxide material, based on dry weight.

Clause 81. The method according to Clause 80, wherein the polysaccharide-base composition comprises about 0.5 wt % to about 1.2 wt % of the oxide material, based on dry weight.

Clause 82. The method according to any one of Clauses 79-81, wherein the oxide material comprises silica, quartz, silicon oxide, alumina, titania, hafnia, or any combination thereof.

Clause 83. The method according to any one of Clauses 58-82, wherein the bio-stimulant composition comprises about 6 wt % to about 20 wt % of an oil composition.

Clause 84. The method according to Clause 83, wherein the bio-stimulant composition comprises about 8 wt % to about 15 wt % of the oil composition.

Clause 85. The method according to Clause 83, wherein the oil composition comprises a seed oil, a vegetable oil, an essential fatty acid, an animal fat, or any combination thereof.

Clause 86. The method according to Clause 83, wherein the oil composition comprises canola oil, soy oil, or any combination thereof.

Clause 87. The method according to any one of Clauses 58-86, wherein the bio-stimulant composition comprises: about 3 wt % to about 12 wt % of canola oil; and about 2 wt % to about 8 wt % of soy oil.

Clause 88. The method according to any one of Clauses 58-87, wherein the bio-stimulant composition comprises about 35 wt % to about 60 wt % of an organic acid composition.

Clause 89. The method according to Clause 88, wherein the bio-stimulant composition comprises about 42 wt % to about 52 wt % of the organic acid composition.

Clause 90. The method according to Clause 88, wherein the organic acid composition comprises fulvic acid, gluconic acid, oleic acid, esters thereof, salts thereof, or any combination thereof.

Clause 91. The method according to Clause 88, wherein the bio-stimulant composition comprises: about 0.4 wt % to about 2 wt % of fulvic acid; about 10 wt % to about 25 wt % of gluconic acid; and about 20 wt % to about 40 wt % of oleic acid.

Clause 92. The method according to Clause 88, wherein the bio-stimulant composition comprises: about 0.6 wt % to about 1 wt % of fulvic acid; about 15 wt % to about 20 wt % of gluconic acid; and about 25 wt % to about 32 wt % of oleic acid.

Clause 93. The method according to any one of Clauses 58-92, wherein the bio-stimulant composition comprises a salt.

Clause 94. The method according to Clause 93, wherein the bio-stimulant composition comprises about 0.5 wt % to about 5 wt % of the salt.

Clause 95. The method according to Clause 93, wherein the bio-stimulant composition comprises about 1 wt % to about 3 wt % of the salt.

Clause 96. The method according to Clause 93, wherein the salt comprises sodium chloride, potassium chloride, magnesium chloride, potassium iodine, or any combination thereof.

Clause 97. The method according to Clause 93, wherein the salt comprises: about 40 wt % to about 60 wt % of magnesium chloride; about 32 wt % to about 42 wt % of potassium chloride; and about 4 wt % to about 15 wt % of sodium chloride, based on dry weight.

Clause 98. The method according to Clause 93, wherein the salt comprises: about 50 wt % to about 55 wt % of magnesium chloride; about 35 wt % to about 39 wt % of potassium chloride; and about 6 wt % to about 10 wt % of sodium chloride, based on dry weight.

Clause 99. The method according to any one of Clauses 58-98, wherein the bio-stimulant composition comprises an alfalfa composition.

Clause 100. The method according to Clause 99, wherein the bio-stimulant composition comprises about 0.05 wt % to about 0.50 wt % of the alfalfa composition.

Clause 101. The method according to Clause 99, wherein the alfalfa composition comprises ground leaves of Medicago sativa.

Clause 102. The method according to any one of Clauses 58-101, wherein the bio-stimulant composition comprises molasses.

Clause 103. The method according to Clause 102, wherein the bio-stimulant composition comprises about 3 wt % to about 12 wt % of the molasses.

Clause 104. The method according to any one of Clauses 58-103, wherein the bio-stimulant composition comprises an alcohol composition.

Clause 105. The method according to Clause 104, wherein the bio-stimulant composition comprises about 10 wt % to about 25 wt % of the alcohol composition.

Clause 106. The method according to Clause 104, wherein the alcohol composition comprises ethanol, sugar cane alcohol, or combinations thereof.

Clause 107. The method according to any one of Clauses 58-106, wherein the bio-stimulant composition comprises a surfactant composition.

Clause 108. The method according to Clause 107, wherein the bio-stimulant composition comprises about 10 wt % to about 25 wt % of the surfactant composition.

Clause 109. The method according to Clause 107, wherein the surfactant composition comprises linoleic acid, oleic acid, sunflower seed oil, or combinations thereof.

Clause 110. The method according to any one of Clauses 58-109, wherein the bio-stimulant composition comprises: about 0.5 wt % to about 5 wt % of a salt; about 35 wt % to about 60 wt % of an organic acid composition; about 6 wt % to about 20 wt % of an oil composition; about 0.05 wt % to about 0.50 wt % of an alfalfa composition; about 3 wt % to about 12 wt % of molasses; about 10 wt % to about 25 wt % of an alcohol composition; and about 10 wt % to about 25 wt % of a surfactant composition.

Clause 111. The method according to any one of Clauses 58-110, wherein the bio-stimulant composition comprises: about 1 wt % to about 3 wt % of a salt; about 42 wt % to about 52 wt % of an organic acid composition; about 8 wt % to about 15 wt % of an oil composition; about 0.08 wt % to about 0.25 wt % of an alfalfa composition; about 4 wt % to about 8 wt % of a molasses; about 12 wt % to about 20 wt % of an alcohol composition; and about 14 wt % to about 20 wt % of a surfactant composition.

Clause 112. The method according to any one of Clauses 58-111, further comprising combining water and the product composition and/or combining water and the reaction product.

Clause 113. The method according to Clause 112, wherein the fire retardant composition comprises: about 25 wt % to about 60 wt % of the product composition or the reaction product; and about 40 wt % to about 75 wt % of the water.

Clause 114. A method for preparing a fire retardant composition and/or a fire retardant product according to any one, two, or more of Clauses 1-113 combined and as further described and discussed herein.

Clause 115. A fire retardant composition and/or a fire retardant product according to any one, two, or more of Clauses 1-114 combined and as further described and discussed herein.

While the foregoing is directed to embodiments of the disclosure, other and further embodiments may be devised without departing from the basic scope thereof, and the scope thereof is determined by the claims that follow. All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications may be made without departing from the spirit and scope of the present disclosure. Accordingly, it is not intended that the present disclosure be limited thereby. Likewise, the term “comprising” is considered synonymous with the term “including” for purposes of United States law. Likewise, whenever a composition, an element, or a group of elements is preceded with the transitional phrase “comprising”, it is understood that the same composition or group of elements with transitional phrases “consisting essentially of”, “consisting of”, “selected from the group of consisting of”, or “is” preceding the recitation of the composition, element, or elements and vice versa, are contemplated. As used herein, the term “about” refers to a +/−10% variation from the nominal value. It is to be understood that such a variation may be included in any value provided herein. The recitation or terms “based on dry weight” is intended to mean dried, dehydrated, or without water, but may still maintain non-aqueous substances in liquid state.

Certain embodiments and features have been described using a set of numerical minimum values and a set of numerical maximum values. It should be appreciated that ranges including the combination of any two values, e.g., the combination of any minimum value with any maximum value, the combination of any two minimum values, and/or the combination of any two maximum values are contemplated unless otherwise indicated. Certain minimum values, maximum values, and ranges appear in one or more claims below.

What is claimed is:

1. A fire retardant composition, comprising:
a product composition prepared from a mixture comprising:
about 90 weight percent (wt %) to about 99.9 wt % of a polysaccharide-base composition; and
about 0.1 wt % to about 10 wt % of a bio-stimulant composition, based on dry weight.

2. The fire retardant composition of claim 1, wherein the polysaccharide-base composition comprises:
about 0.01 wt % to about 1 wt % of a polysaccharide composition;
about 10 wt % to about 40 wt % of an organic base composition; and
about 60 wt % to about 94 wt % of an ammonium phosphate composition, based on dry weight.

3. The fire retardant composition of claim 1, wherein the polysaccharide composition comprises:
about 60 wt % to about 90 wt % of lambda carrageenan; and
about 10 wt % to about 40 wt % of kappa carrageenan, based on dry weight.

4. The fire retardant composition of claim 1, wherein the organic base composition comprises urea, salts thereof, complexes thereof, or any combination thereof.

5. The fire retardant composition of claim 1, wherein the ammonium phosphate composition comprises:
about 20 wt % to about 80 wt % of monobasic ammonium phosphate; and
about 20 wt % to about 80 wt % of dibasic ammonium phosphate, based on dry weight.

6. The fire retardant composition of claim 1, wherein the polysaccharide-base composition comprises about 0.1 wt % to about 2.5 wt % of an oxide material, based on dry weight, and wherein the oxide material comprises silica, quartz, silicon oxide, alumina, titania, hafnia, or any combination thereof.

7. The fire retardant composition of claim 1, wherein the bio-stimulant composition comprises about 6 wt % to about 20 wt % of an oil composition, and wherein the oil composition comprises a seed oil, a vegetable oil, an essential fatty acid, an animal fat, or any combination thereof.

8. The fire retardant composition of claim 1, wherein the bio-stimulant composition comprises about 35 wt % to about 60 wt % of an organic acid composition, and wherein the organic acid composition comprises fulvic acid, gluconic acid, oleic acid, esters thereof, salts thereof, or any combination thereof.

9. The fire retardant composition of claim 1, wherein the bio-stimulant composition comprises about 0.5 wt % to about 5 wt % of a salt, and wherein the salt comprises sodium chloride, potassium chloride, magnesium chloride, potassium iodine, or any combination thereof.

10. The fire retardant composition of claim 1, wherein the bio-stimulant composition comprises:
about 0.5 wt % to about 5 wt % of a salt;
about 35 wt % to about 60 wt % of an organic acid composition;
about 6 wt % to about 20 wt % of an oil composition;
about 0.05 wt % to about 0.50 wt % of an alfalfa composition;
about 3 wt % to about 12 wt % of molasses;
about 10 wt % to about 25 wt % of an alcohol composition; and
about 10 wt % to about 25 wt % of a surfactant composition.

11. A fire retardant composition, comprising:
a reaction product of a weight ratio of a polysaccharide-base composition and a bio-stimulant composition, the weight ratio in a range from about 50:1 to about 200:1, based on dry weight.

12. The fire retardant composition of claim 11, wherein the polysaccharide-base composition comprises:
about 0.01 wt % to about 0.1 wt % of a polysaccharide composition;
about 16 wt % to about 25 wt % of an organic base composition; and
about 72 wt % to about 84 wt % of an ammonium phosphate composition, based on dry weight.

13. The fire retardant composition of claim 11, wherein the polysaccharide composition comprises:
about 70 wt % to about 80 wt % of lambda carrageenan; and
about 20 wt % to about 30 wt % of kappa carrageenan, based on dry weight.

14. The fire retardant composition of claim 11, wherein the organic base composition comprises urea, salts thereof, complexes thereof, or any combination thereof.

15. The fire retardant composition of claim 11, wherein the ammonium phosphate composition comprises:
about 20 wt % to about 80 wt % of monobasic ammonium phosphate; and
about 20 wt % to about 80 wt % of dibasic ammonium phosphate, based on dry weight.

16. The fire retardant composition of claim 11, wherein the polysaccharide-base composition comprises about 0.1 wt % to about 2.5 wt % of an oxide material, based on dry weight, and wherein the oxide material comprises silica, quartz, silicon oxide, alumina, titania, hafnia, or any combination thereof.

17. The fire retardant composition of claim 11, wherein the bio-stimulant composition comprises about 6 wt % to about 20 wt % of an oil composition, and wherein the oil composition comprises a seed oil, a vegetable oil, an essential fatty acid, an animal fat, or any combination thereof.

18. The fire retardant composition of claim 11, wherein the bio-stimulant composition comprises about 35 wt % to about 60 wt % of an organic acid composition, and wherein the organic acid composition comprises fulvic acid, gluconic acid, oleic acid, esters thereof, salts thereof, or any combination thereof.

19. The fire retardant composition of claim 11, wherein the bio-stimulant composition comprises about 0.5 wt % to about 5 wt % of a salt, and wherein the salt comprises about 40 wt % to about 60 wt % of magnesium chloride, about 32 wt % to about 42 wt % of potassium chloride, and about 4 wt % to about 15 wt % of sodium chloride, based on dry weight.

20. The fire retardant composition of claim 11, wherein the bio-stimulant composition comprises:
about 0.5 wt % to about 5 wt % of a salt;
about 35 wt % to about 60 wt % of an organic acid composition;
about 6 wt % to about 20 wt % of an oil composition;
about 0.05 wt % to about 0.50 wt % of an alfalfa composition;
about 3 wt % to about 12 wt % of molasses;
about 10 wt % to about 25 wt % of an alcohol composition; and
about 10 wt % to about 25 wt % of a surfactant composition.

21. A fire retardant composition, comprising:
a product composition prepared from a mixture comprising:
about 95 weight percent (wt %) to about 99.4 wt % of a polysaccharide-base composition; and
about 0.6 wt % to about 5 wt % of a bio-stimulant composition, based on dry weight; or
a reaction product of a weight ratio of the polysaccharide-base composition and the bio-stimulant composition, the weight ratio in a range from about 70:1 to about 150:1, based on dry weight;
wherein the polysaccharide-base composition comprises:
about 0.005 wt % to about 0.5 wt % of a polysaccharide composition;
about 12 wt % to about 30 wt % of an organic base composition; and
about 65 wt % to about 88 wt % of an ammonium phosphate composition, based on dry weight;
wherein the polysaccharide composition comprises one or more carrageenans, salts thereof, complexes thereof, or any combination thereof;
wherein the organic base composition comprises urea, salts thereof, complexes thereof, or any combination thereof;
wherein the ammonium phosphate composition comprises monobasic ammonium phosphate, dibasic ammonium phosphate, salts thereof, complexes thereof, or any combination thereof; and
wherein the bio-stimulant composition comprises about 8 wt % to about 15 wt % of the oil composition; about 42 wt % to about 52 wt % of the organic acid composition; and about 10 wt % to about 25 wt % of the surfactant composition.
